(19) United States
(12) Patent Application Publication
(10) Pub. No.: US 2014/0297344 A1
(43) Pub. Date: Oct. 2, 2014

(54) SYSTEM AND METHOD FOR LABORATORY AND PERSONNEL MANAGEMENT, DEVELOPMENT AND MAINTENANCE

(71) Applicant: COLA, Columbia, MD (US)

(72) Inventor: Douglas A. BEIGEL, Westmount, MD (US)

(21) Appl. No.: 14/298,126

(22) Filed: Jun. 6, 2014

Related U.S. Application Data
(63) Continuation of application No. 13/180,509, filed on Jul. 11, 2011.
(60) Provisional application No. 61/363,114, filed on Jul. 9, 2010.

(51) Int. Cl. G06Q 10/06

(52) U.S. Cl. CPC G06Q 10/06311
USPC 705/7.13

(57) ABSTRACT

A personalized tool, designed to help personnel manage their laboratories/organizations/companies and personal/professional development more efficiently. Access to the tools needed to run a more efficient laboratory/organization and improve patient care/customer satisfaction. The web portal provides a variety of helpful electronic tools, giving personnel the ability to update their laboratory/organization profile, view news alerts and survey results, prepare for upcoming compliance surveys/reviews and receive support for a wide range of laboratory/organization/company needs. Example features for laboratories include an easy-to-follow dashboard wheel that displays compliance/progress status information at a glance, a self-assessment wizard allowing managers to monitor their laboratory's quality and a dedicated section for waived laboratories. This provides a resource where professionals can update their lab/organization/company profile, view communications, see survey results, prepare for upcoming surveys and receive support for a whole range of laboratory/organization/company needs.

### RELATED APPLICATIONS

This application is a Continuation Application of U.S. patent application Ser. No. 13/180,509, filed Jul. 11, 2011, which claims the benefit under 35 U.S.C. 119(e) of U.S. Provisional Patent Application No. 61/363,114, filed Jul. 9, 2010, the content of each of which is hereby incorporated by reference in its entirety.

### BACKGROUND

1. Field

The present subject matter relates to the management, development and maintenance of laboratory documents, equipment, personnel and accreditation.

2. Background

Laboratory managers are constantly challenged to act in accordance with Quality Systems, meet federal CLIA and state regulatory requirements and provide the best possible patient care.

SUMMARY

The following presents a simplified summary in order to provide a basic understanding of some aspects of the claimed subject matter. This summary is not an extensive overview, and is not intended to identify key/critical elements or to delineate the scope of the claimed subject matter. Its purpose is to present some concepts in a simplified form as a prelude to the more detailed description that is presented later.

The present subject matter relates to the management, development and maintenance of laboratory documents, equipment, personnel and accreditation.

Other aspects of the disclosure are found throughout the specification.

### BRIEF DESCRIPTION OF THE DRAWINGS

The drawings depict example designs and features of the subject matter.

FIG. 1 shows an example home and login screen of a web portal;

FIG. 2 shows another example home and login screen of a web portal;

FIGS. 3-5 introduce some of the features of the example web portal;

FIGS. 6-7 introduce some of the management/compliance features of the example web portal;

FIG. 8 introduces some of the features of the main dashboard;

FIGS. 9-10 are example self assessments;

FIGS. 11-13 depict various stages a user may interact with;

FIGS. 14-15 show Messages and Alerts notified by the system;

FIG. 16 shows an example screen for reviewing survey information;

FIGS. 17a and 17b are example screens introducing Self Assessment/Pre-Survey to users;

FIGS. 18a-18e depict example descriptions of an On-Site Survey;

FIG. 19 shows an example screen for a user at the Post Survey/Corrective Action phase;

FIG. 20 shows an example screen for entering and updating Profile information, for example, “Personal Information”;

FIGS. 21a and 21b show example screens for a user at the Post Survey/Corrective Action phase;

FIGS. 22a and 22b are example screens introducing Accreditation to users;

FIGS. 23a-23c are example screens introducing aspects of Ongoing Education to users;

FIGS. 24-25b are example screens introducing aspects of Management Compliance;

FIG. 26 shows sample fields for entry of data related to an Accounting Statement;

FIG. 27 shows a Widget Central module;

FIG. 28-39 show features of a Document Repository module;

FIG. 40 shows an example Lab Director Signature Forms screen;

FIGS. 41-56 show features of a Lab Information module;

FIG. 57 shows features of Test Systems management modules;

FIGS. 58-59 show features of Personnel management modules;

FIGS. 60-62 show features of Proficiency Testing and Proficiency Testing Results modules;

FIGS. 63a-68 show features of Self Assessment related modules;

FIGS. 69a and 69b show an example Test Systems summary and updating screen;

FIGS. 70-72 show features of an Education/Resources module;

FIGS. 73-75 show features of a Waived Testing module;

FIGS. 76-77b show features of a Support Center module;

FIGS. 78a and 78b show features of a Contact Us module;

FIGS. 79-90 show features of a Lab Operations module;

FIGS. 91-98f show features of a Competency Tracker module; and

FIGS. 99a-99d show Consultant User features.

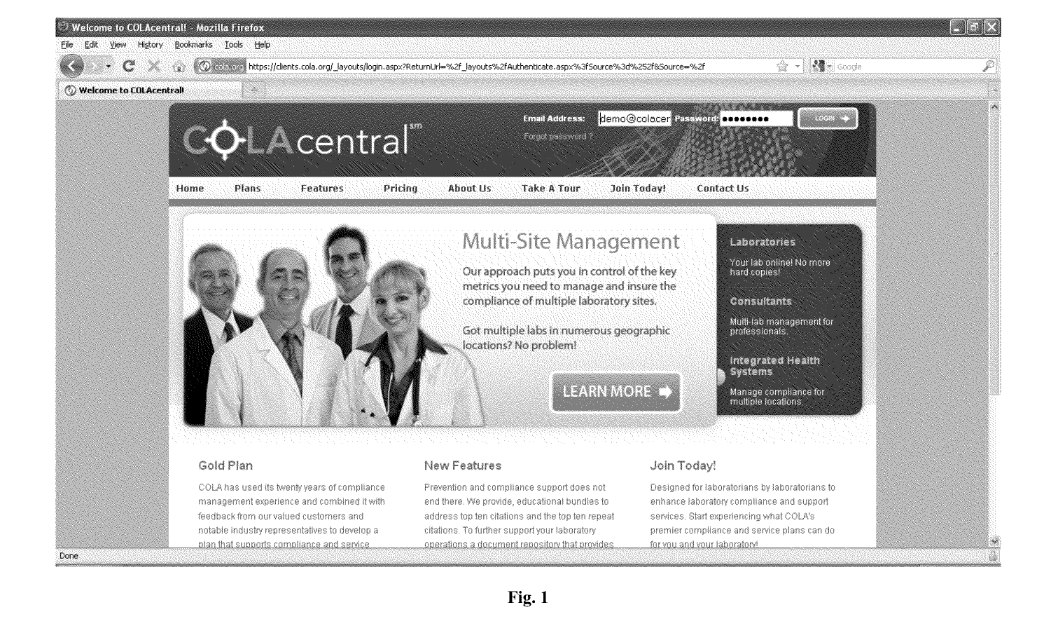

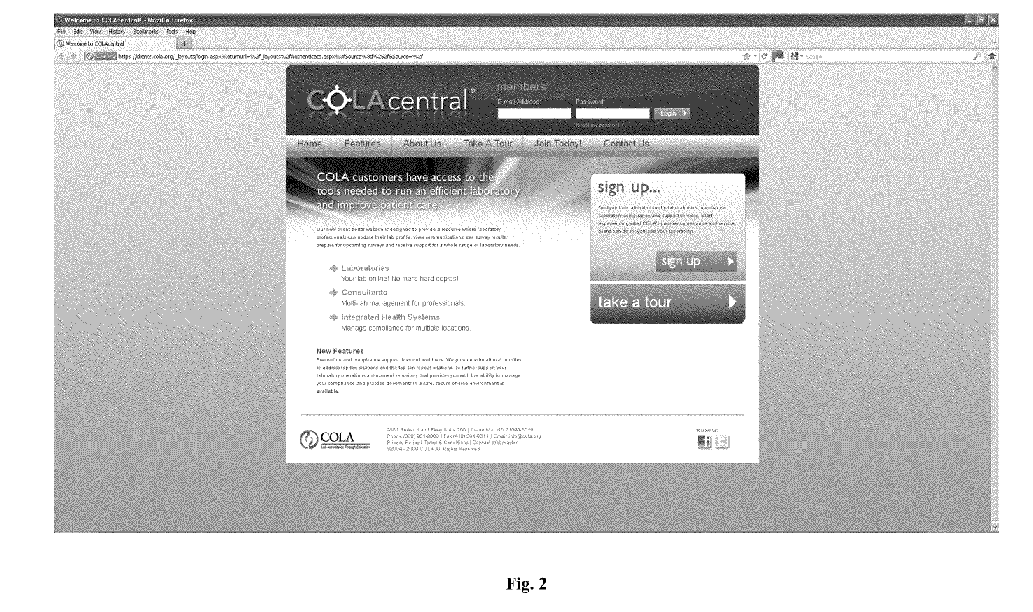

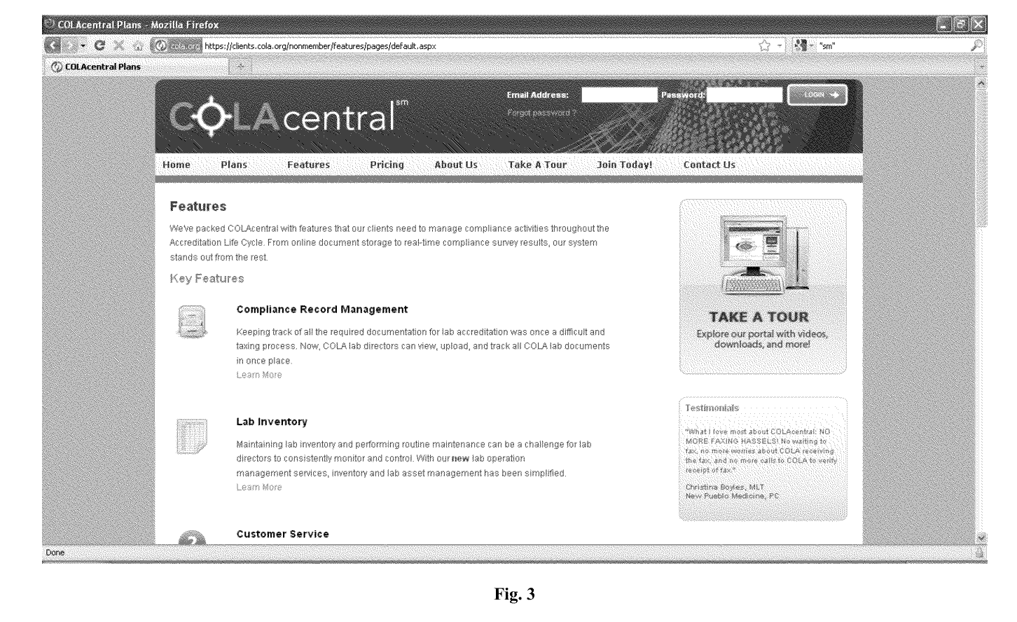

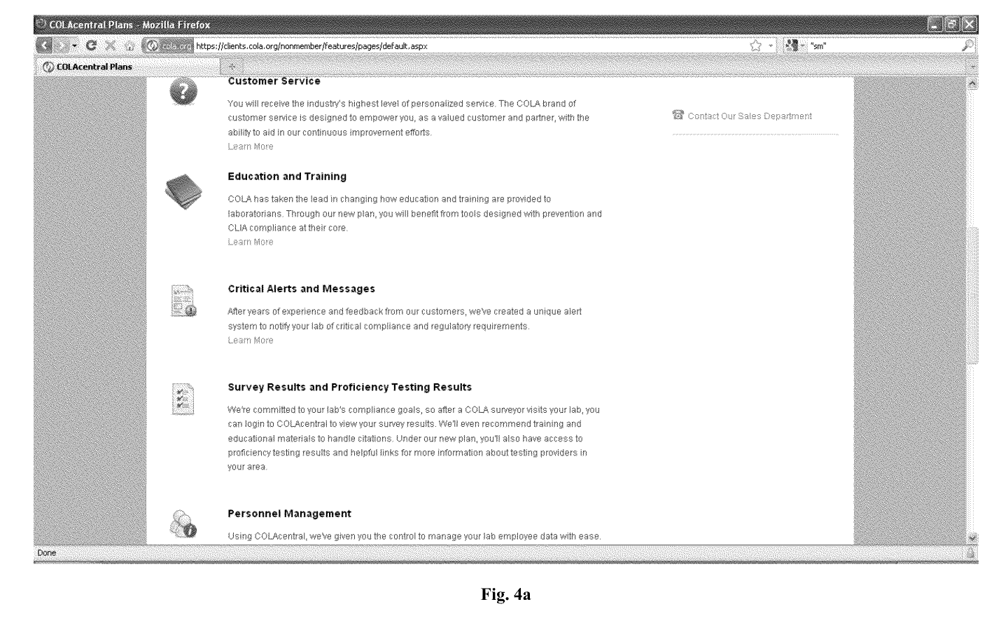

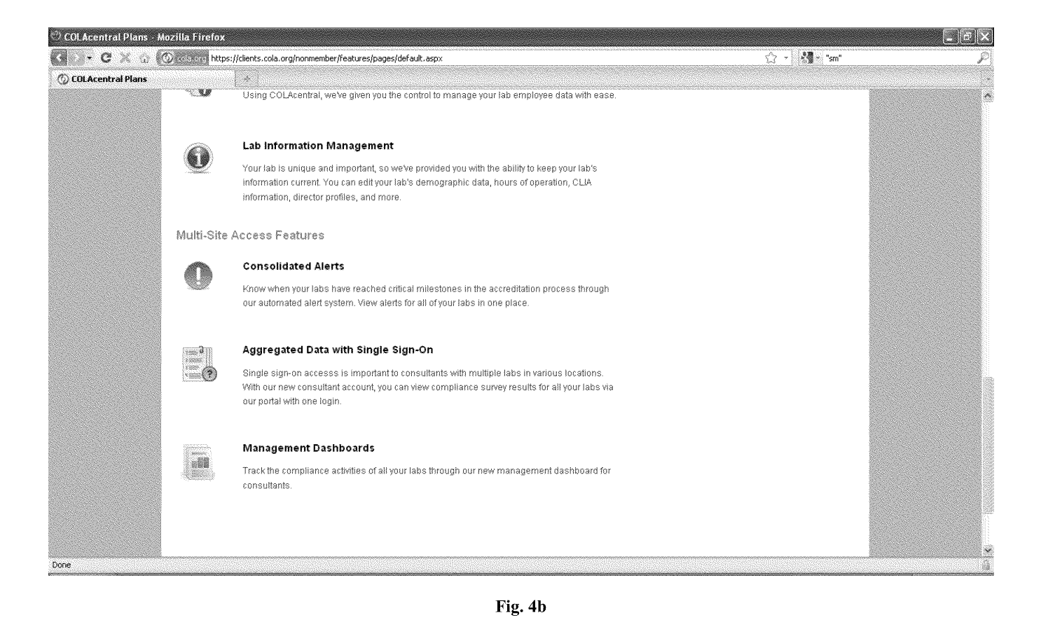

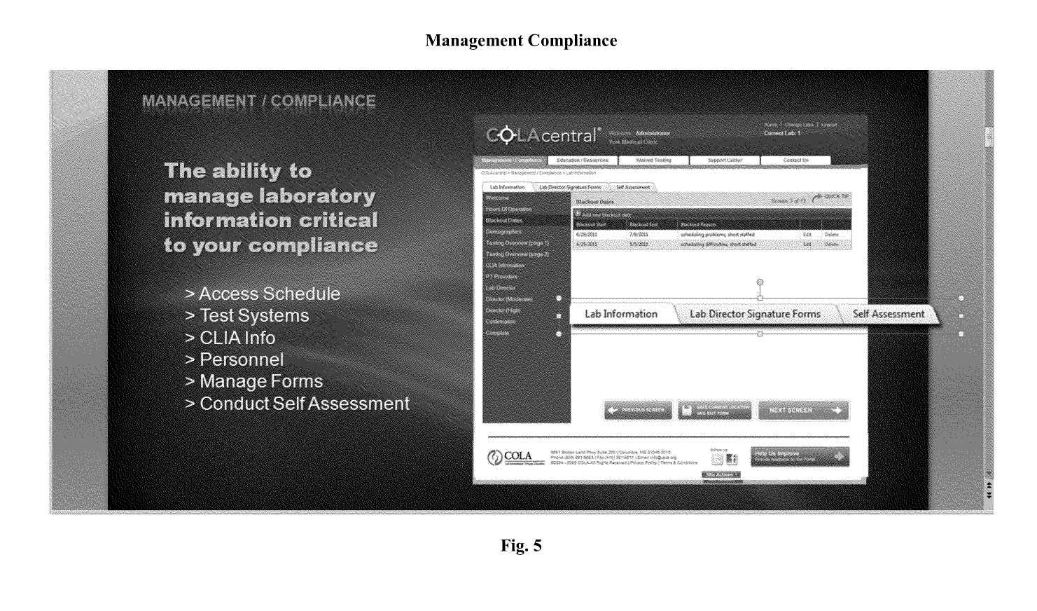

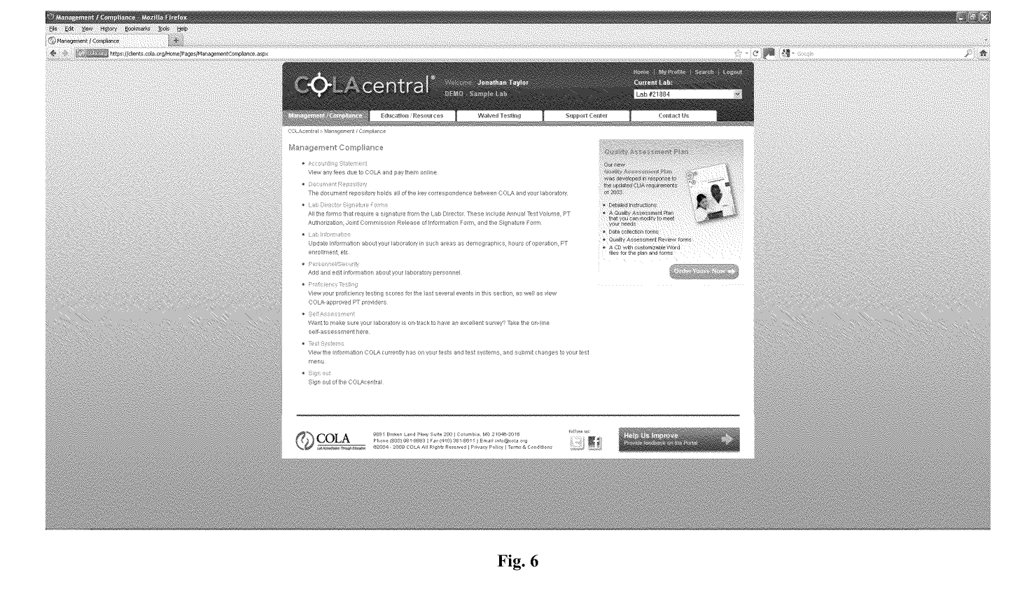

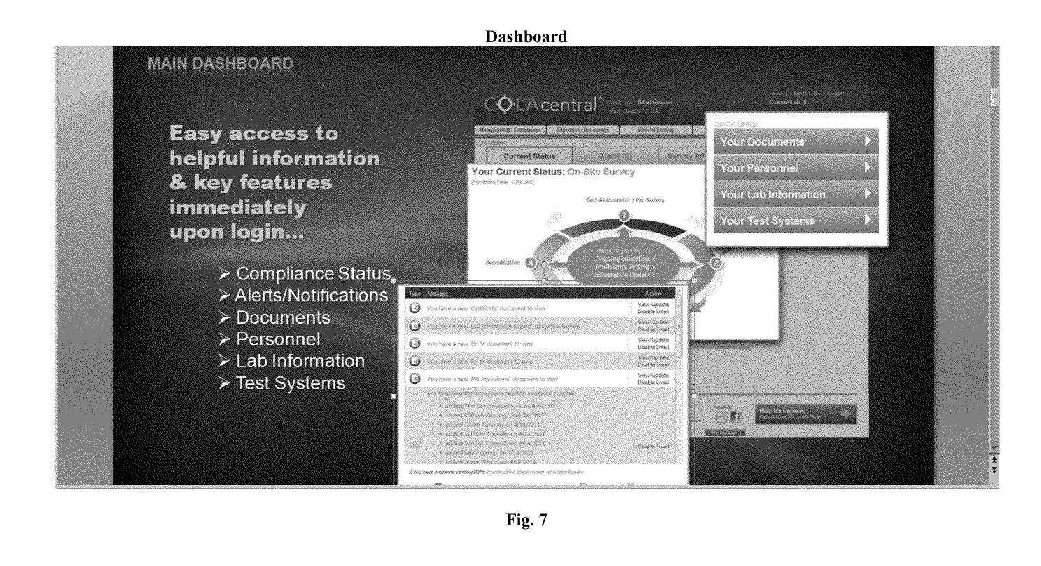

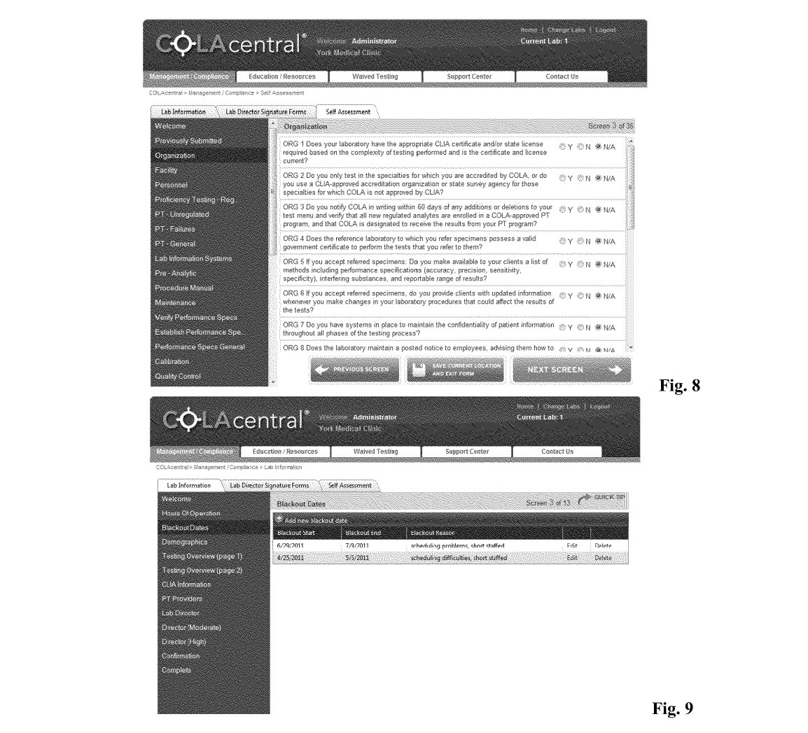

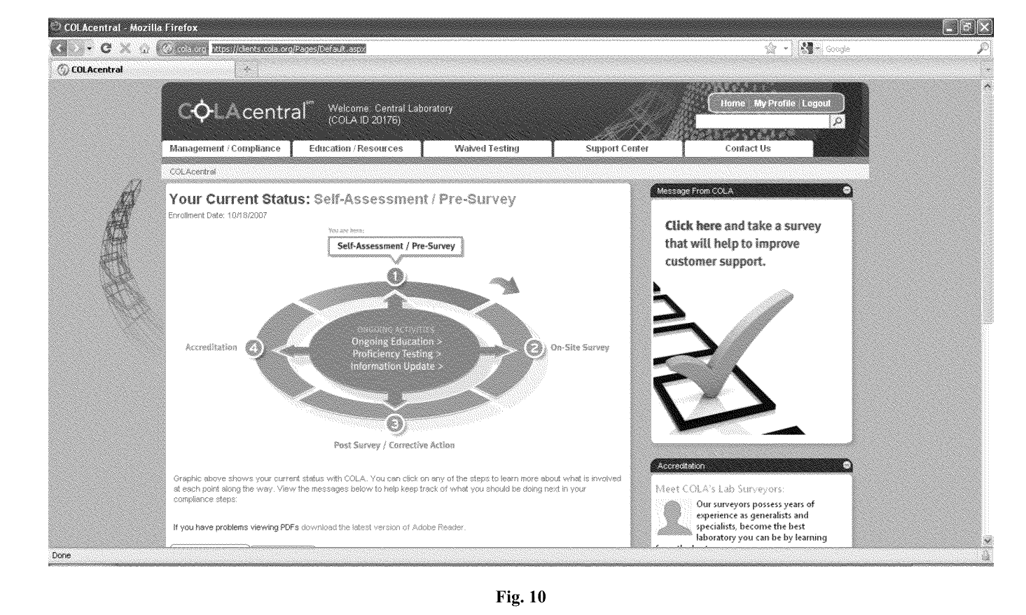

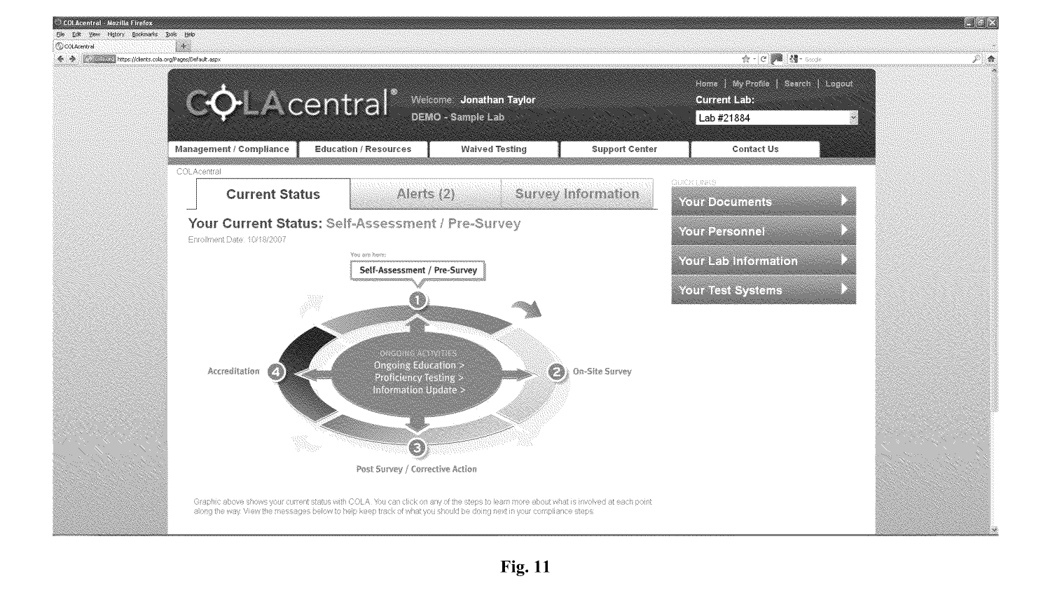

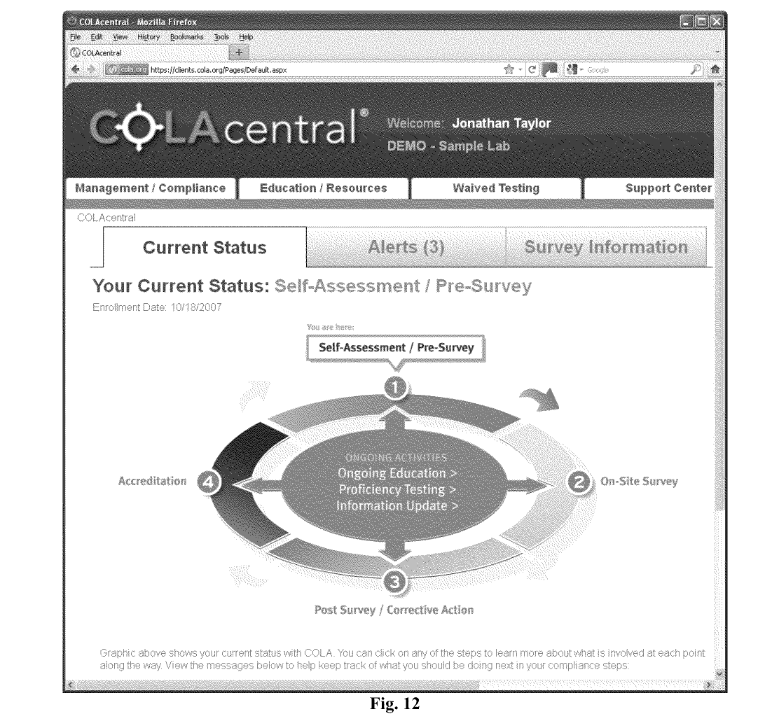

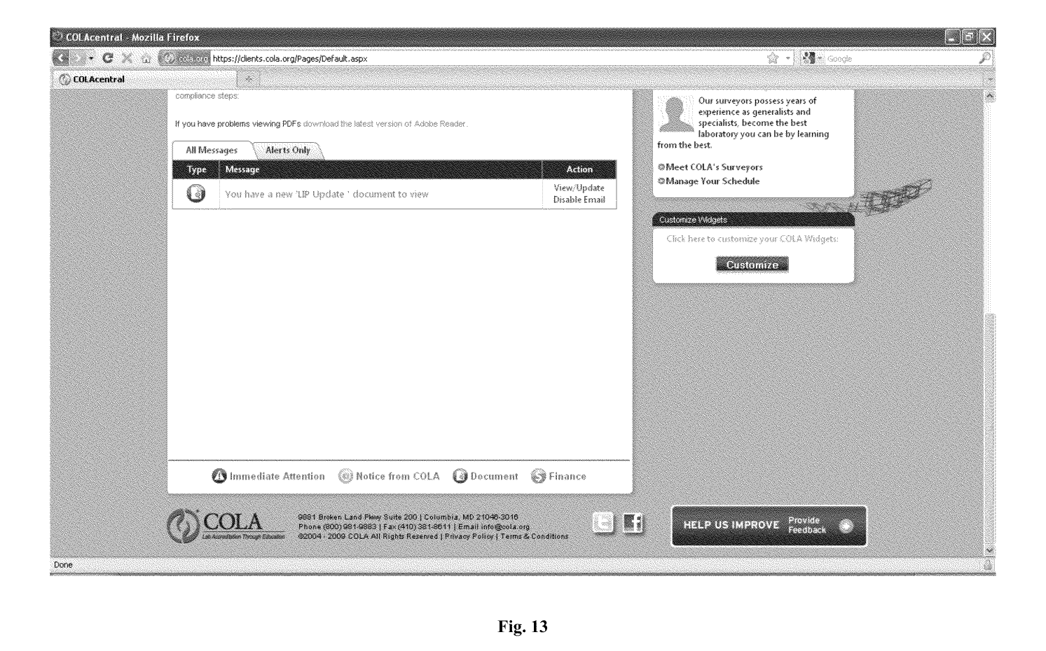

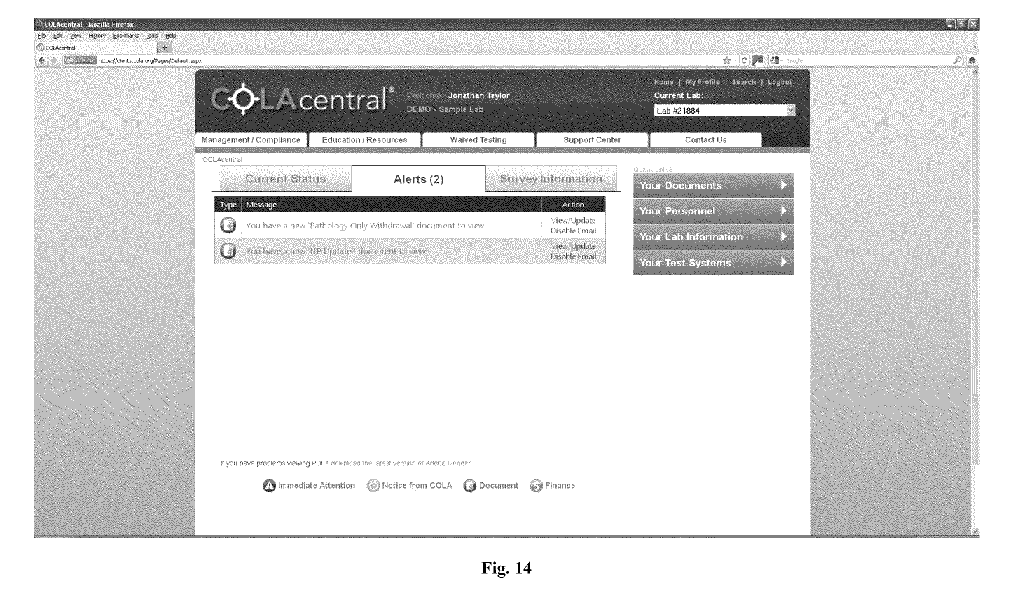

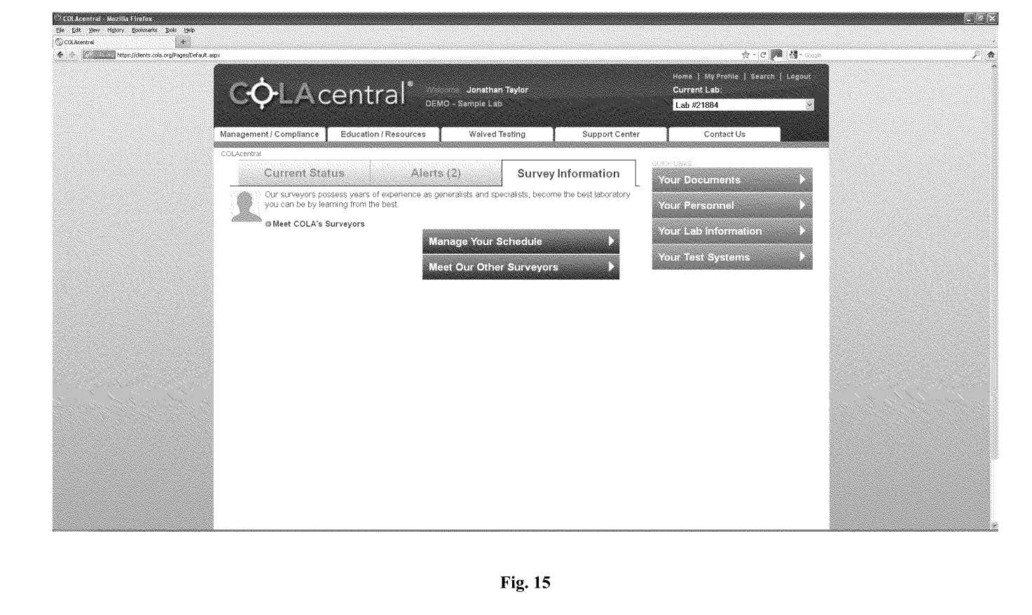

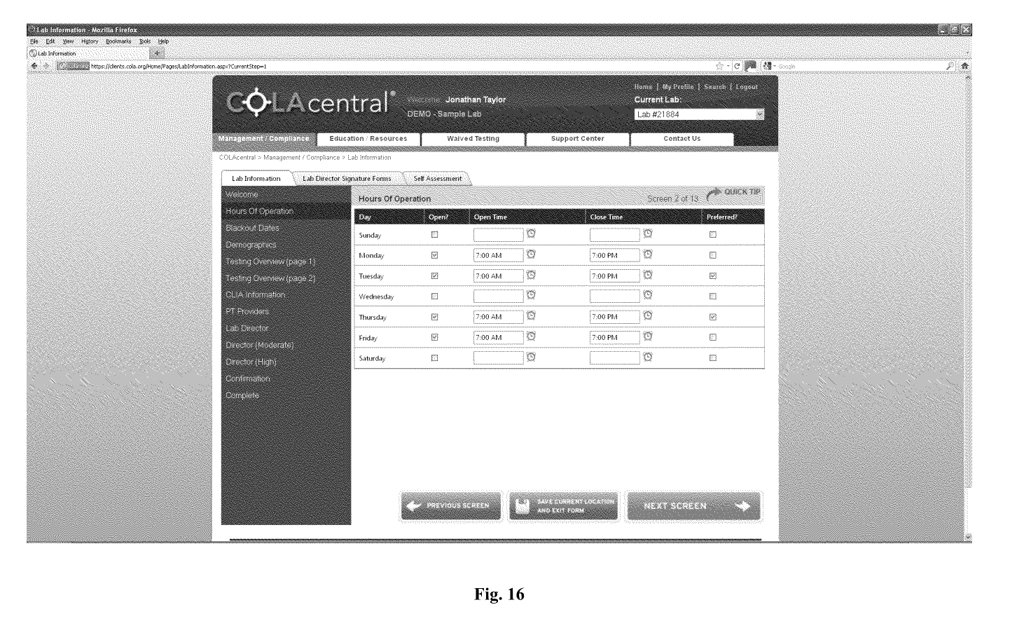

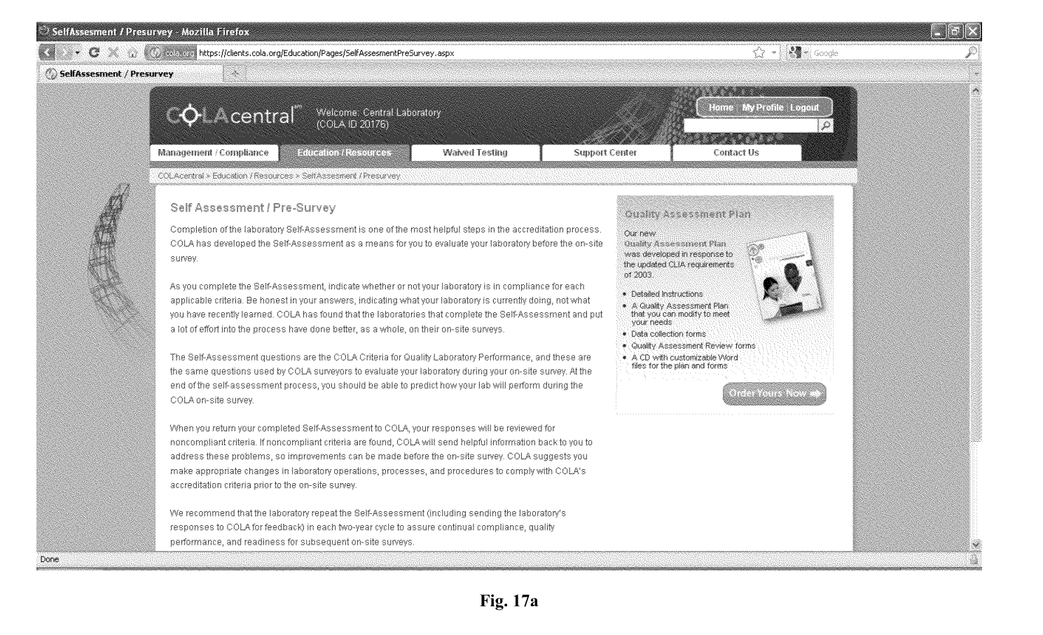

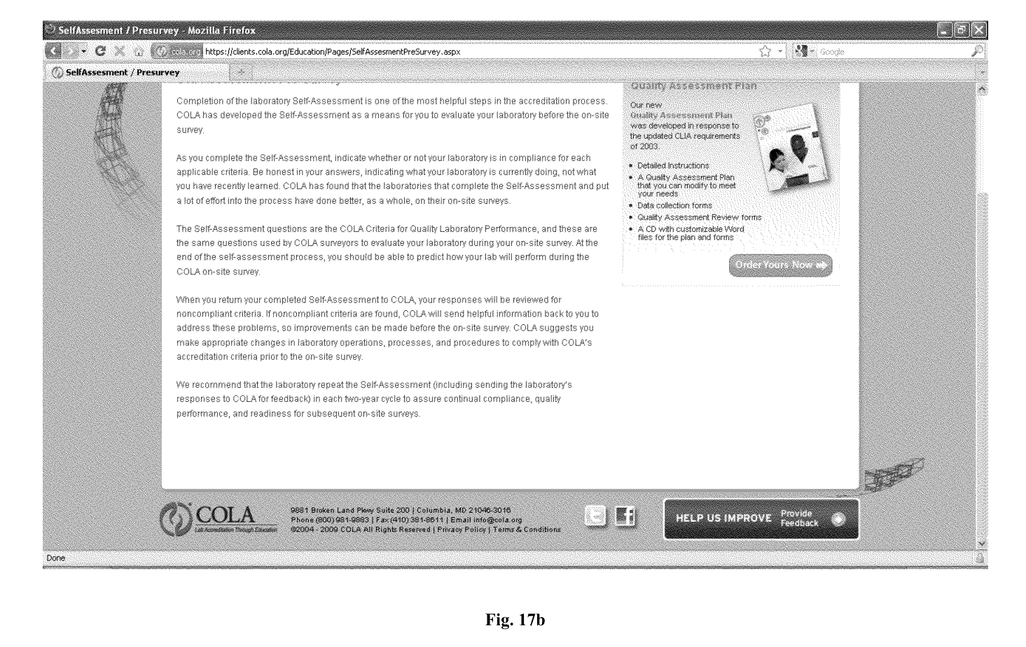

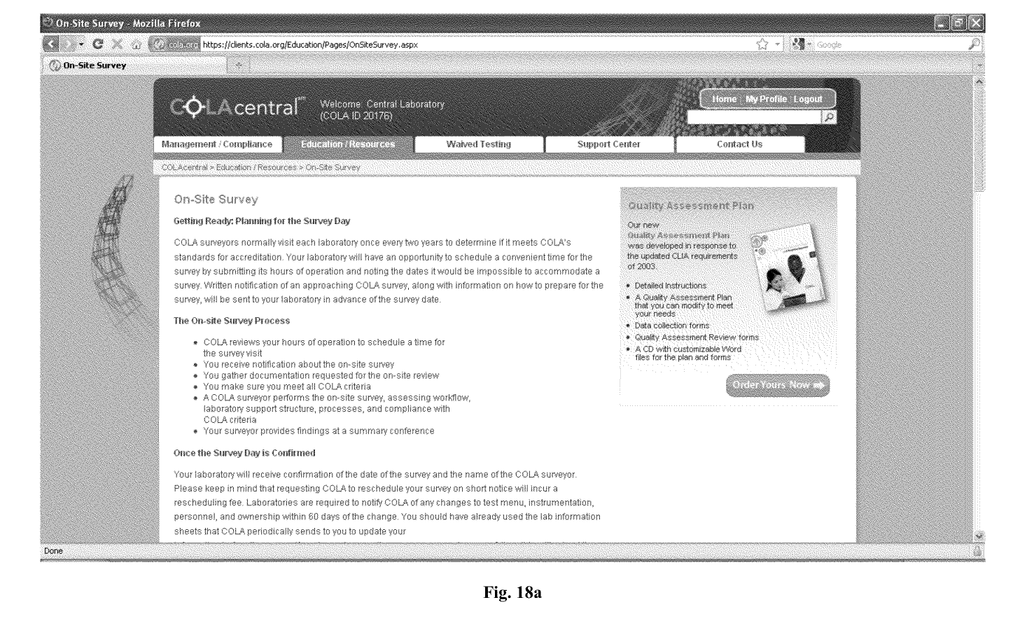

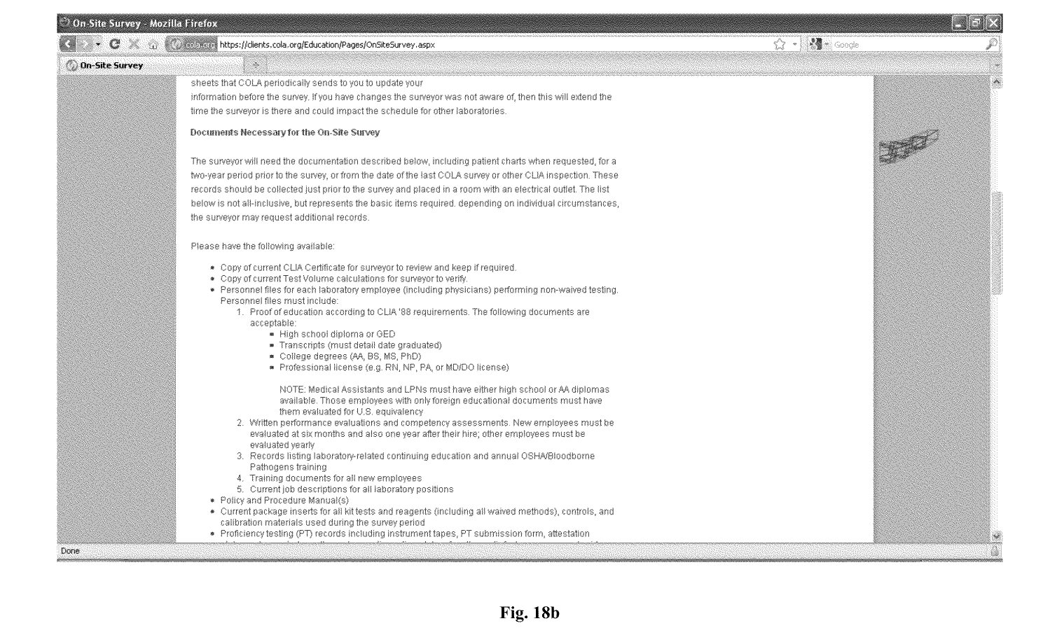

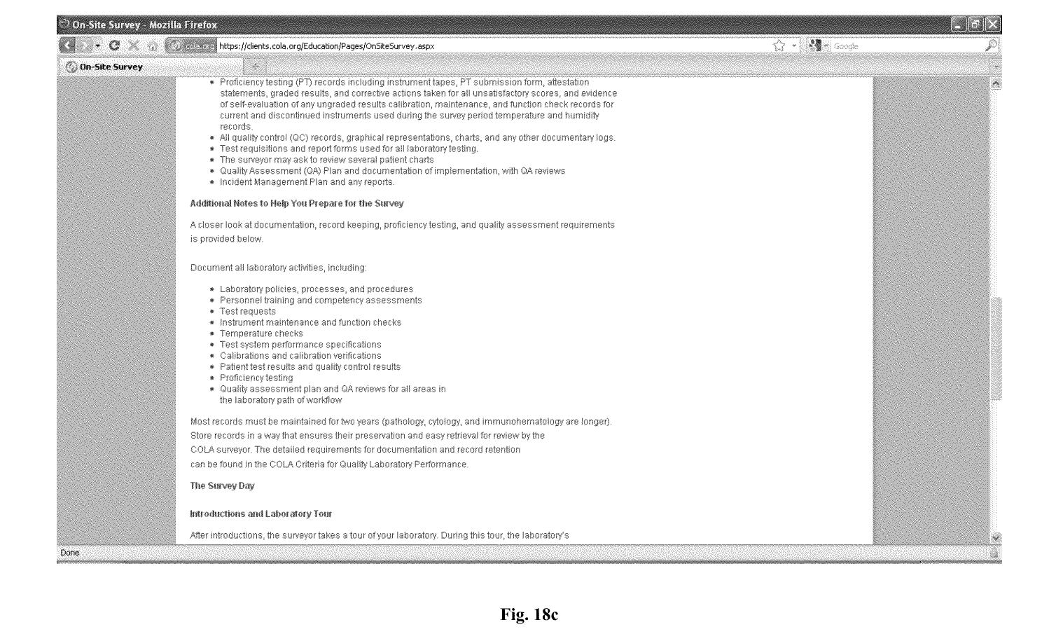

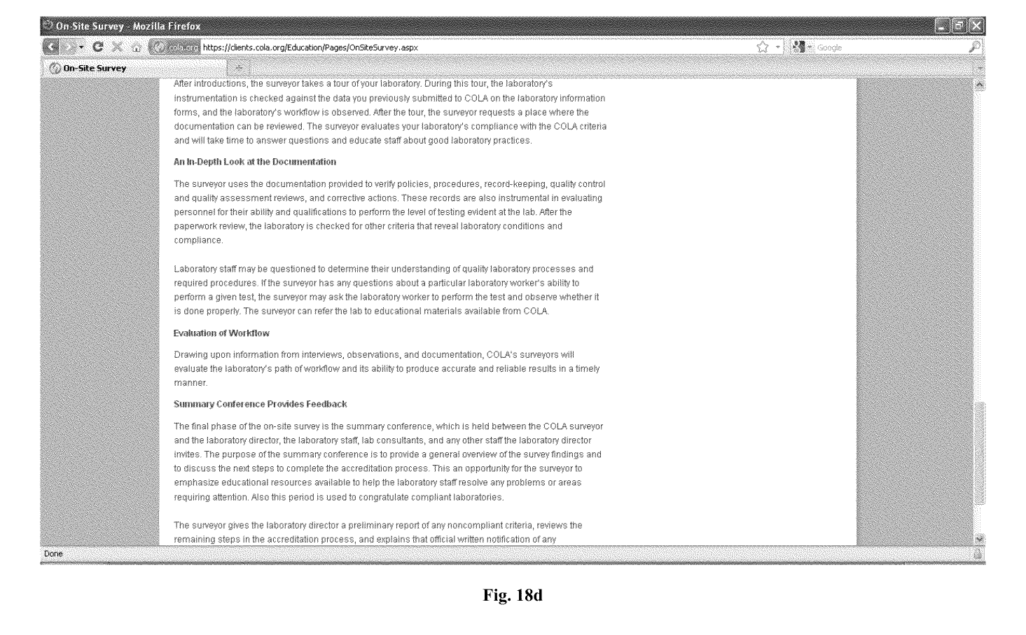

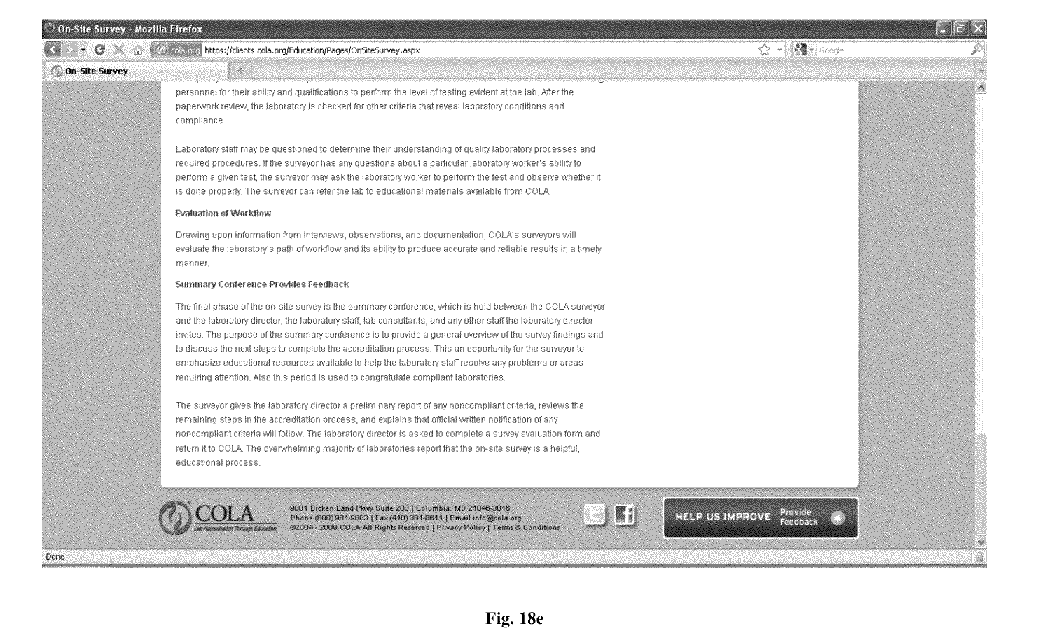

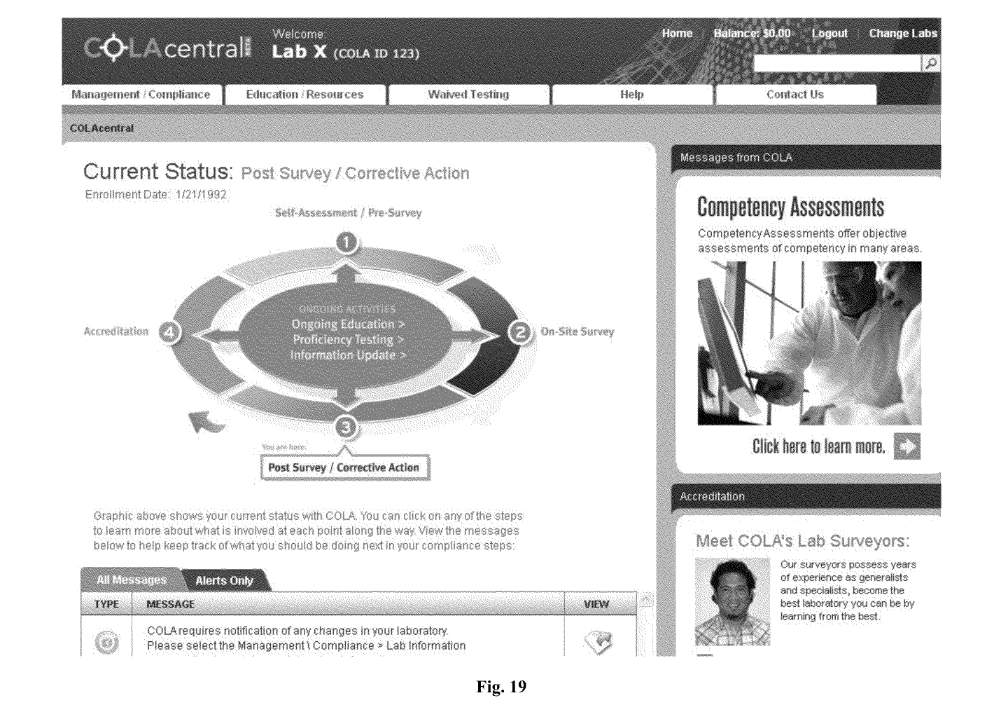

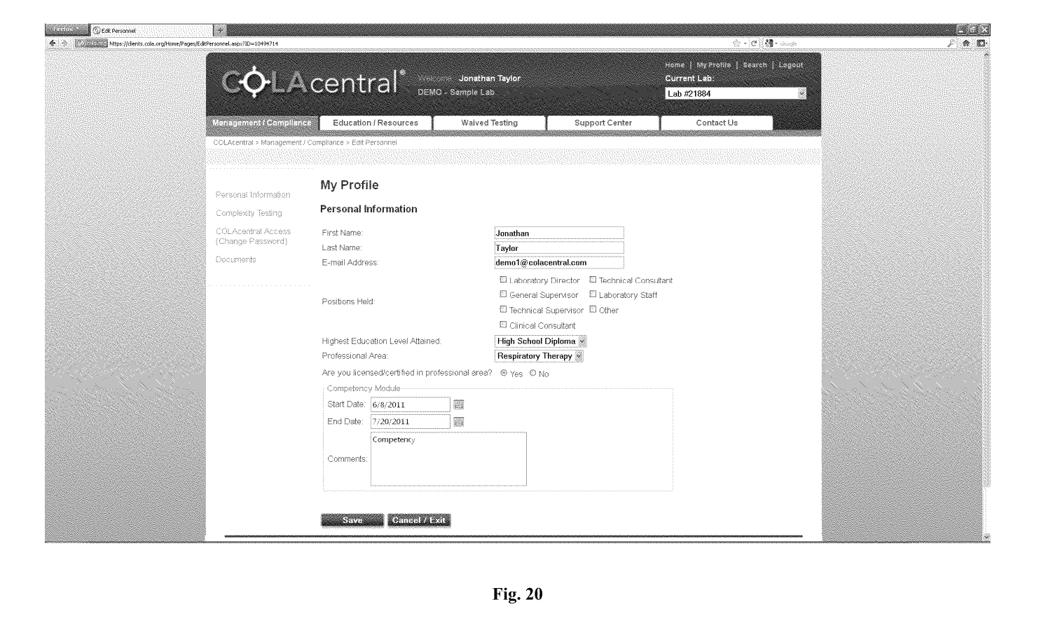

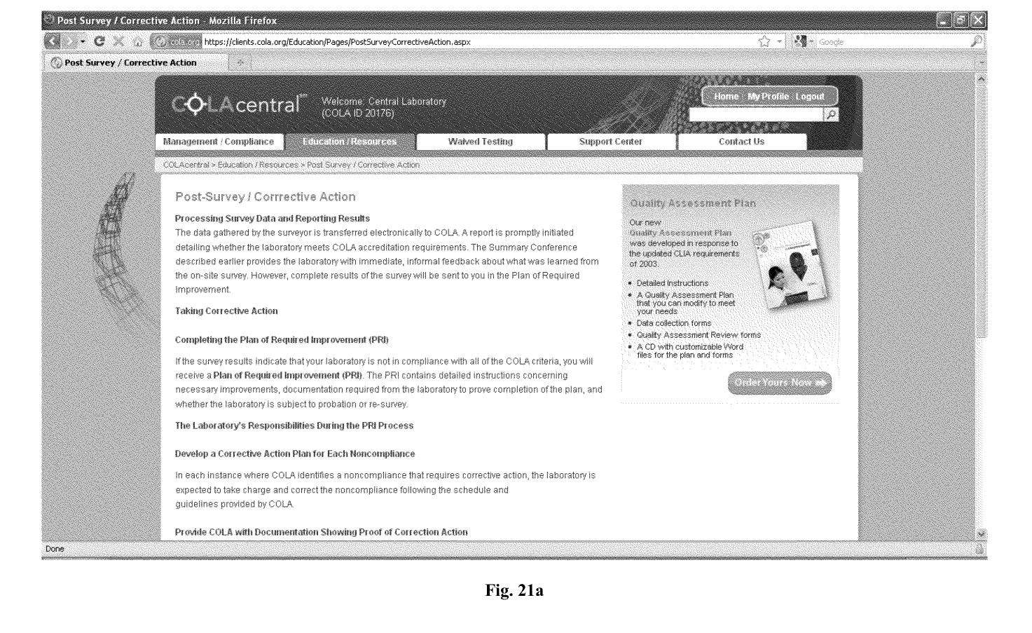

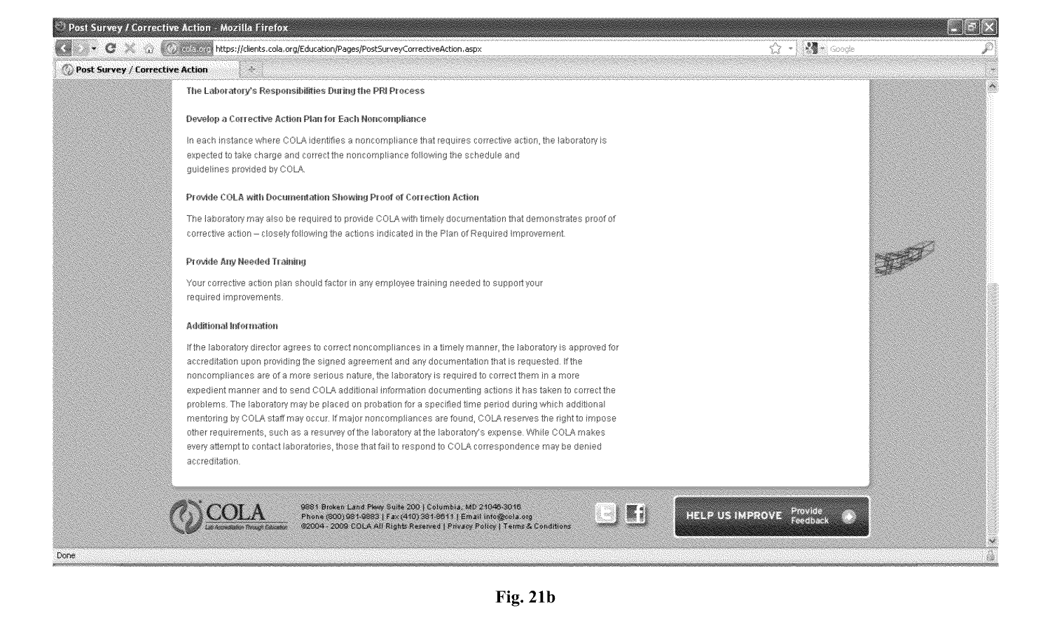

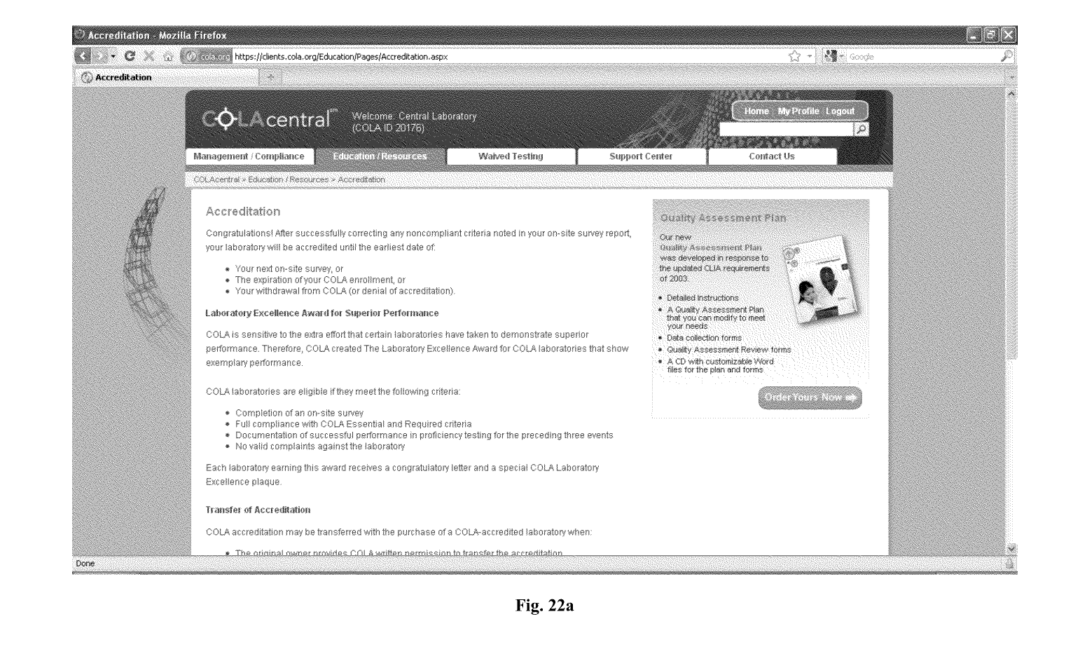

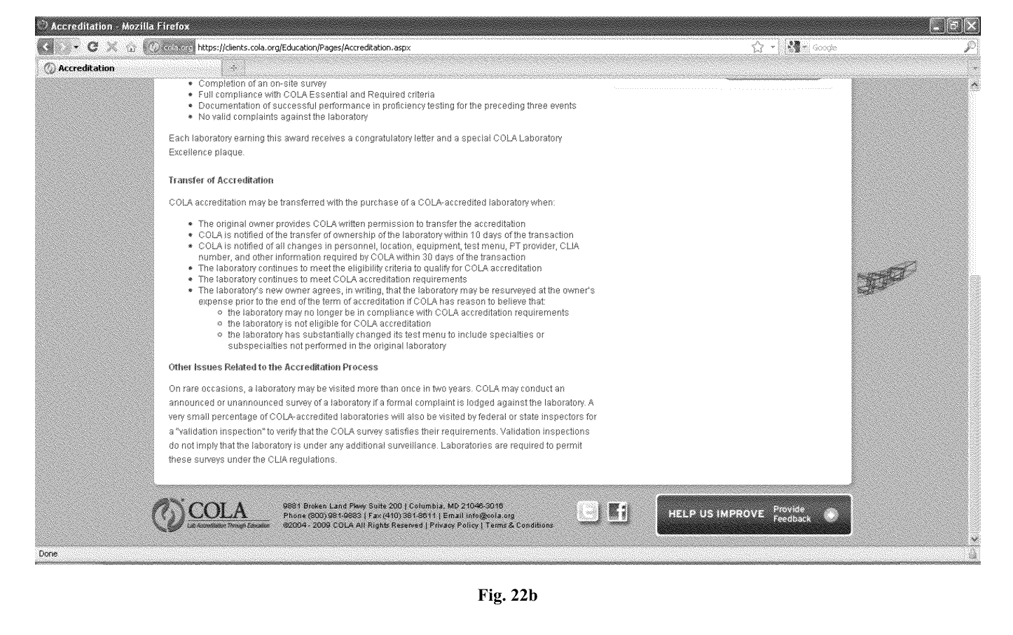

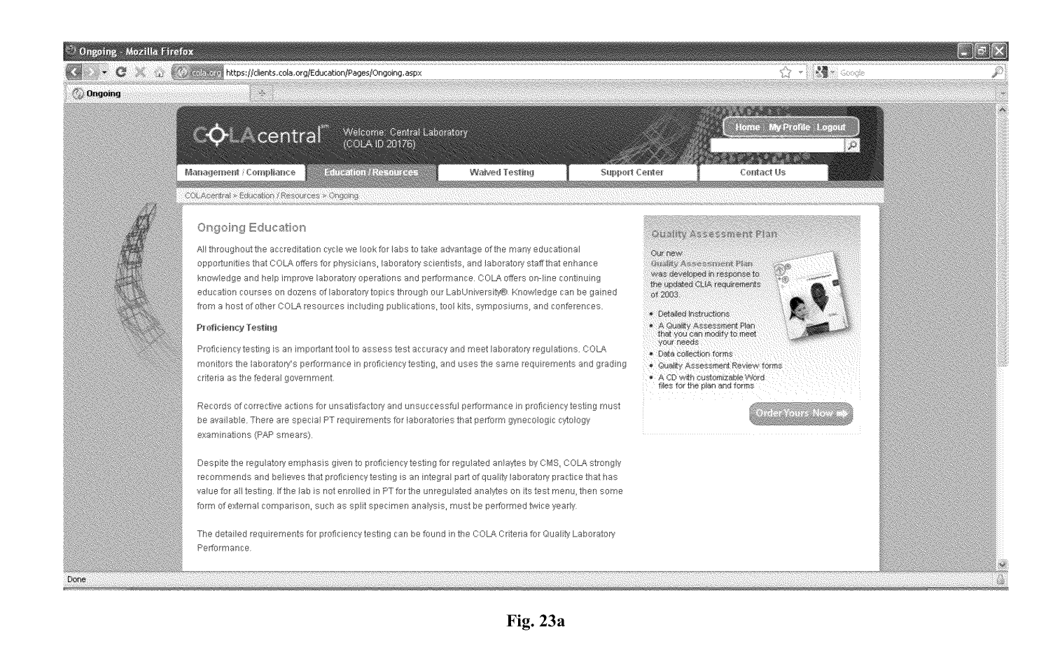

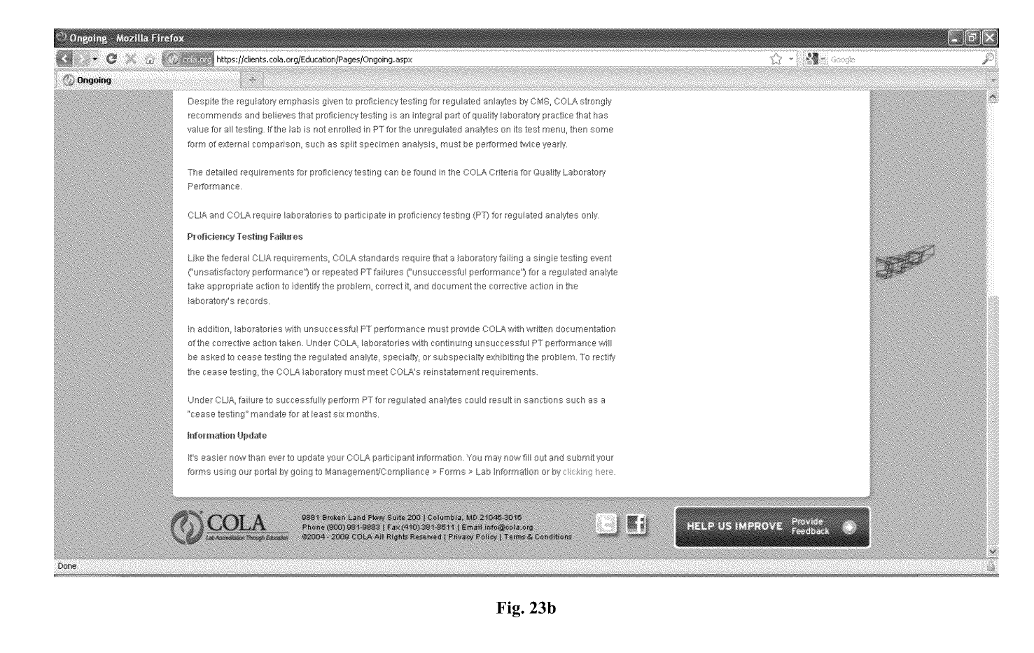

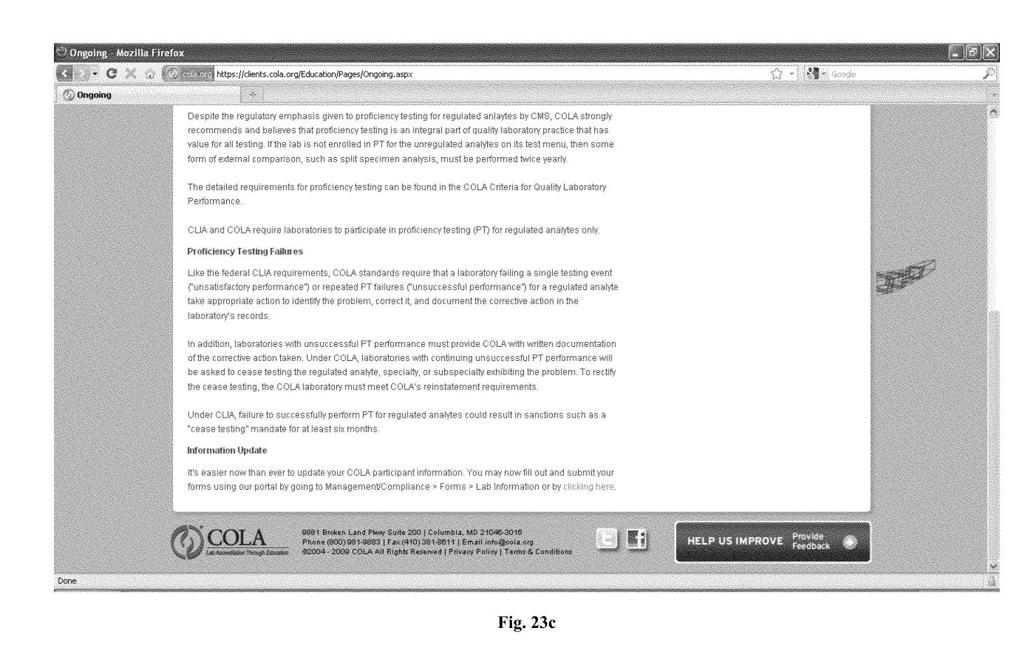

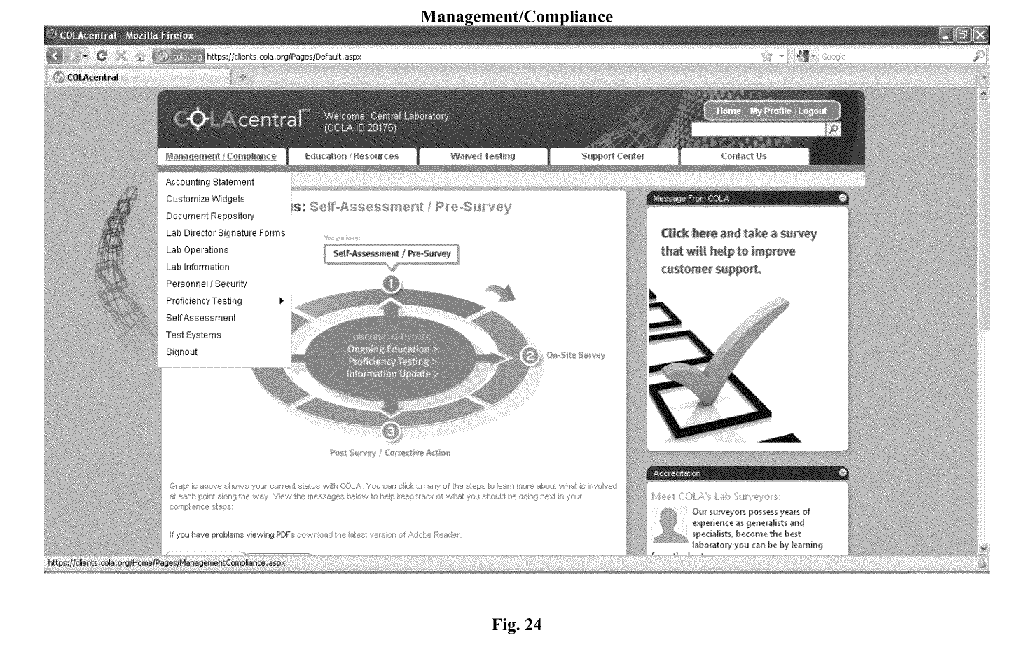

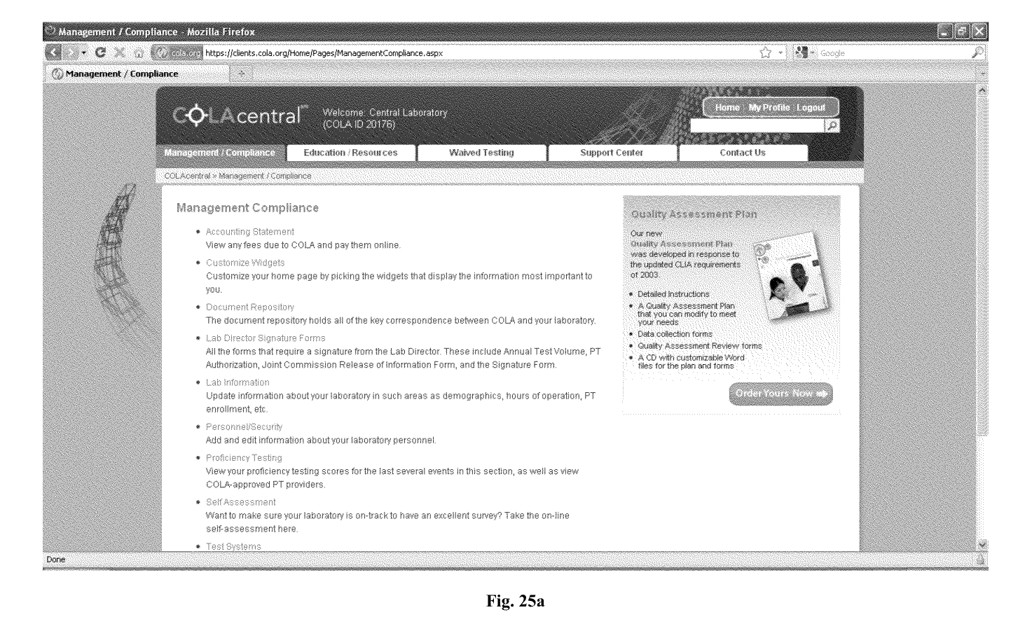

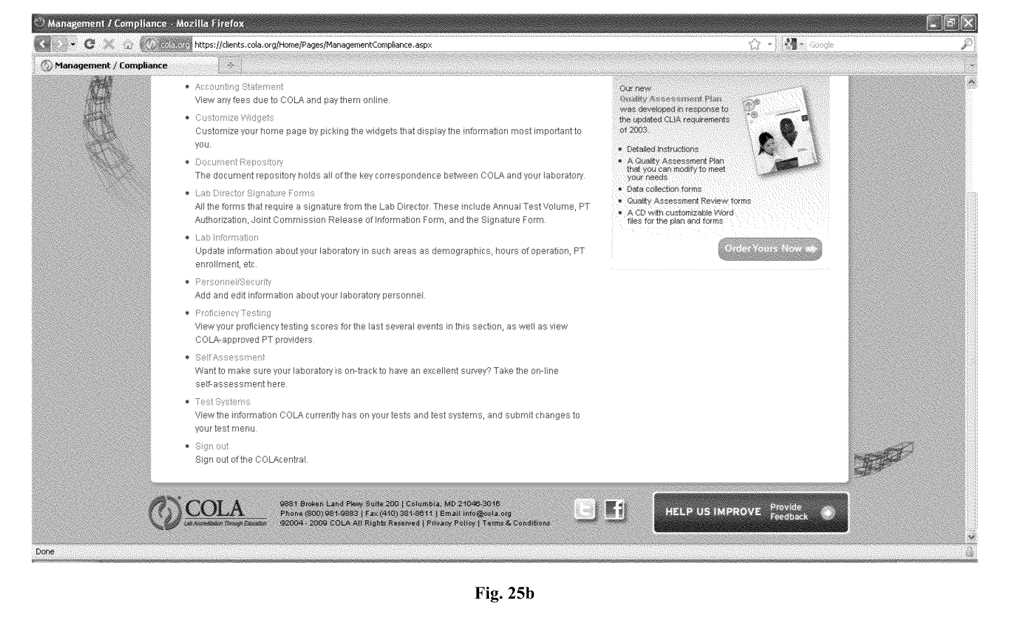

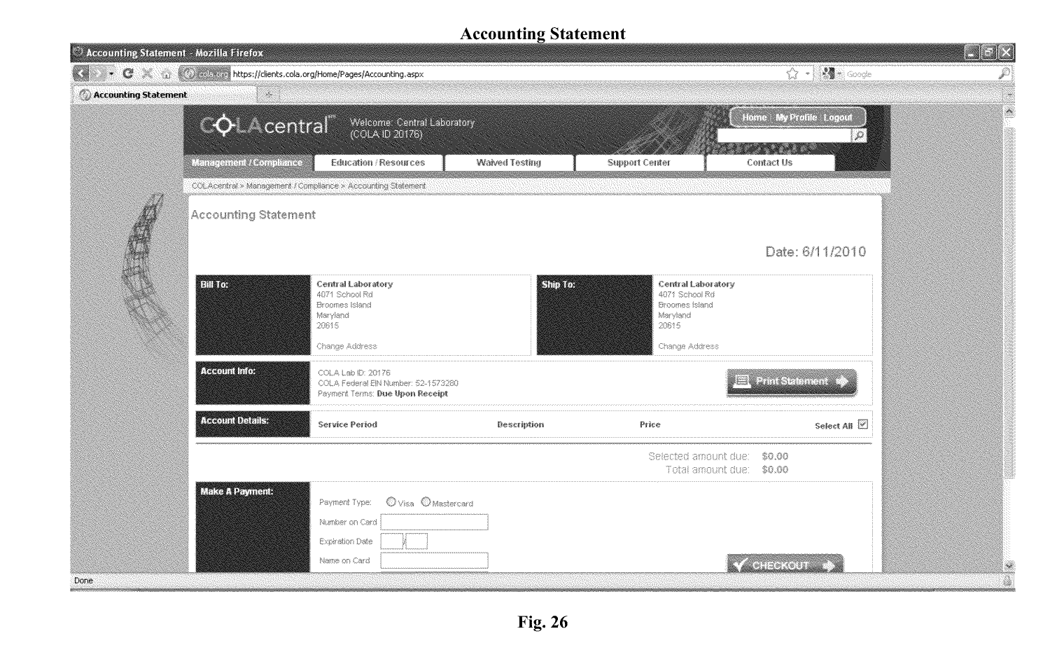

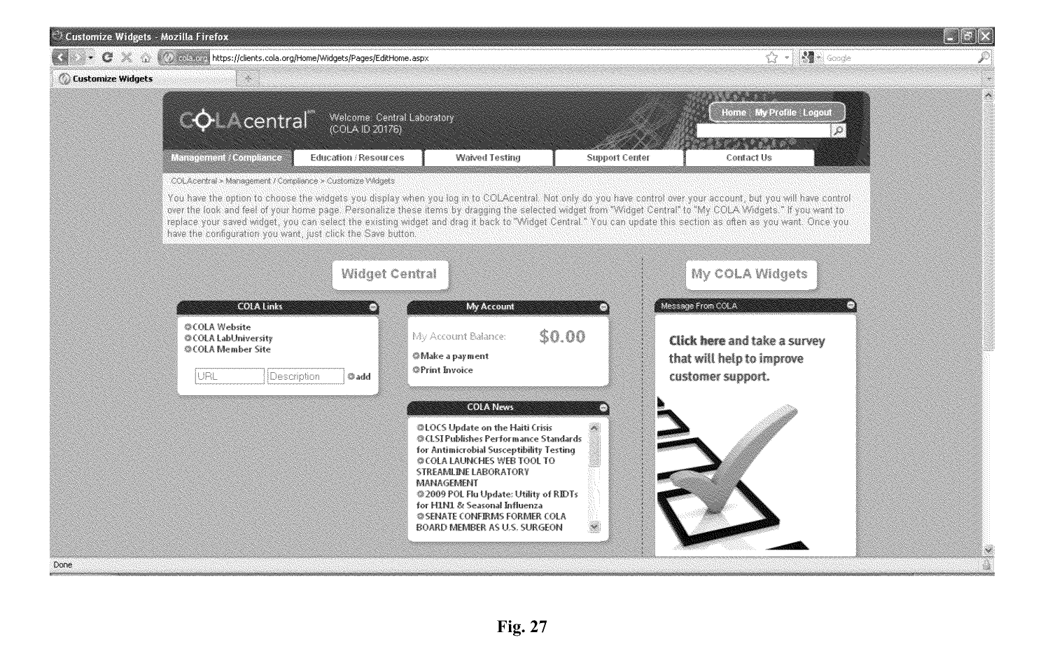

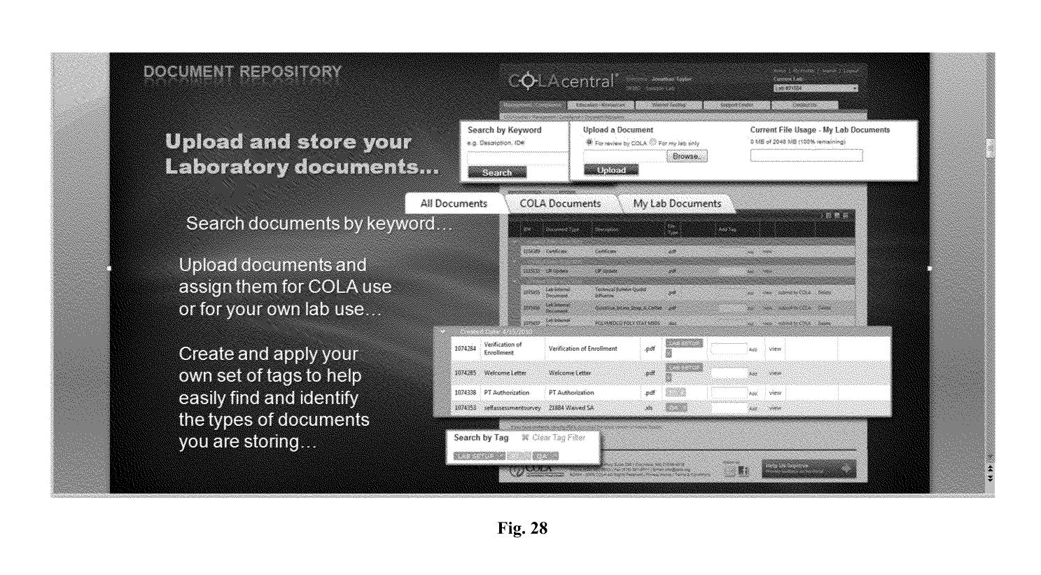

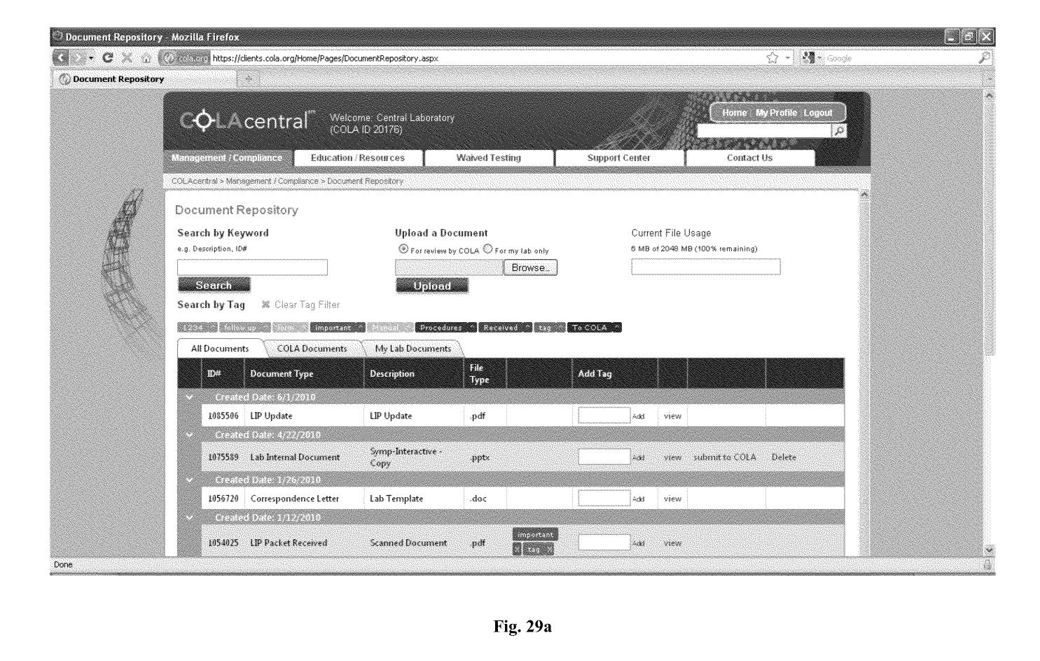

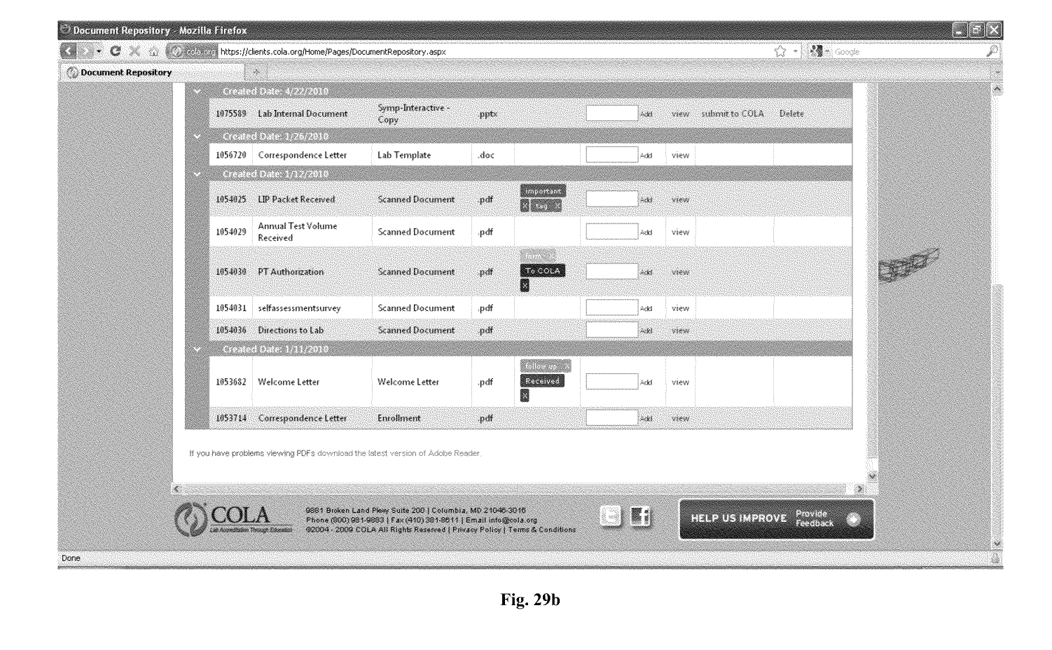

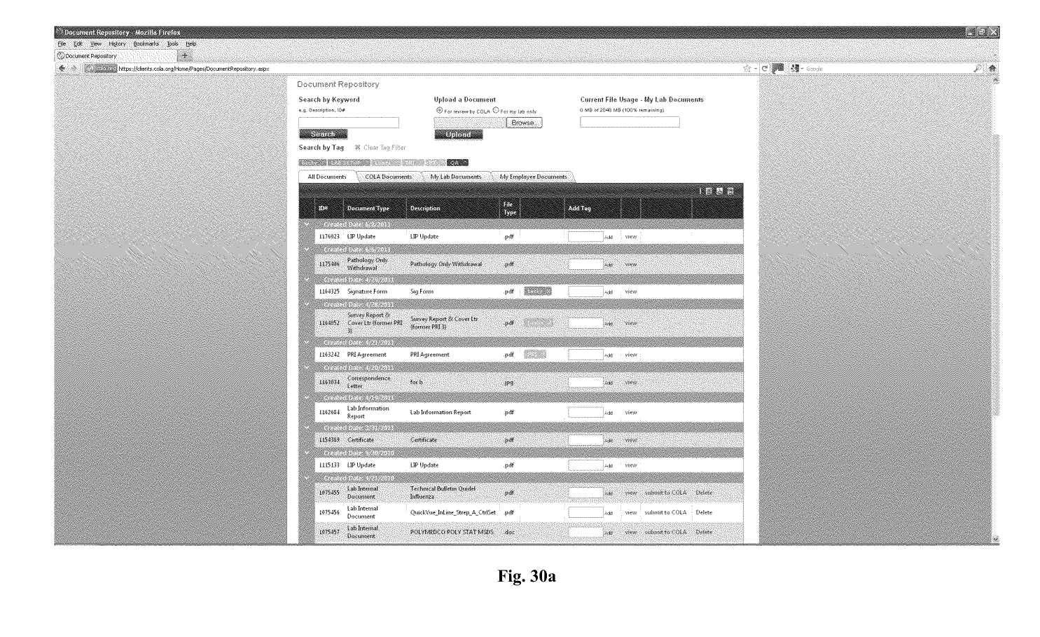

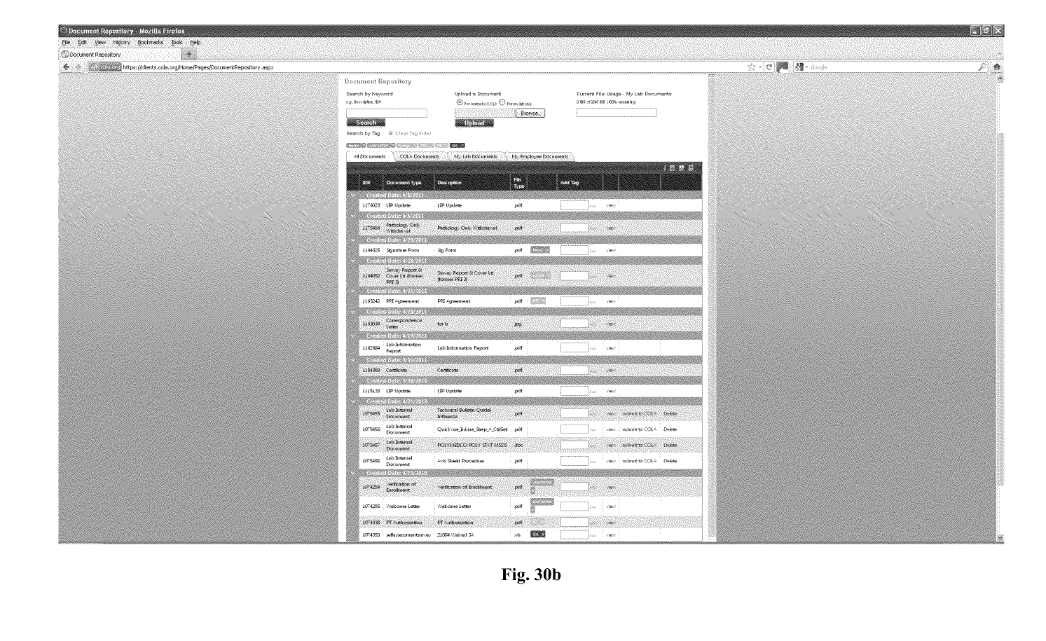

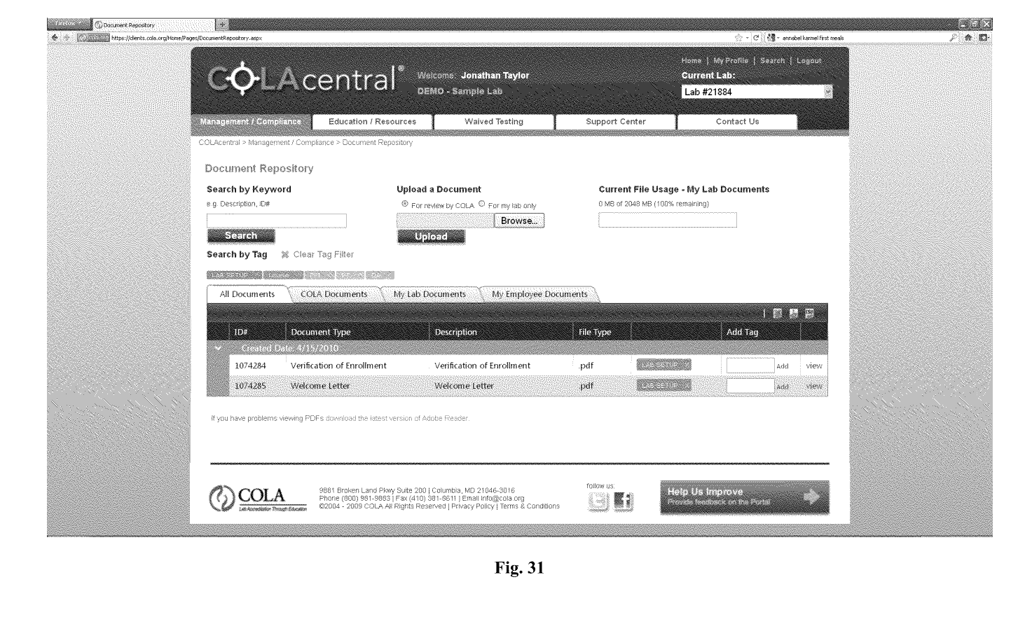

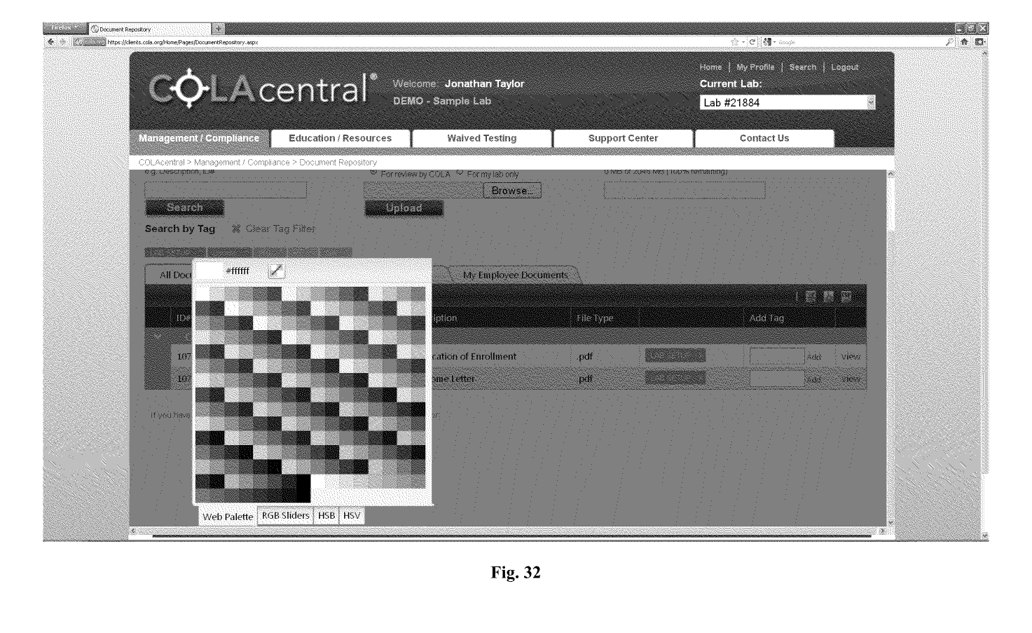

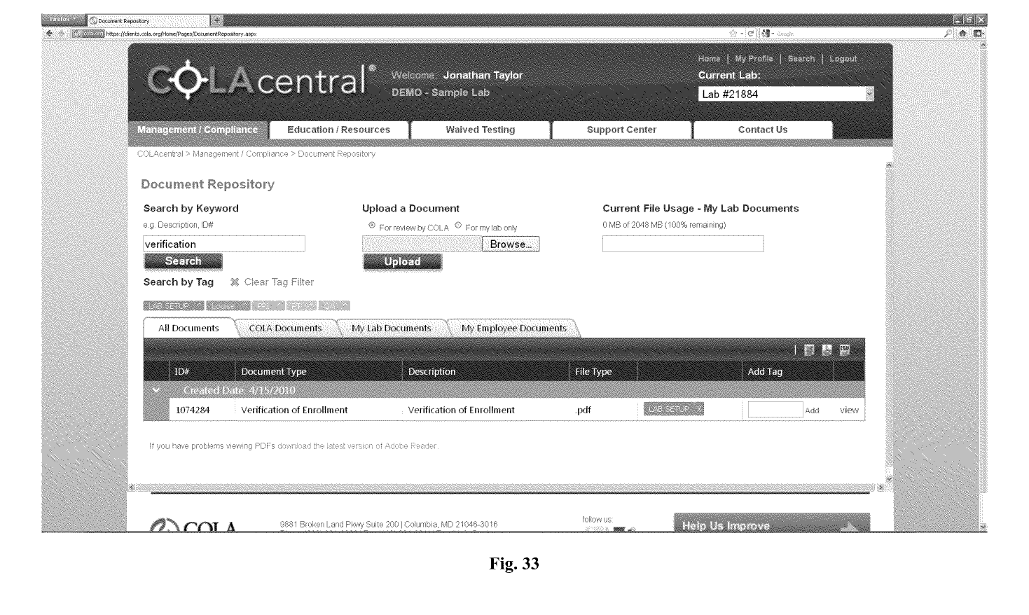

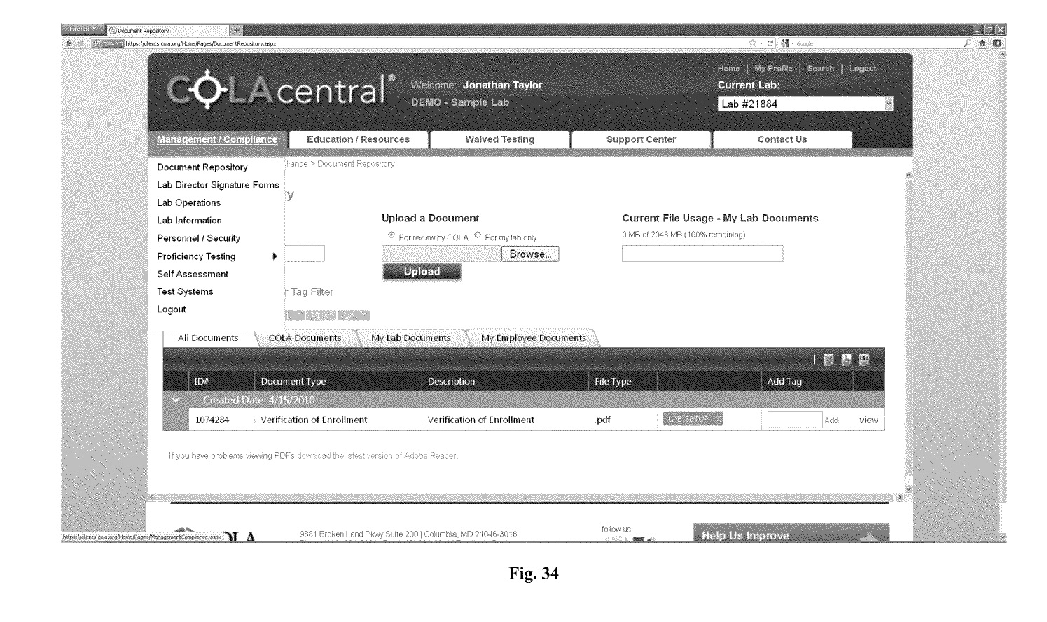

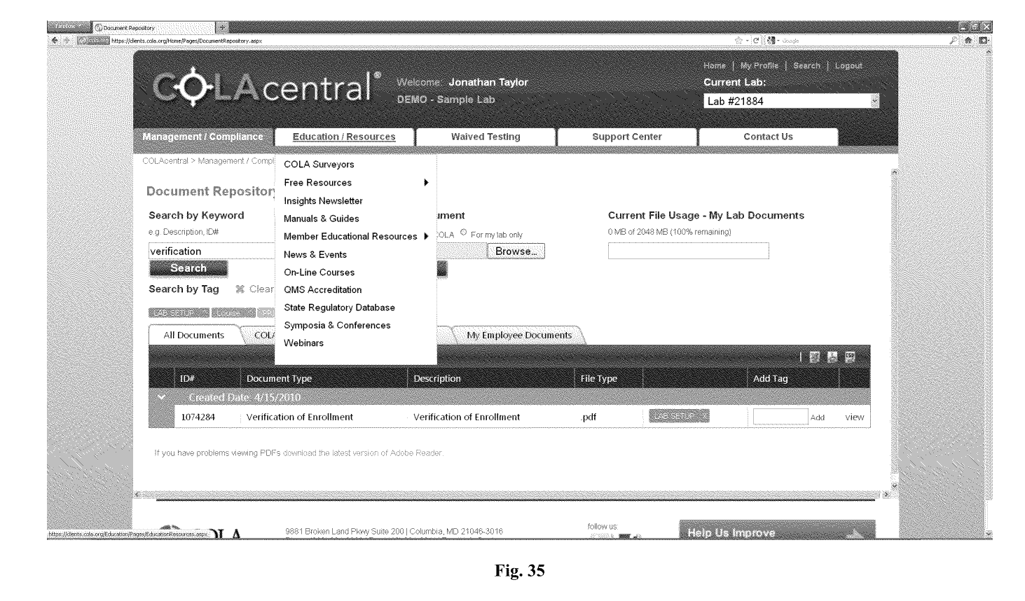

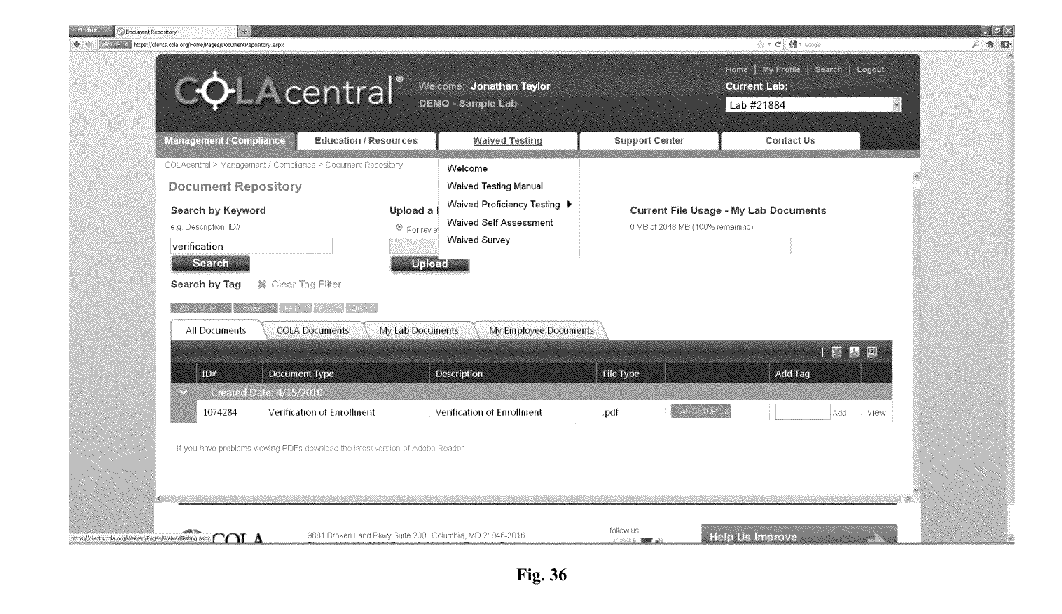

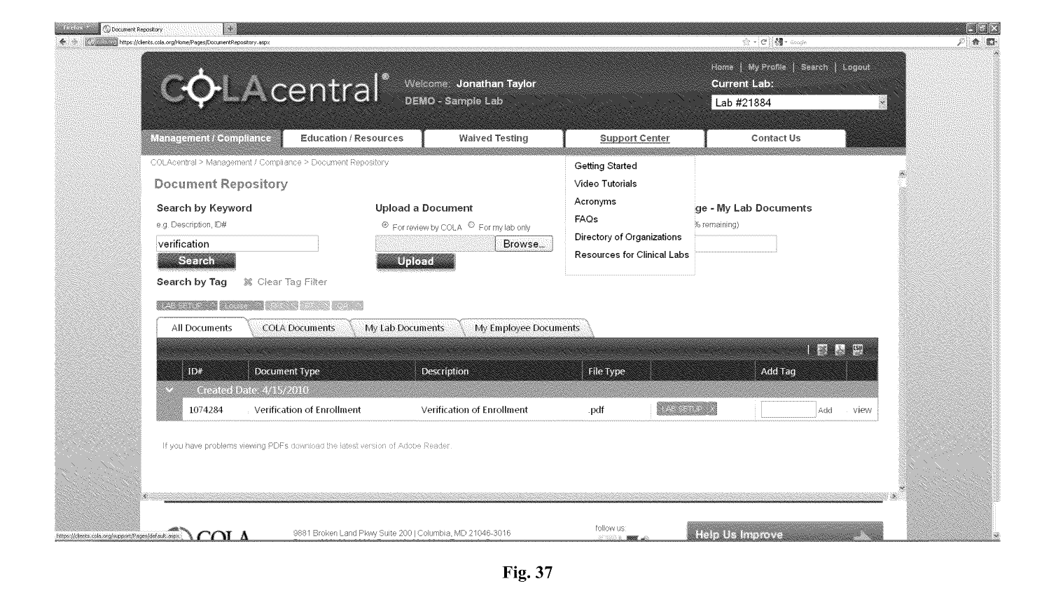

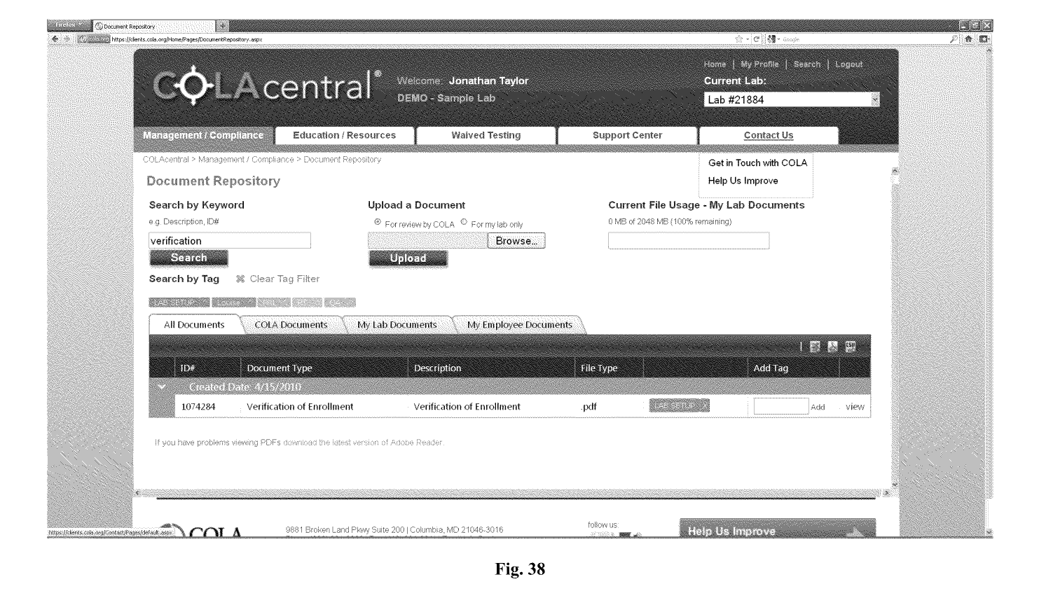

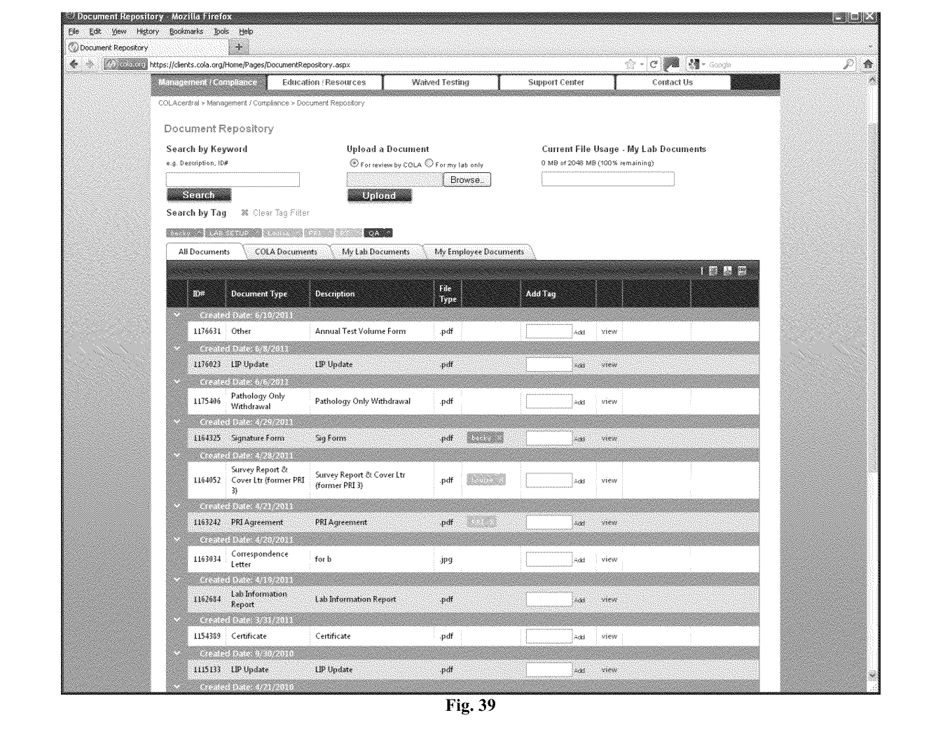

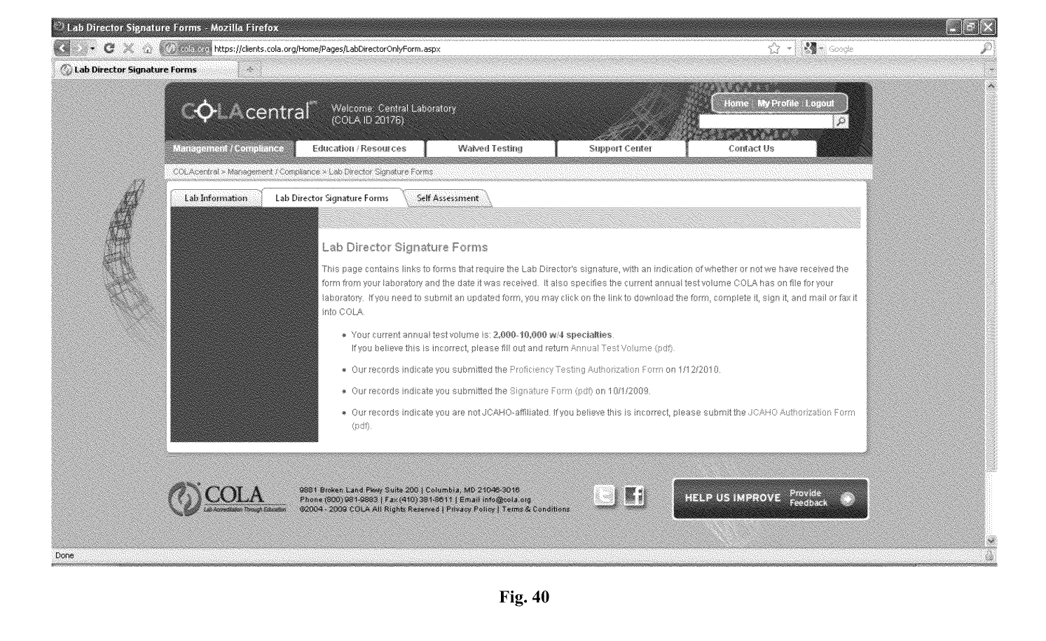

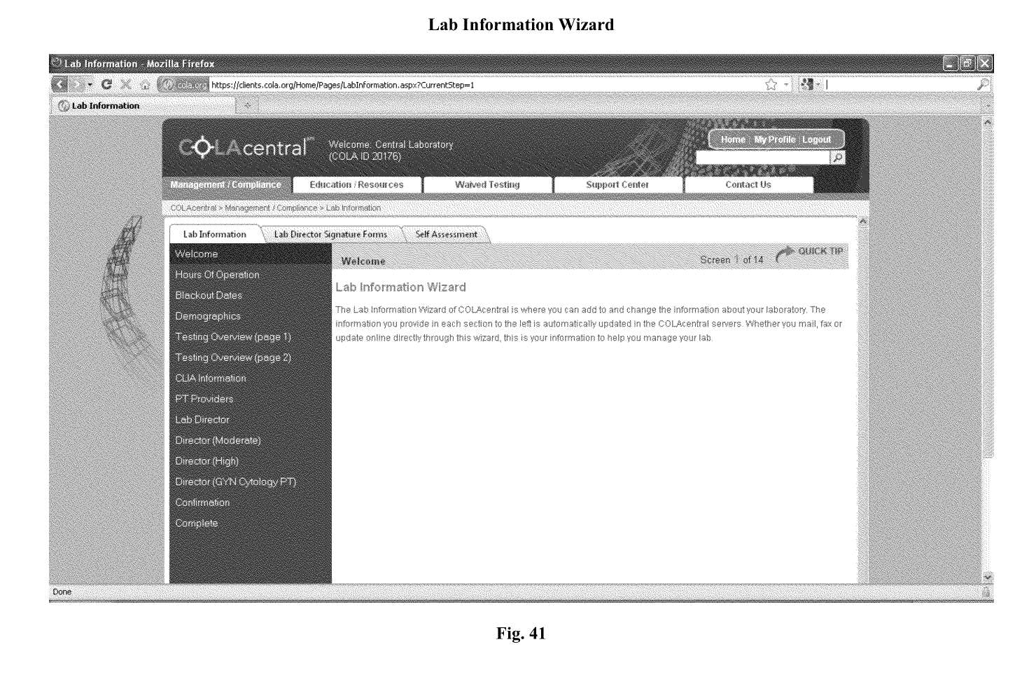

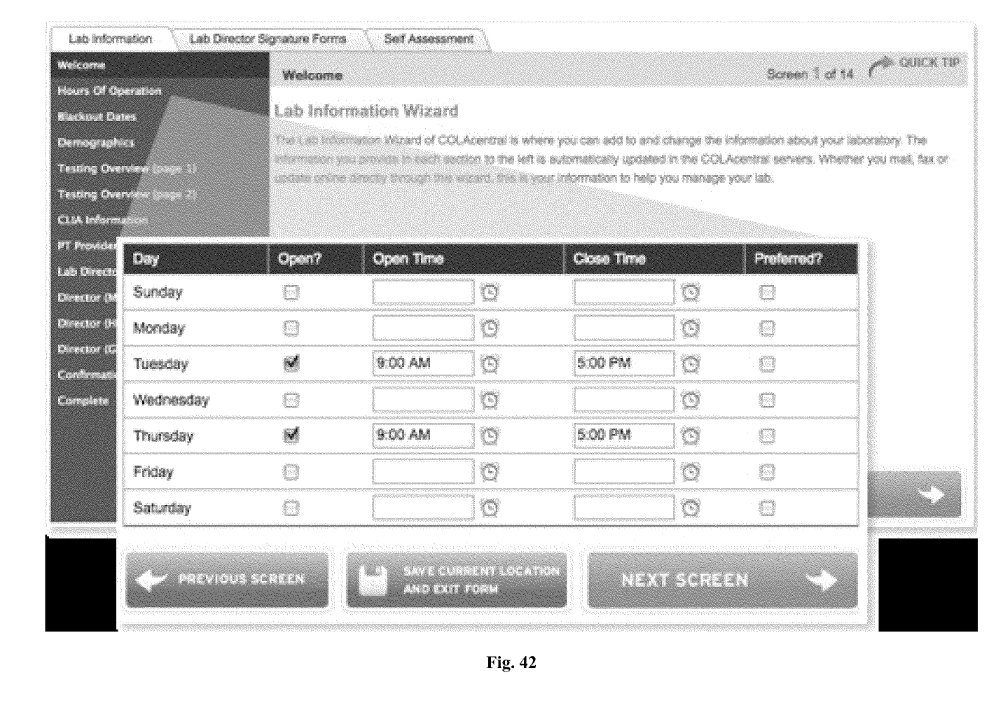

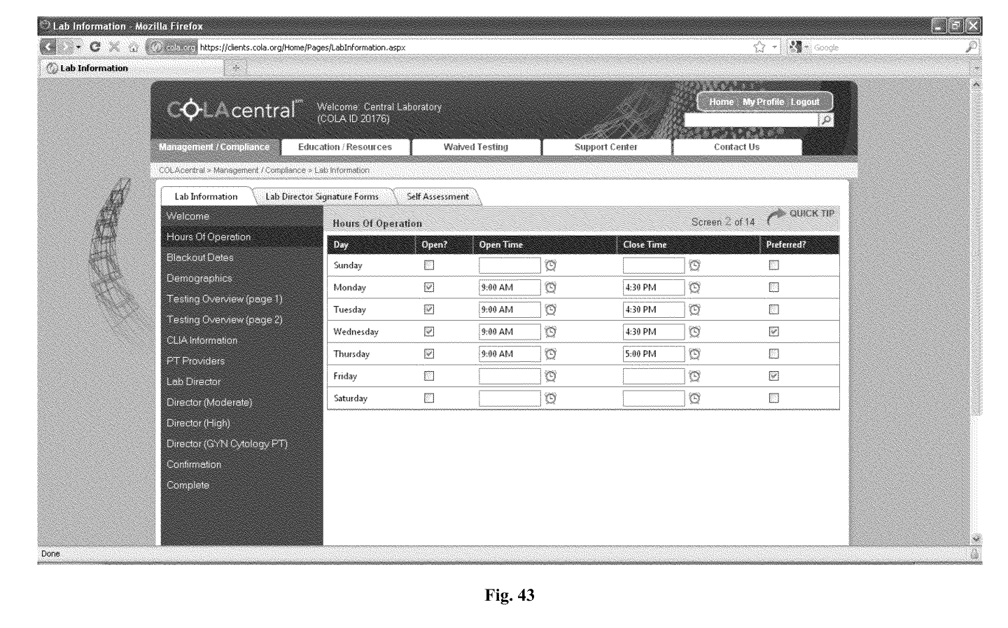

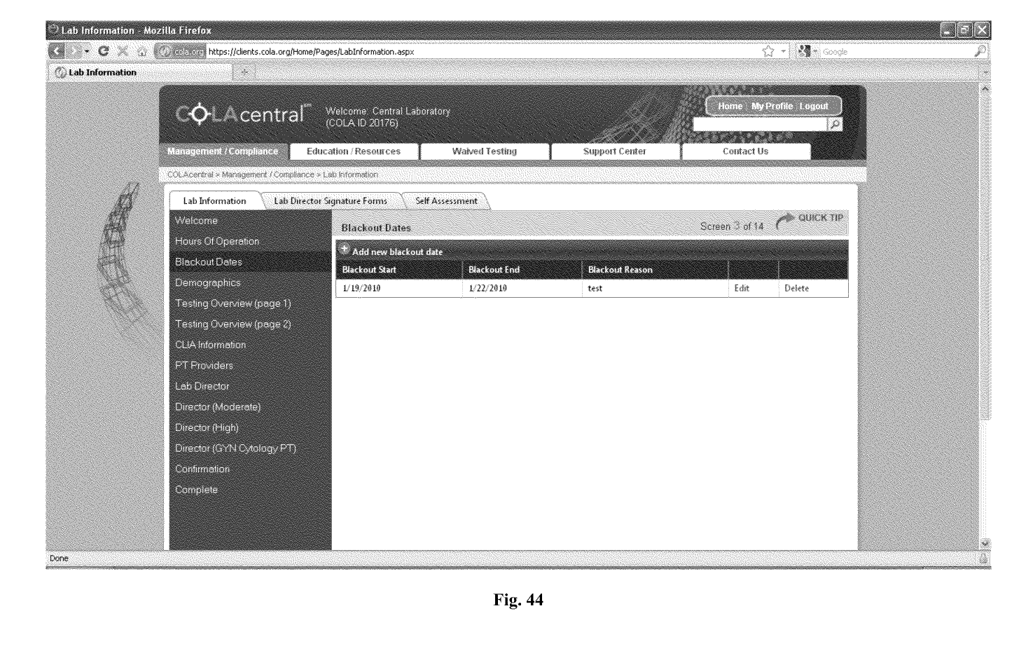

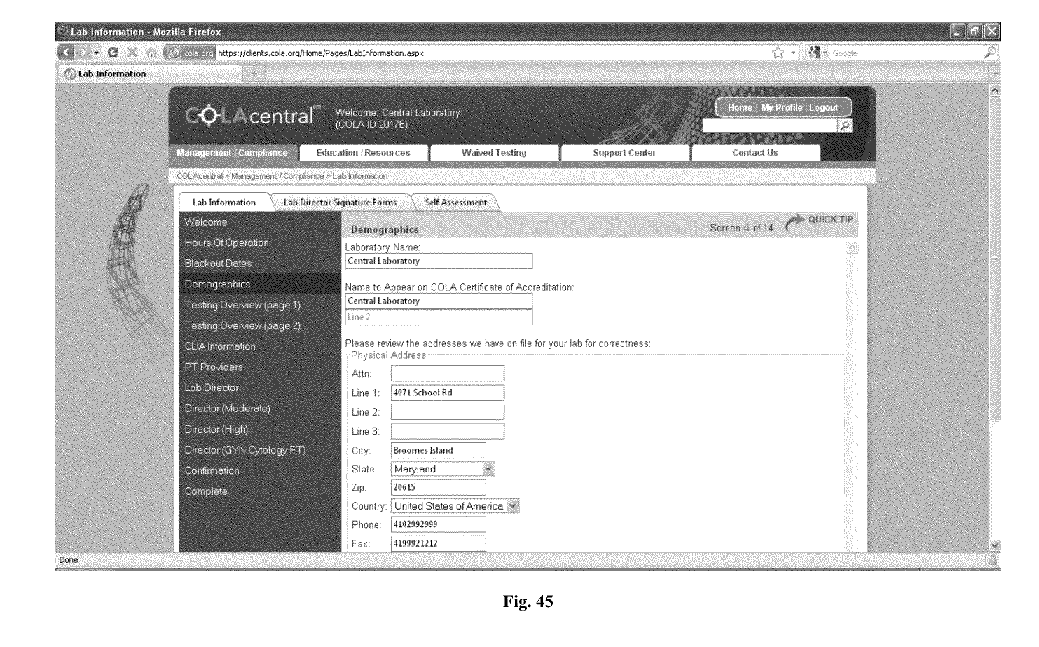

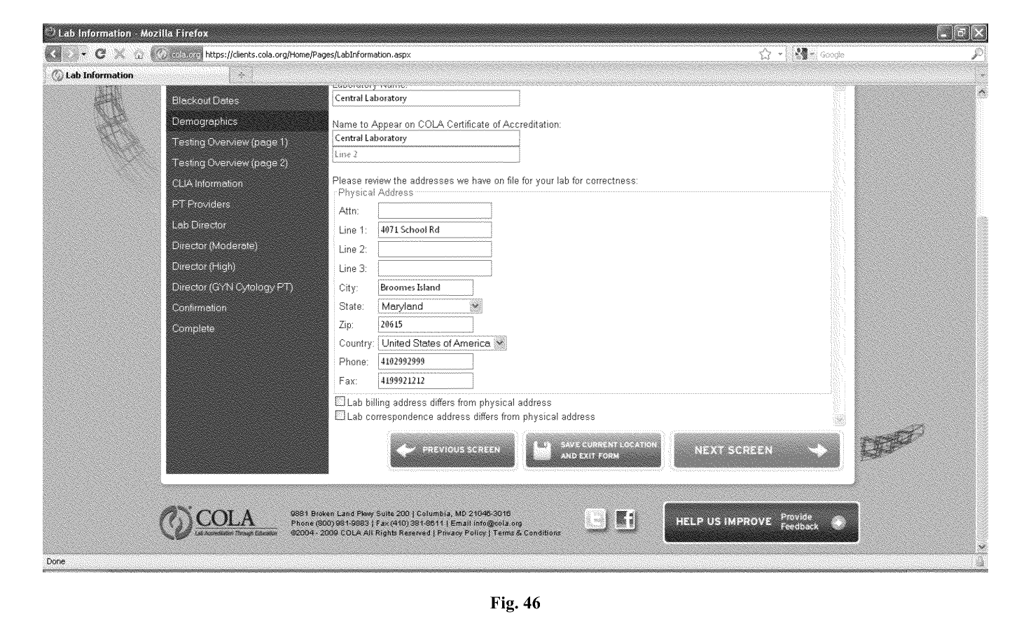

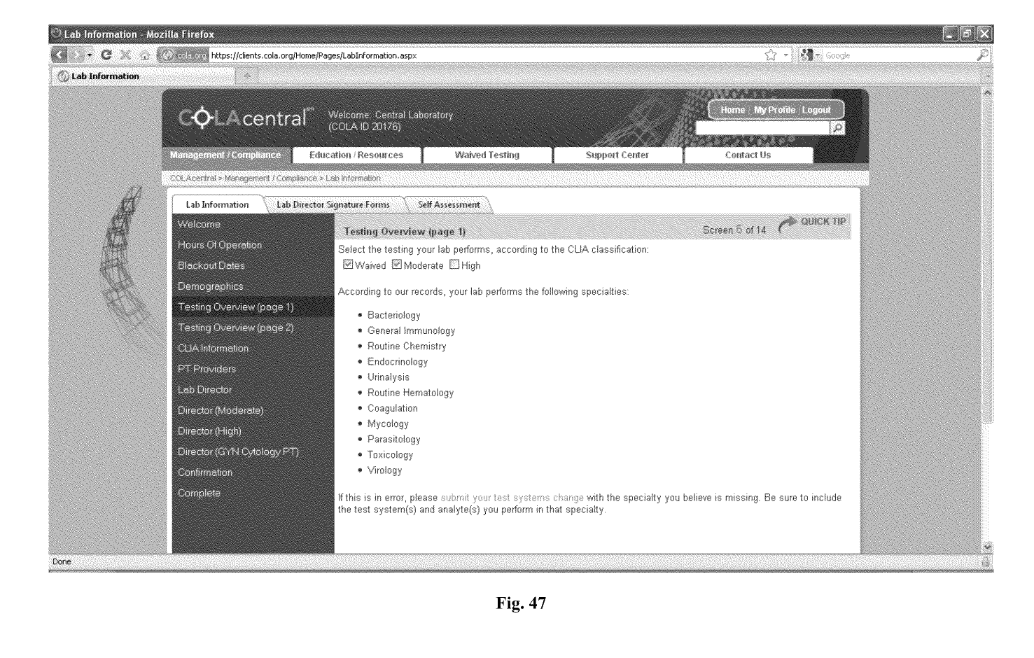

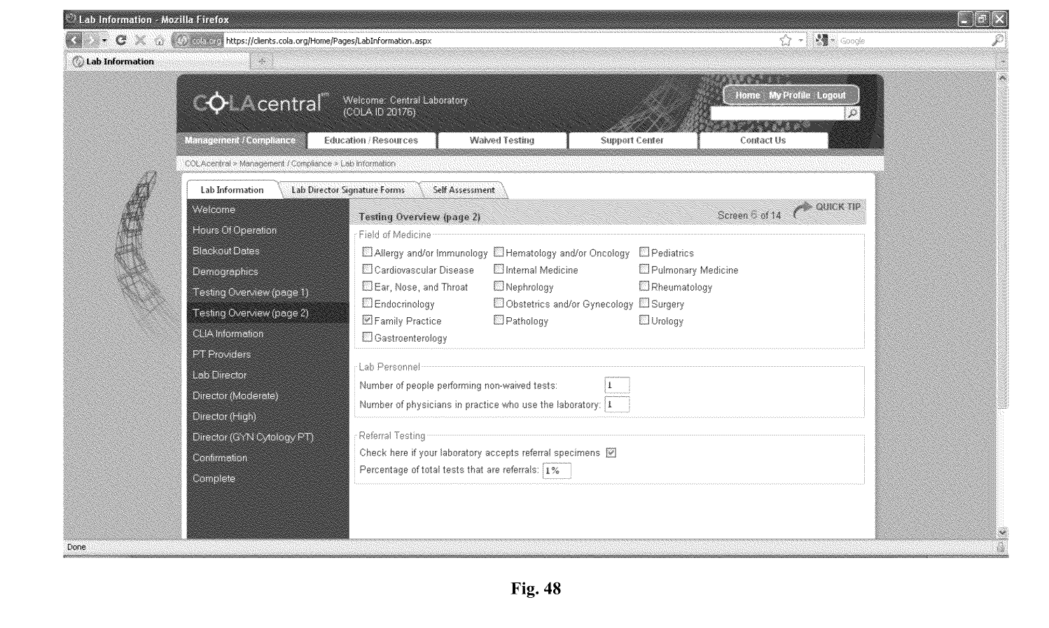

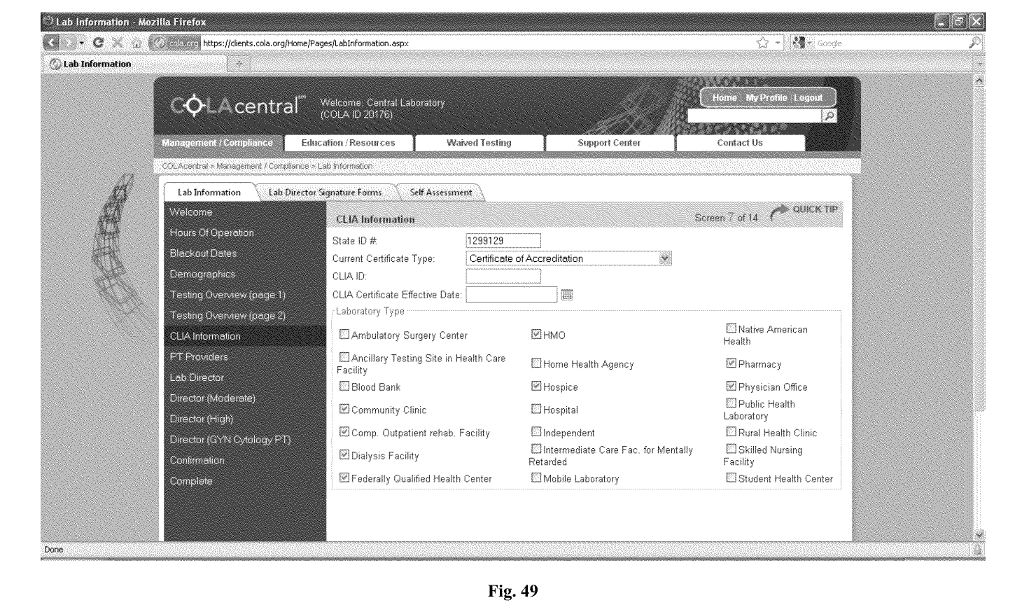

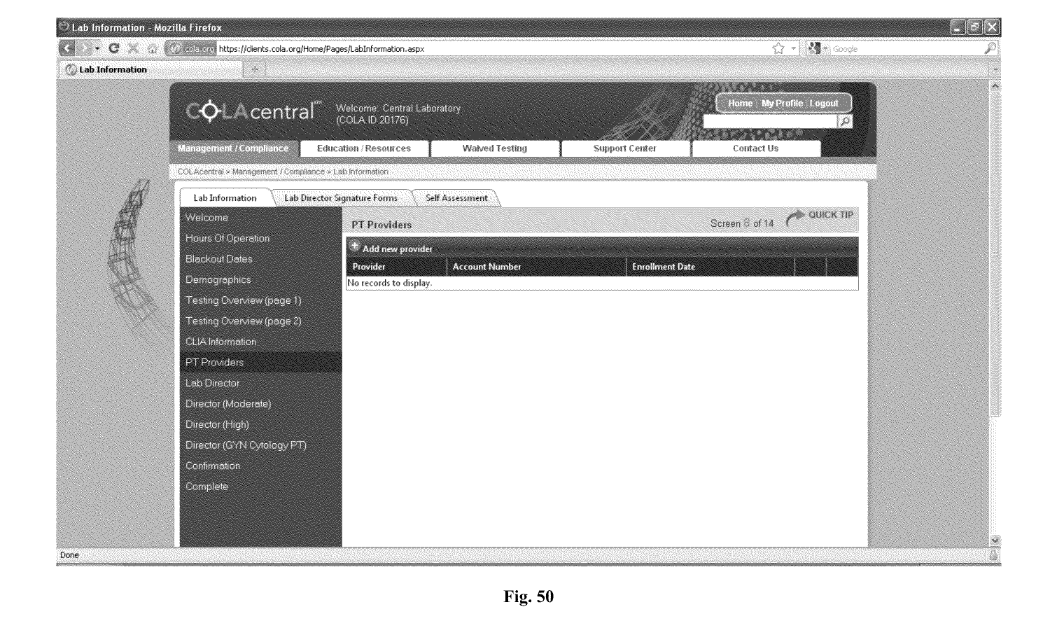

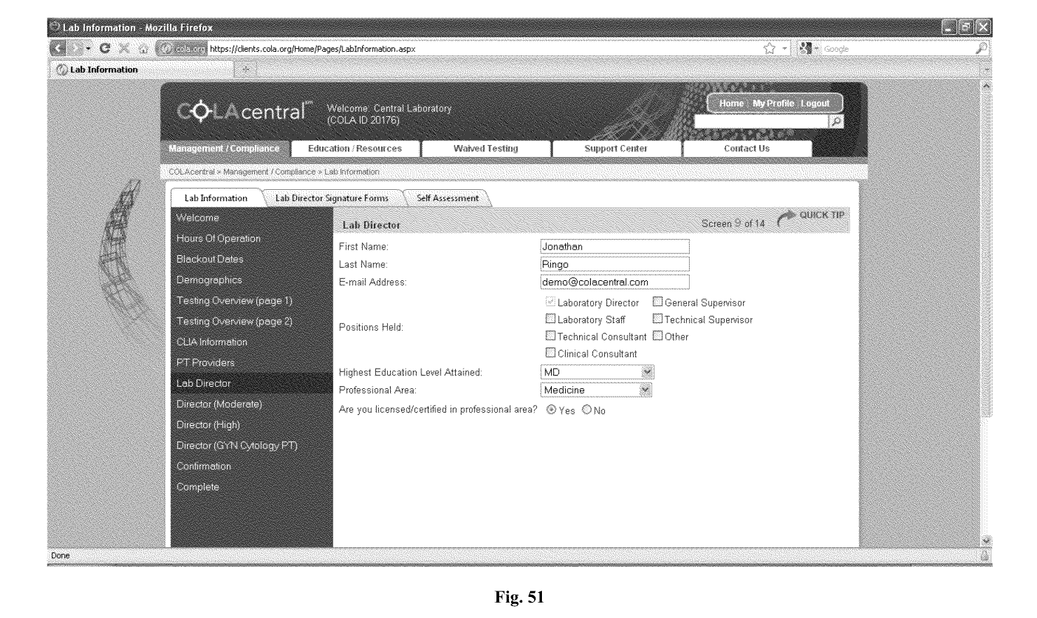

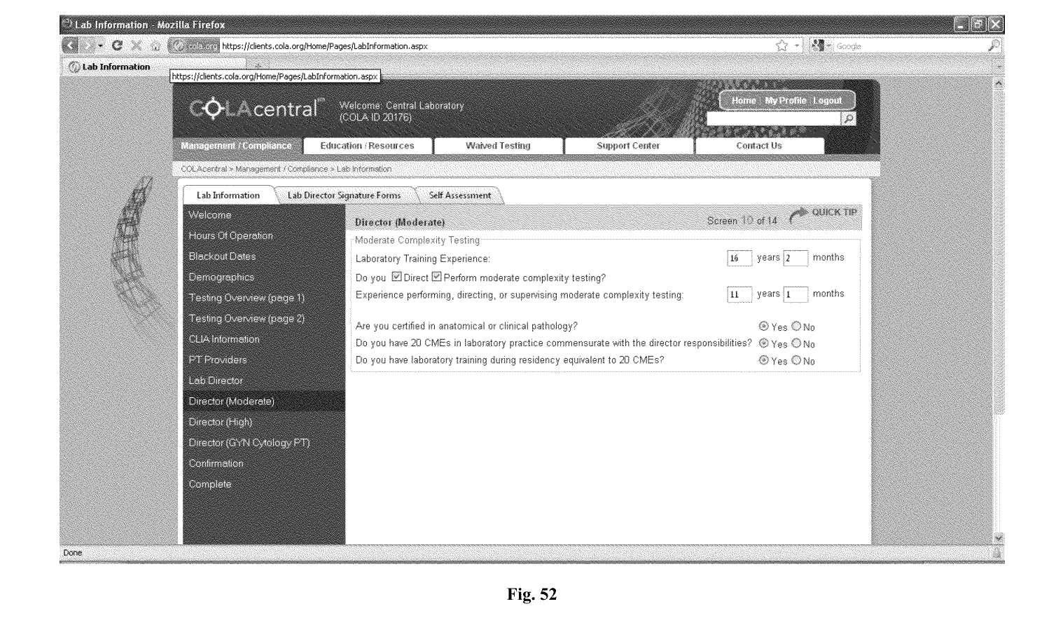

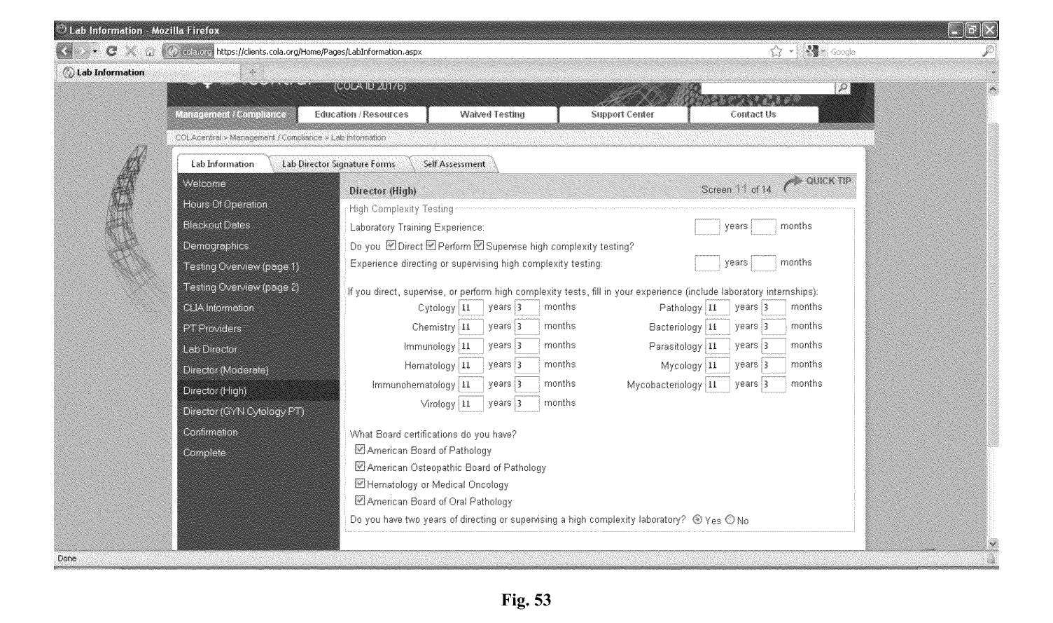

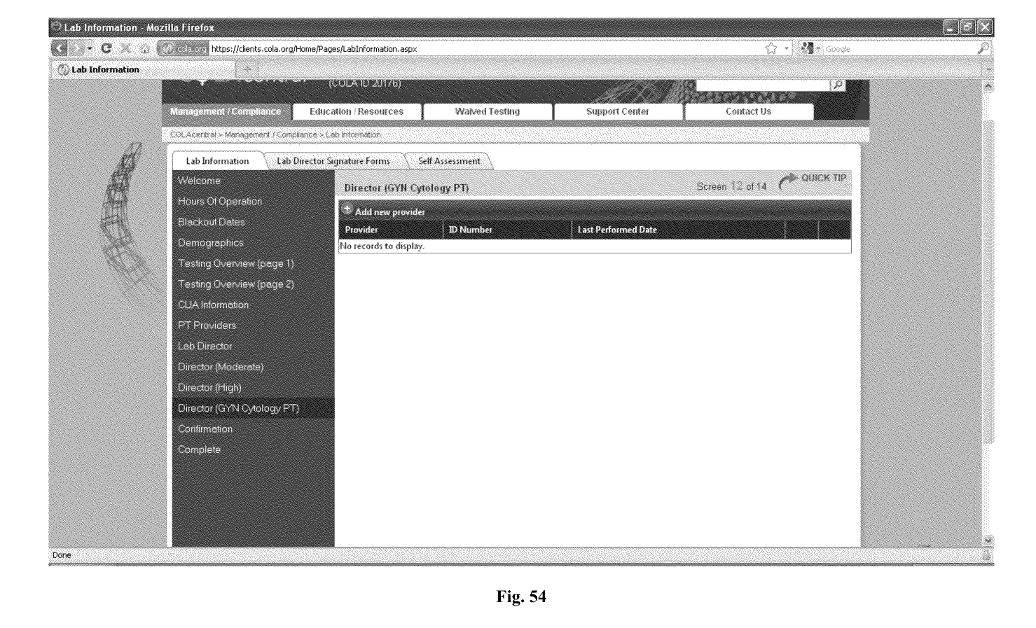

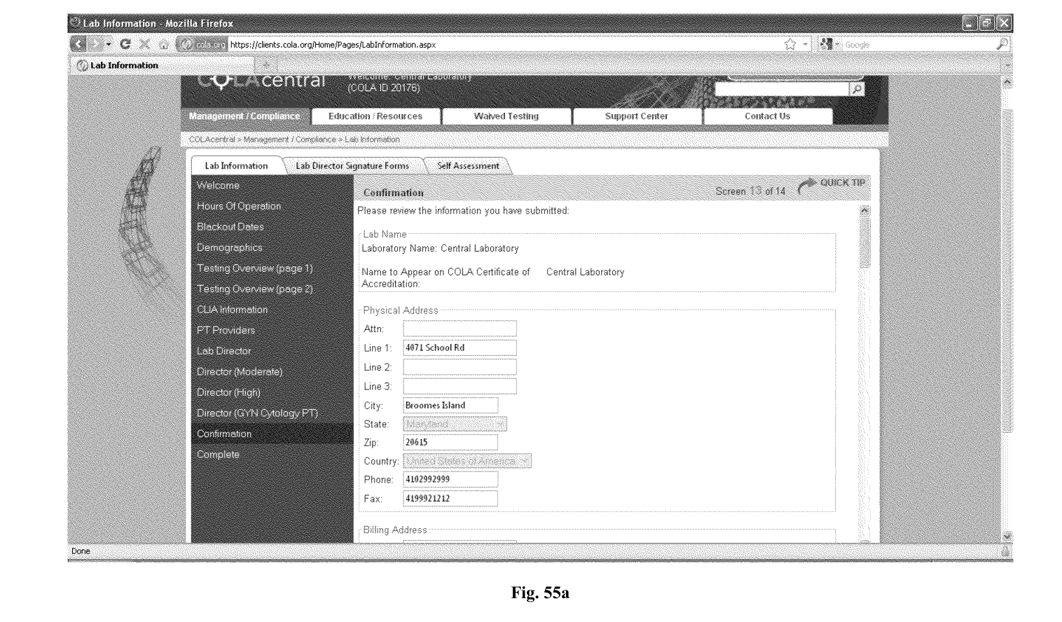

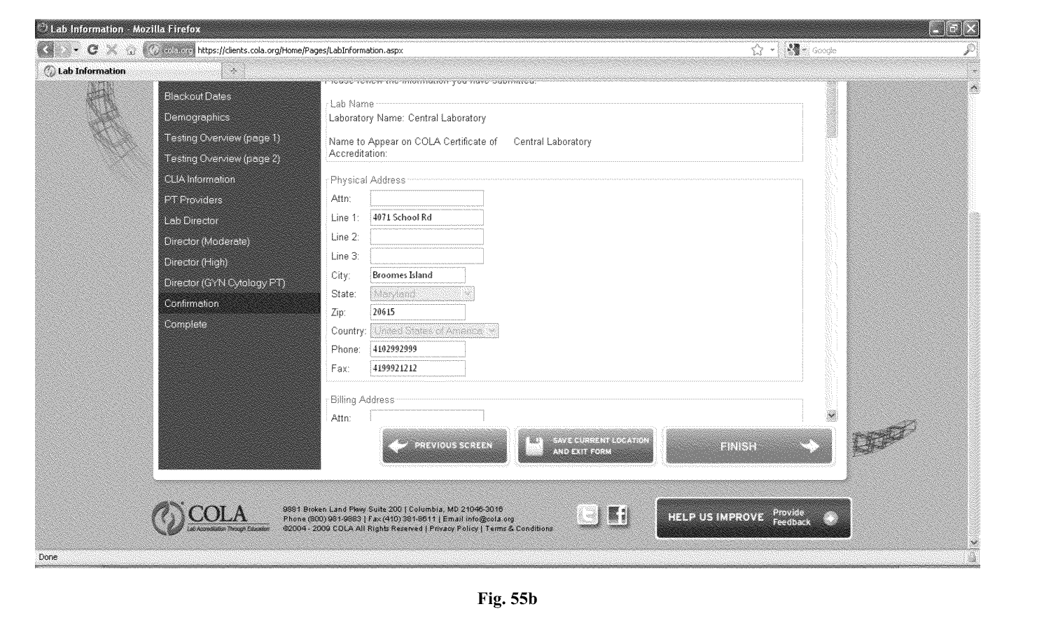

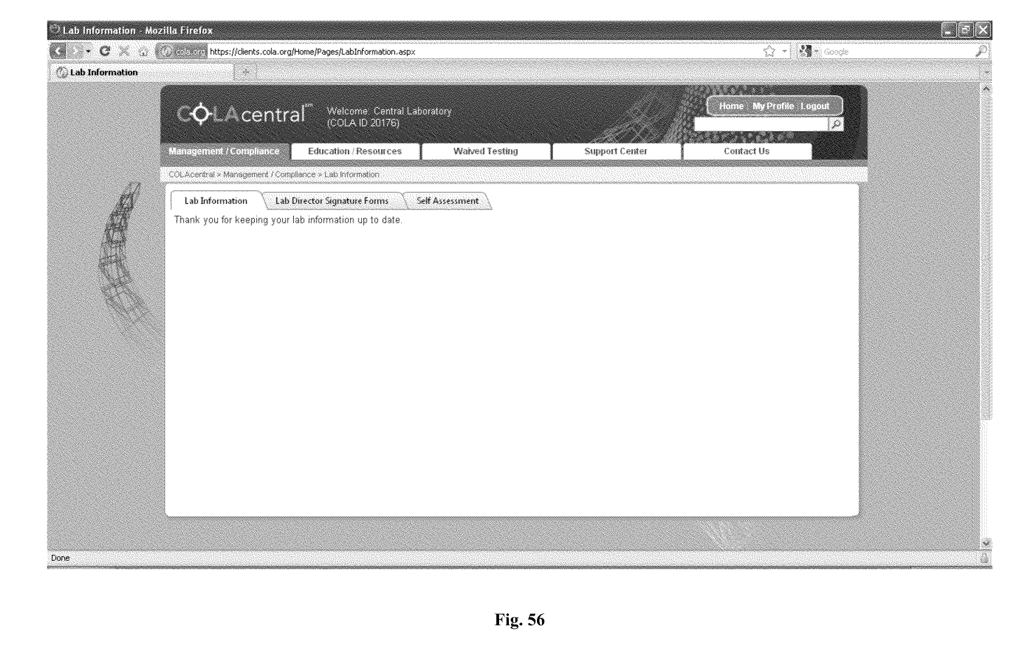

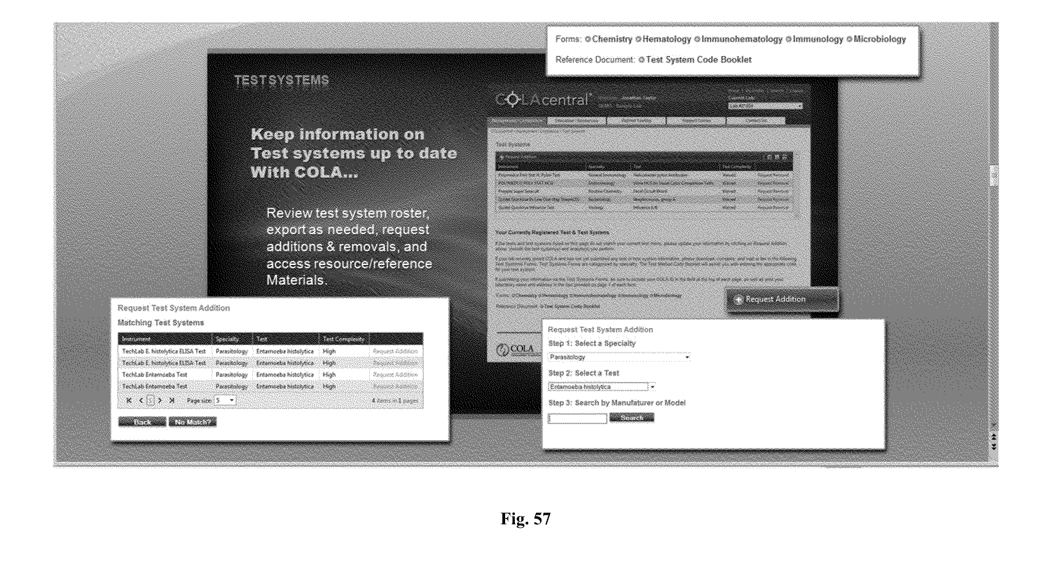

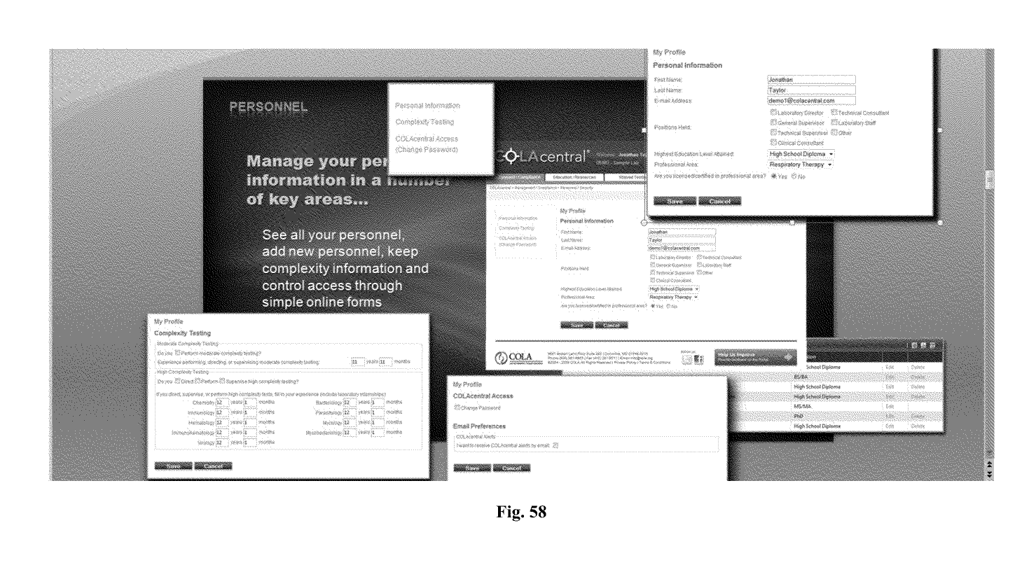

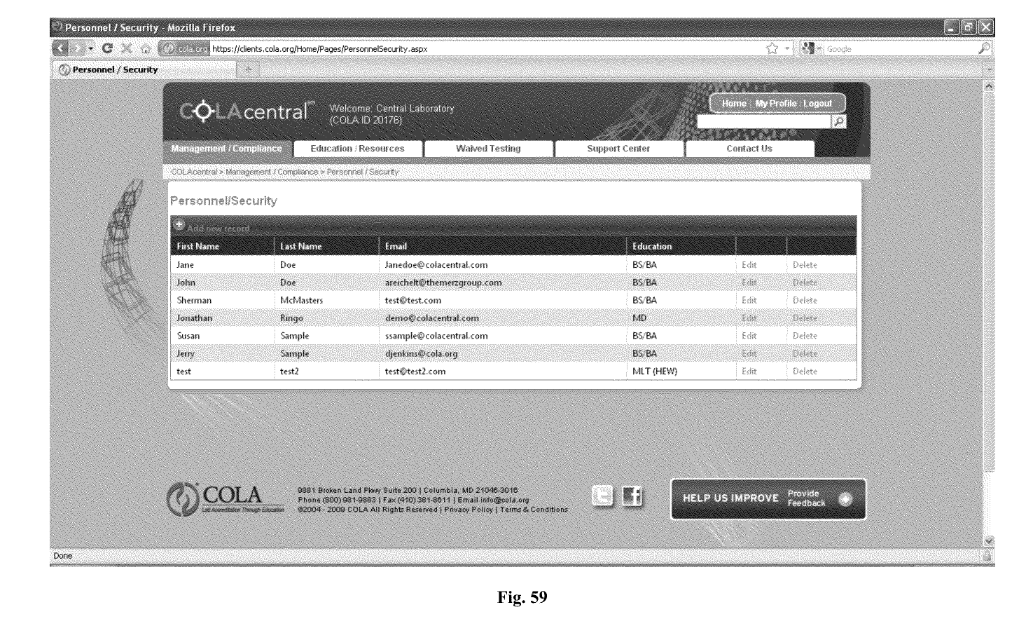

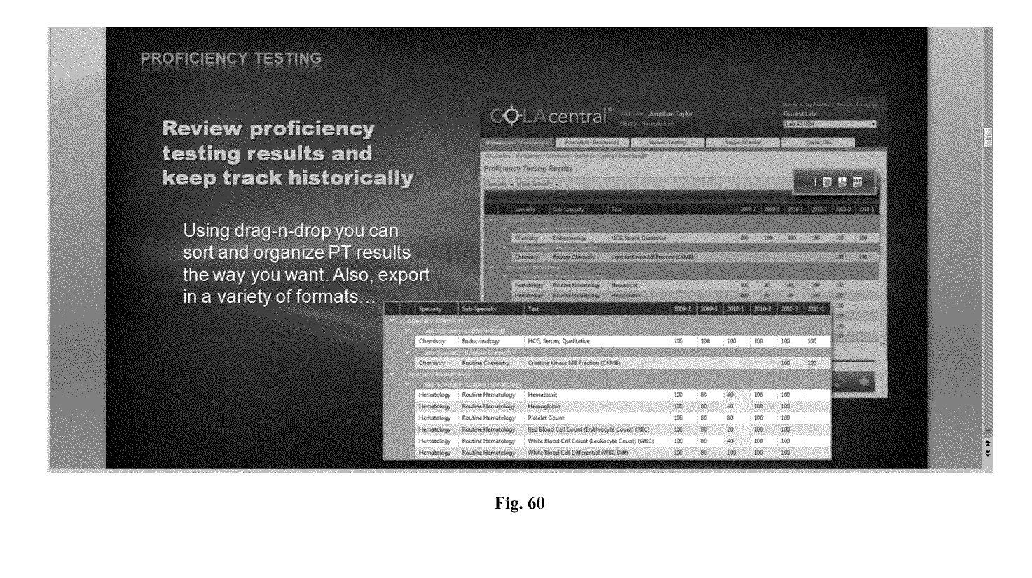

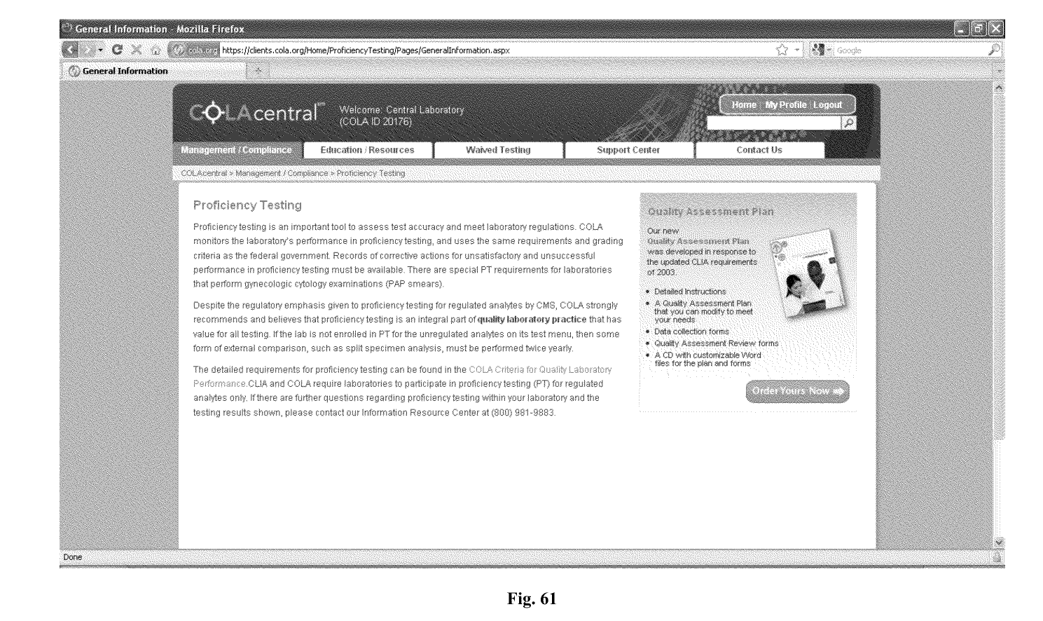

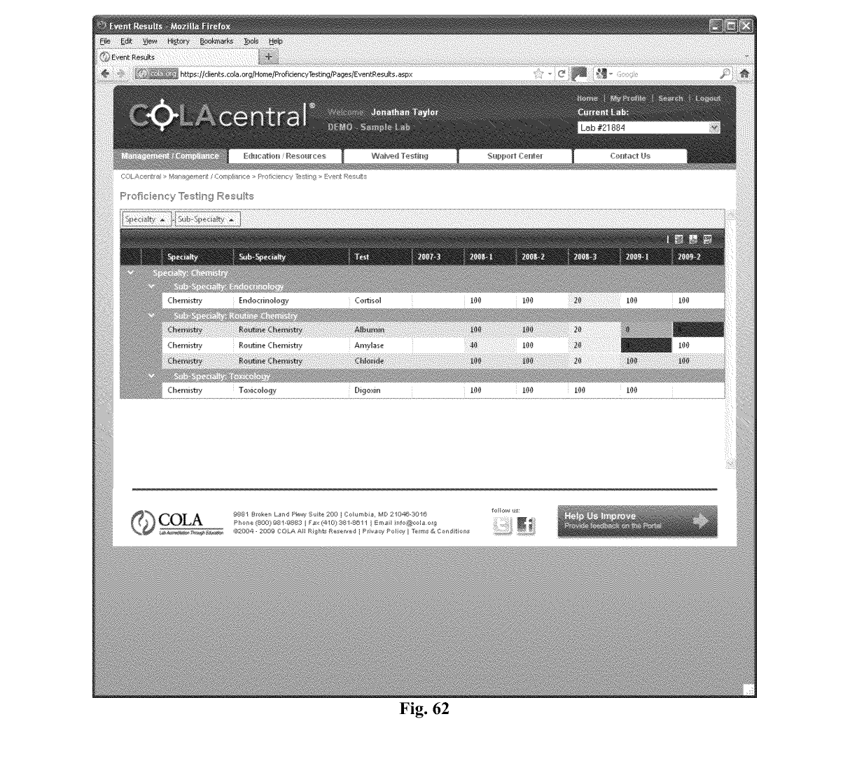

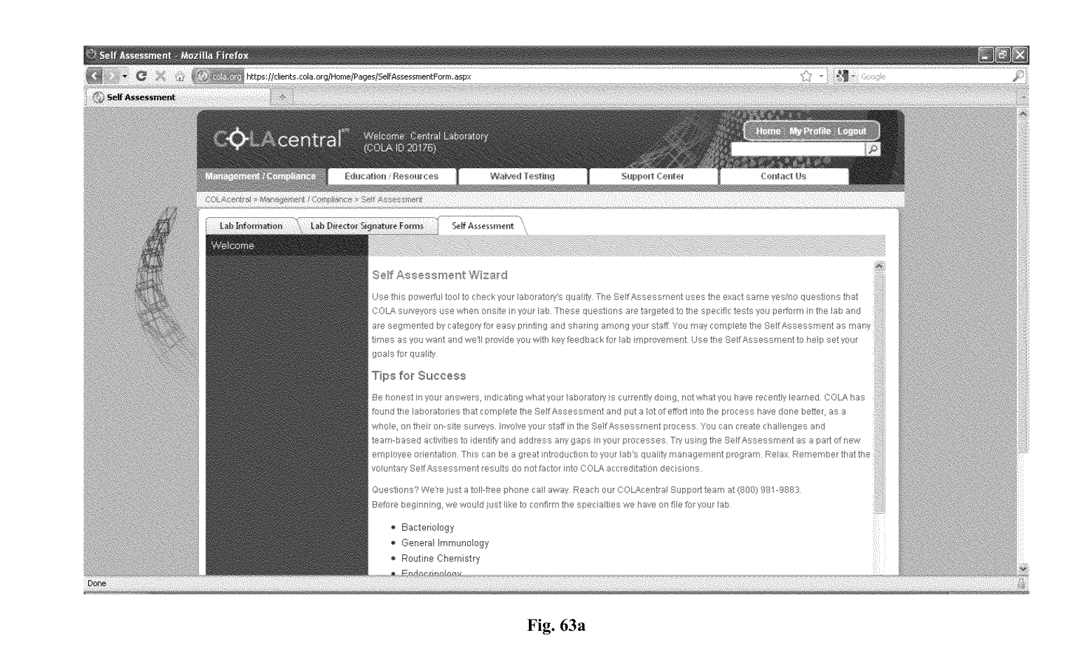

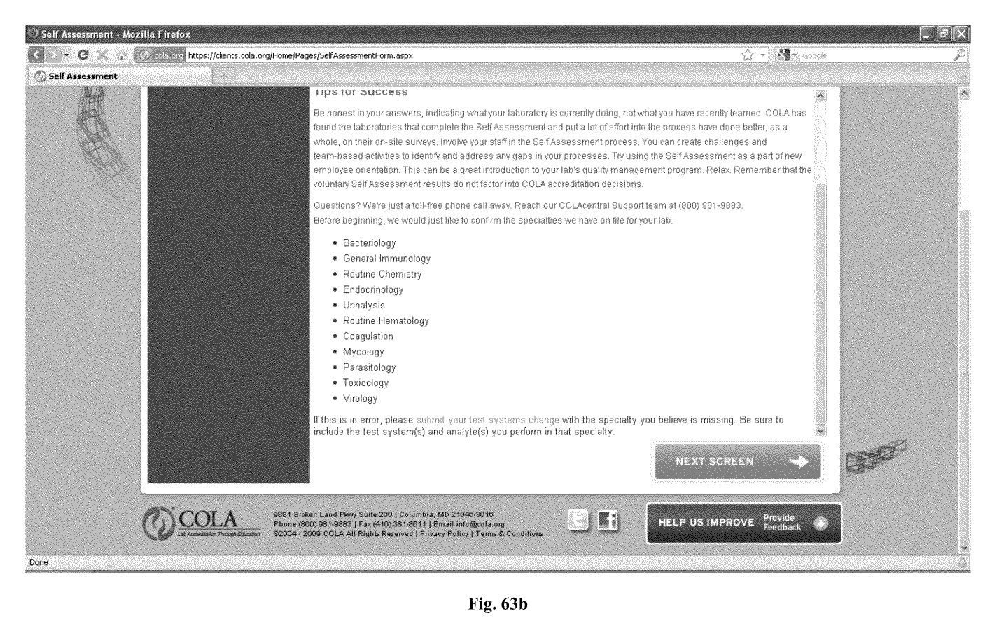

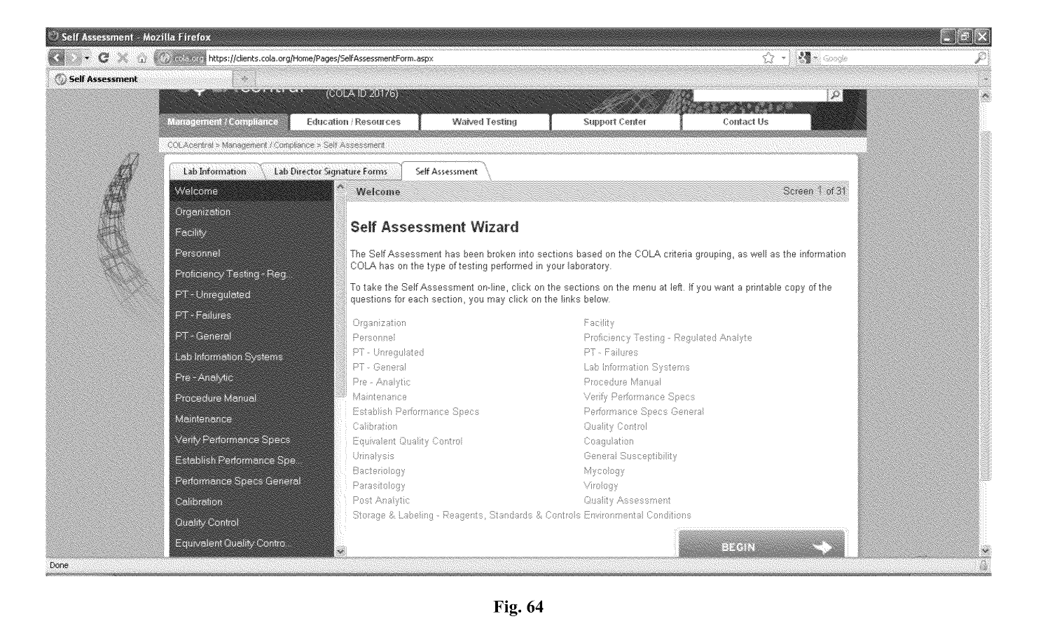

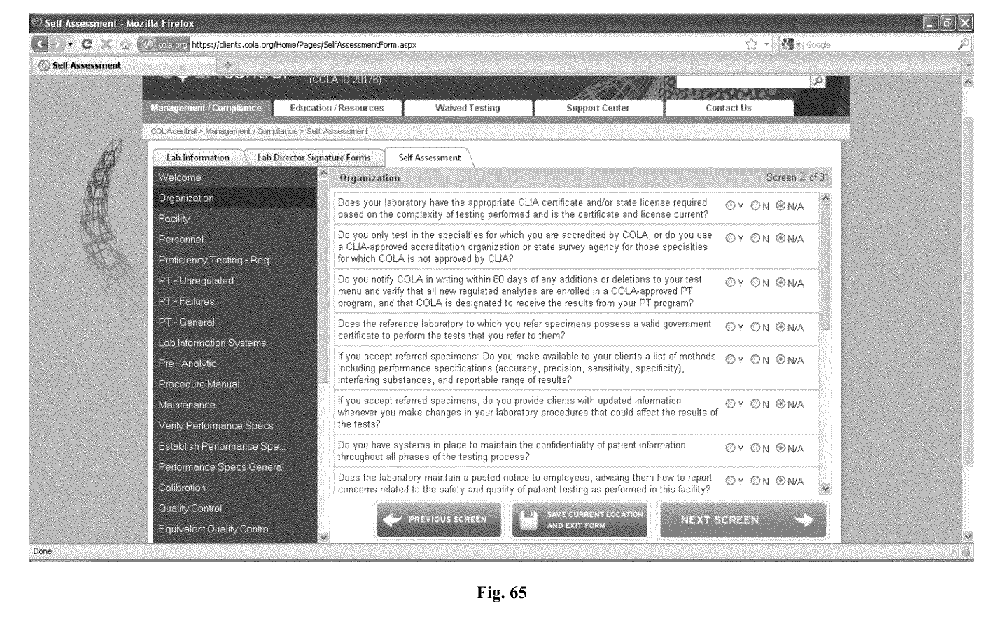

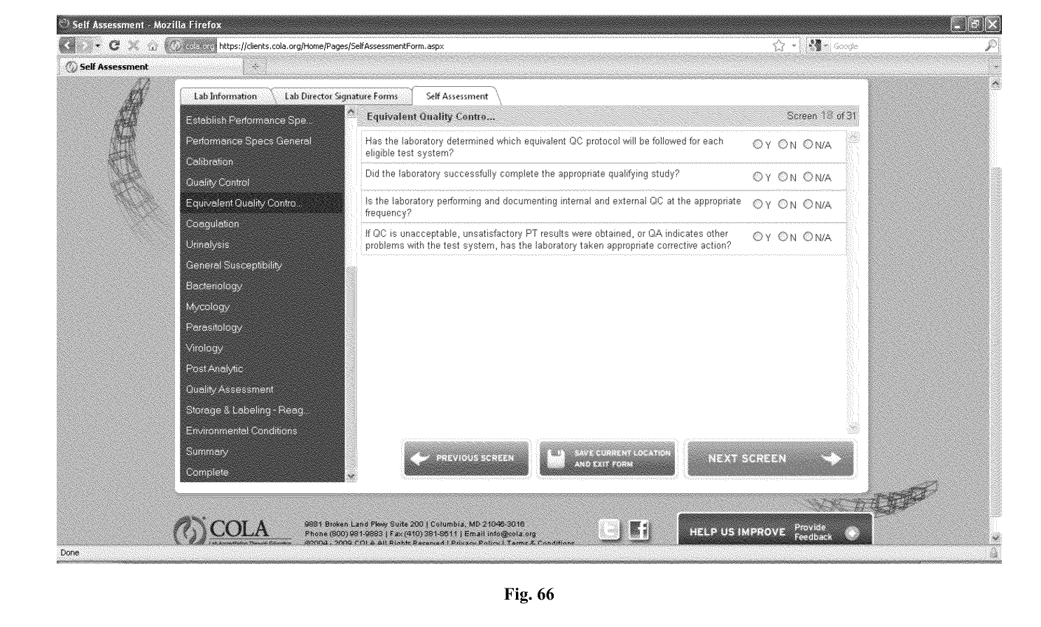

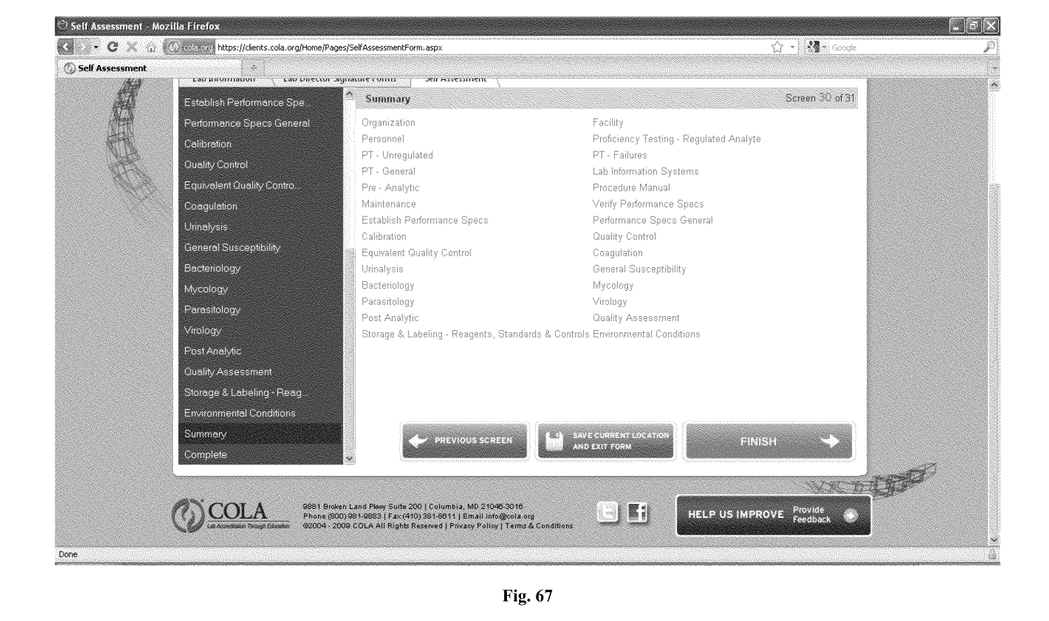

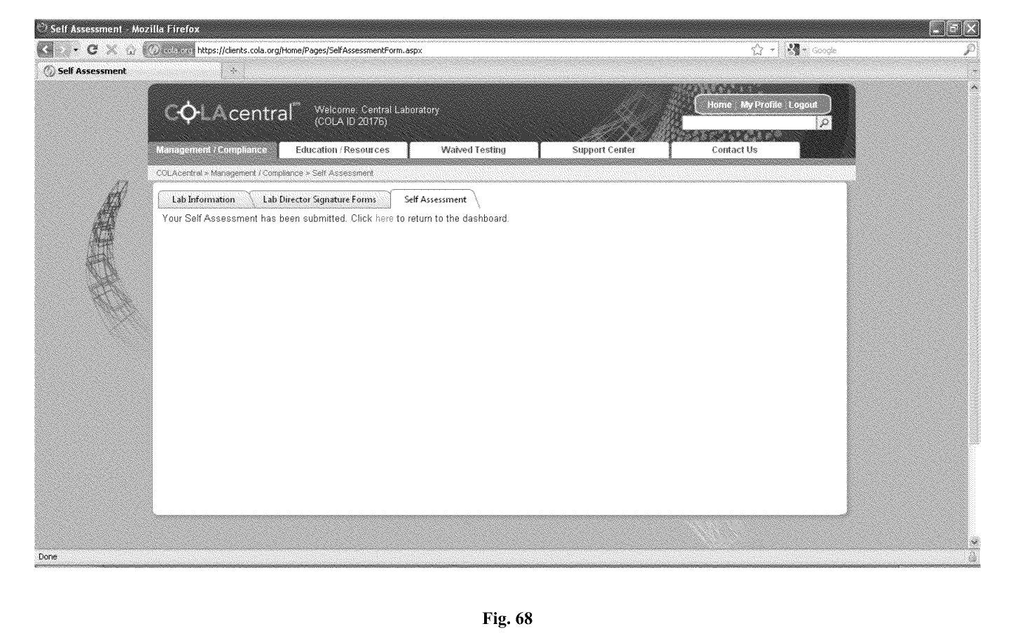

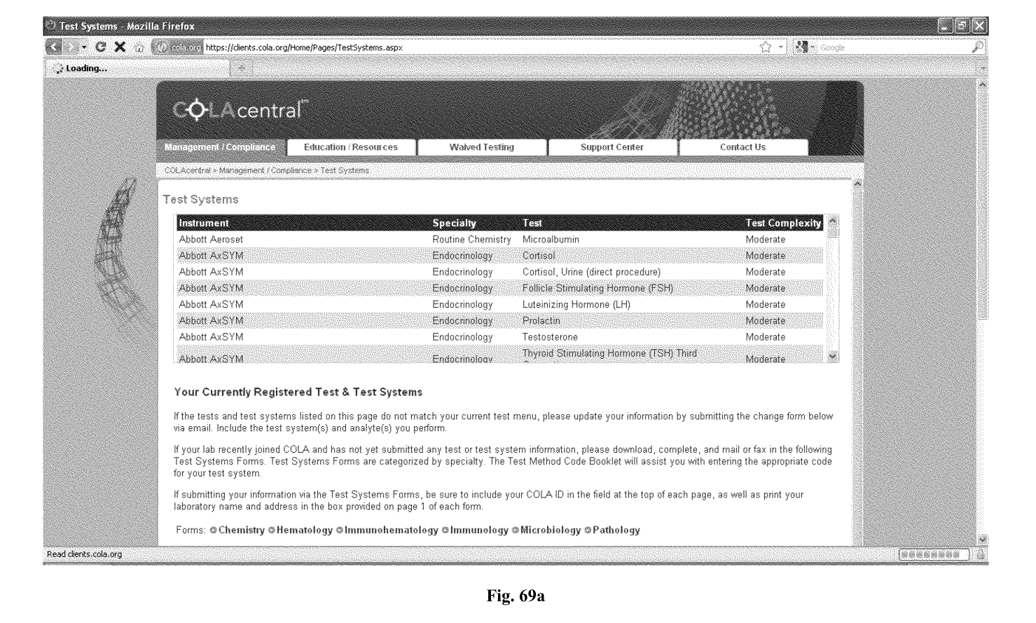

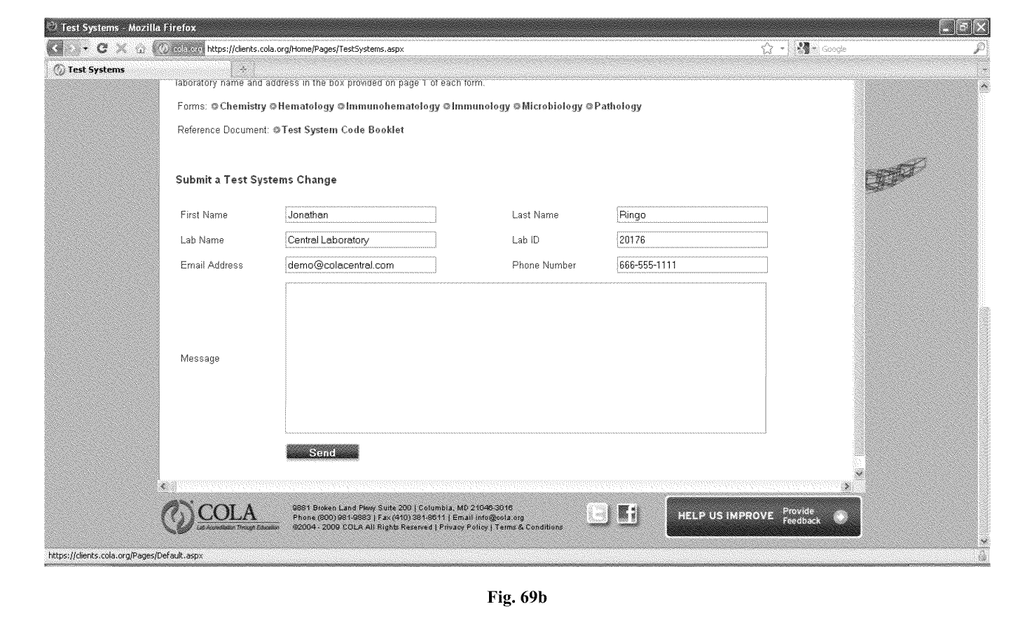

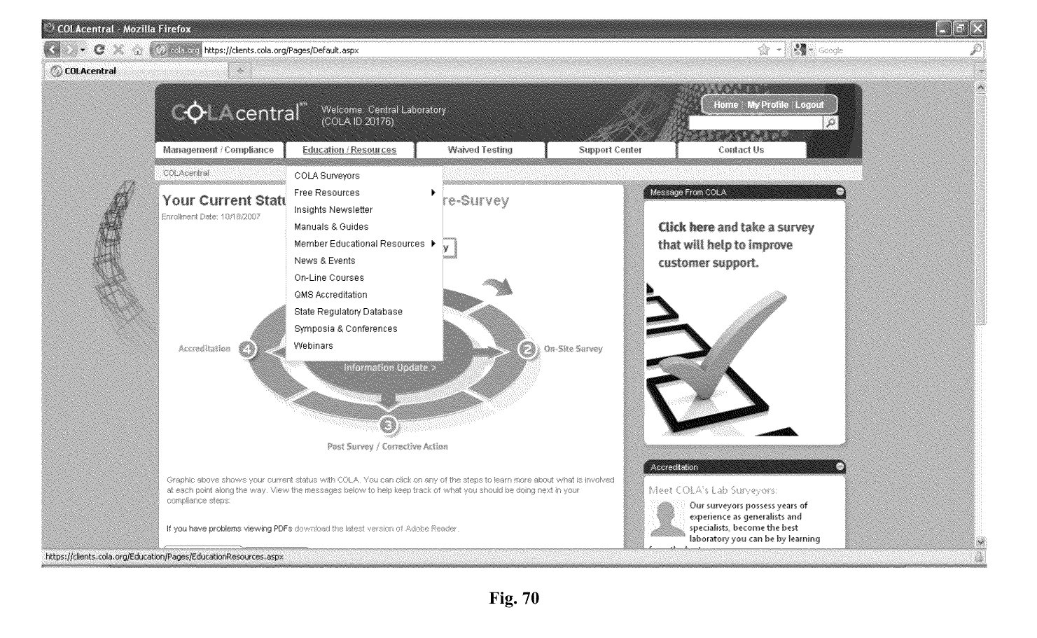

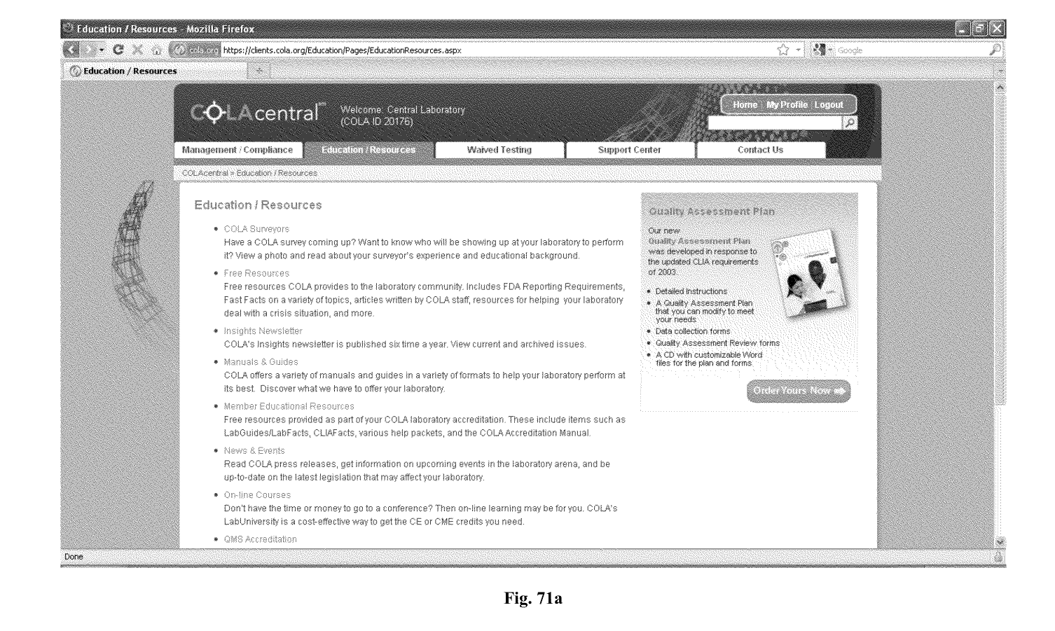

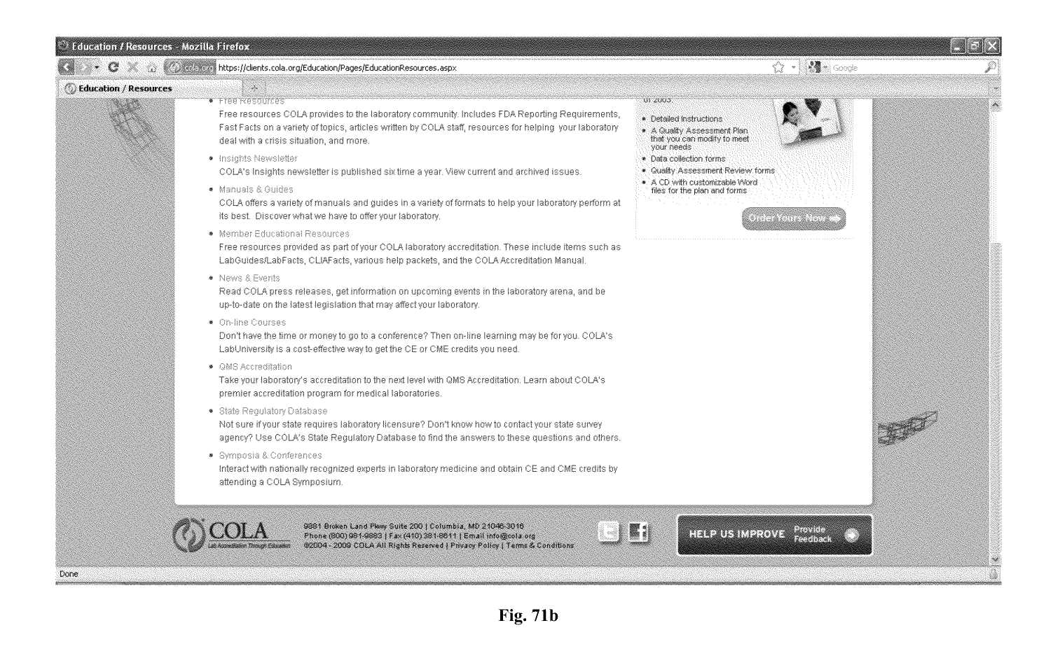

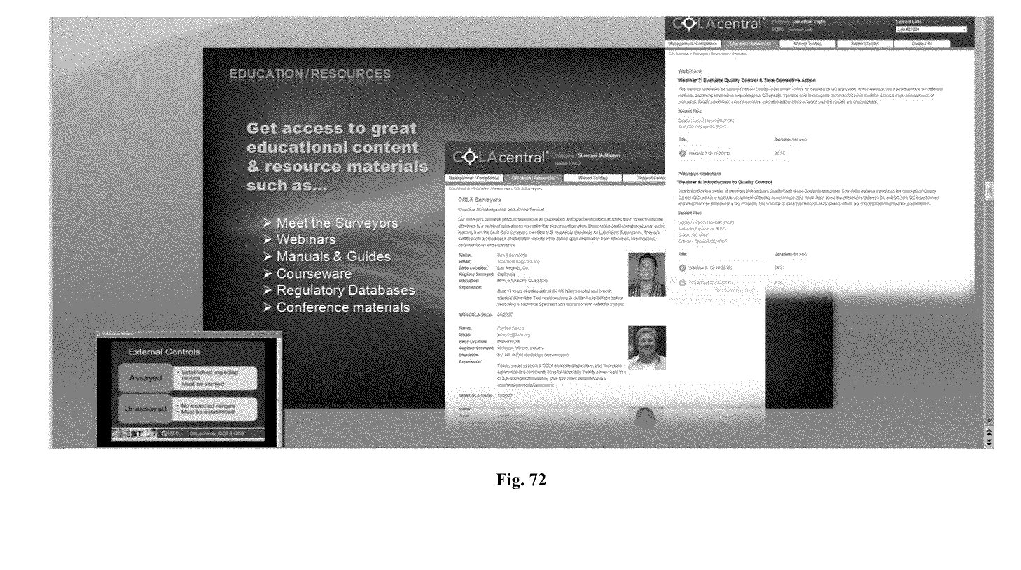

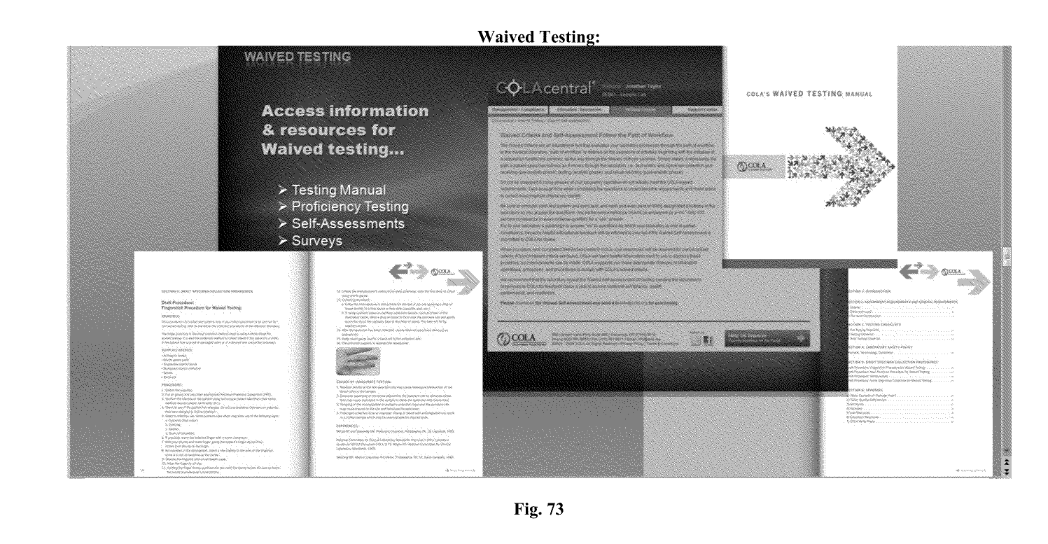

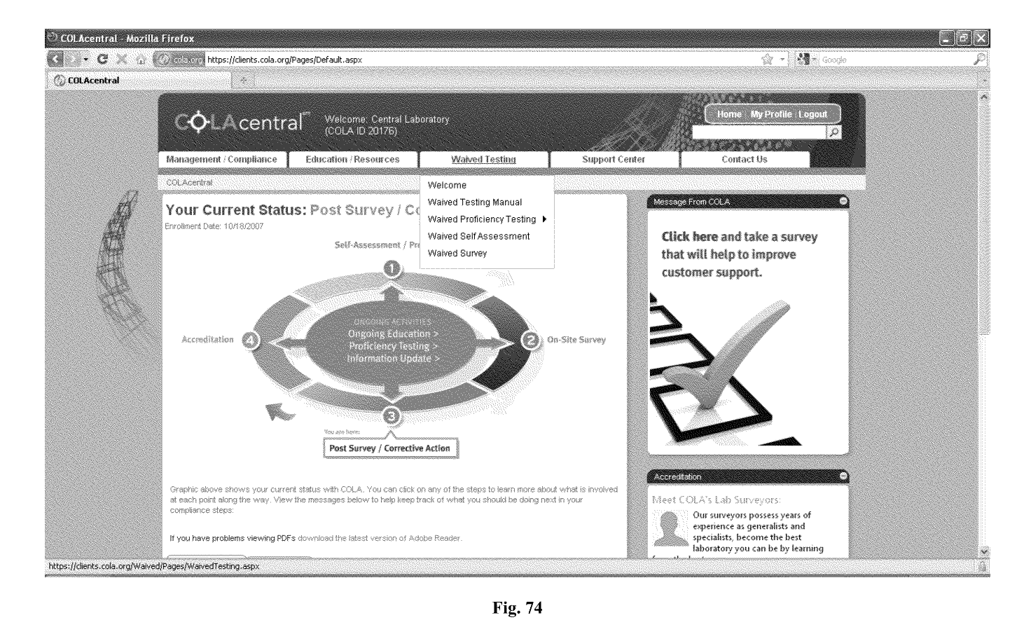

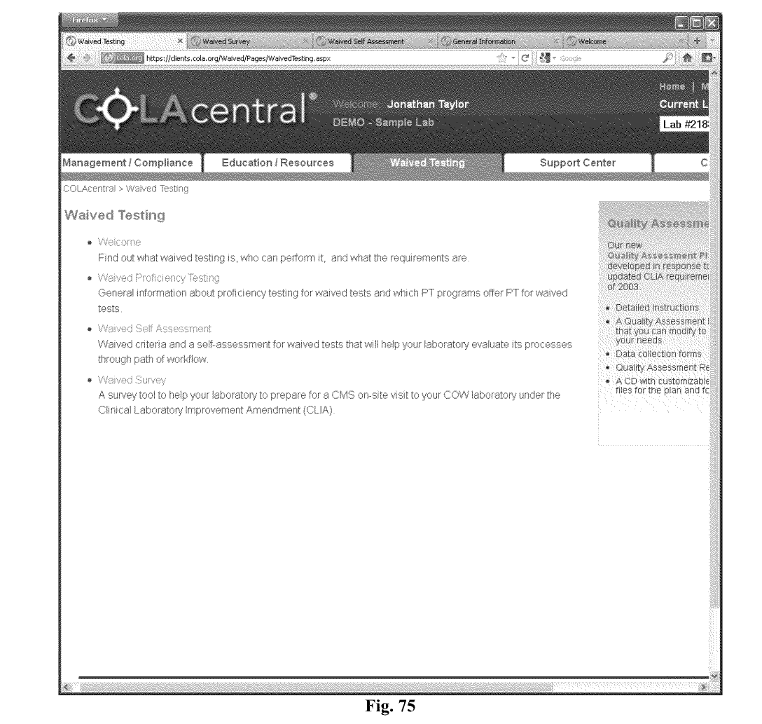

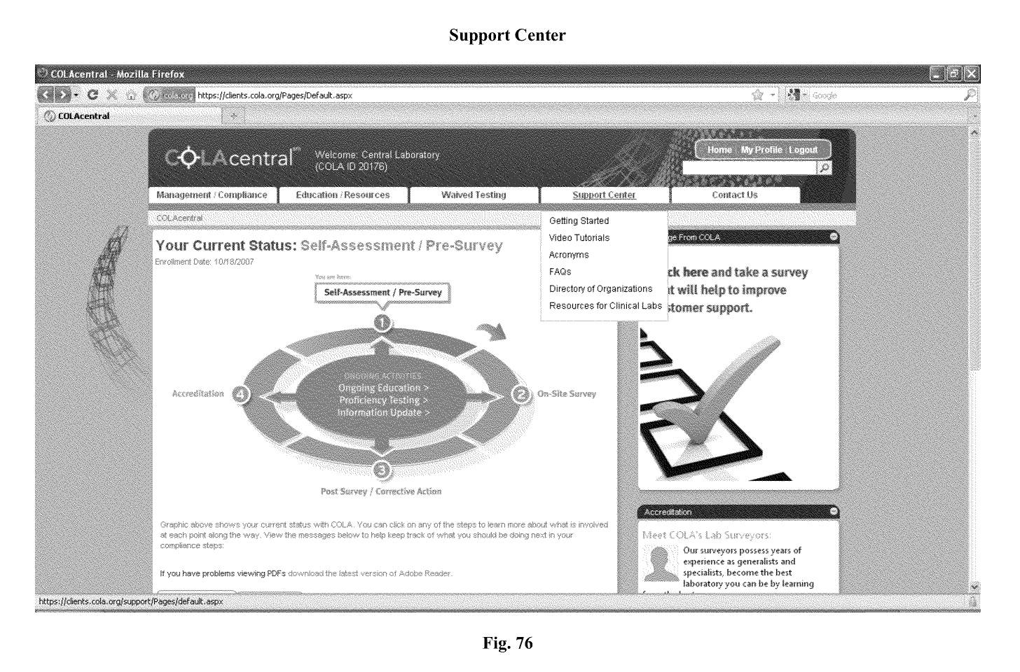

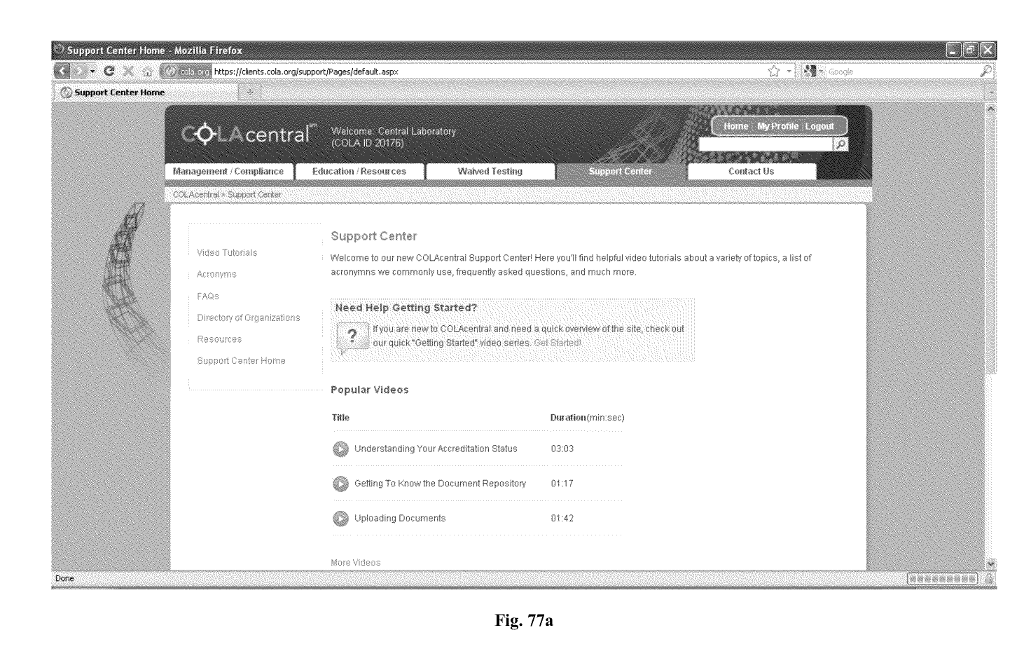

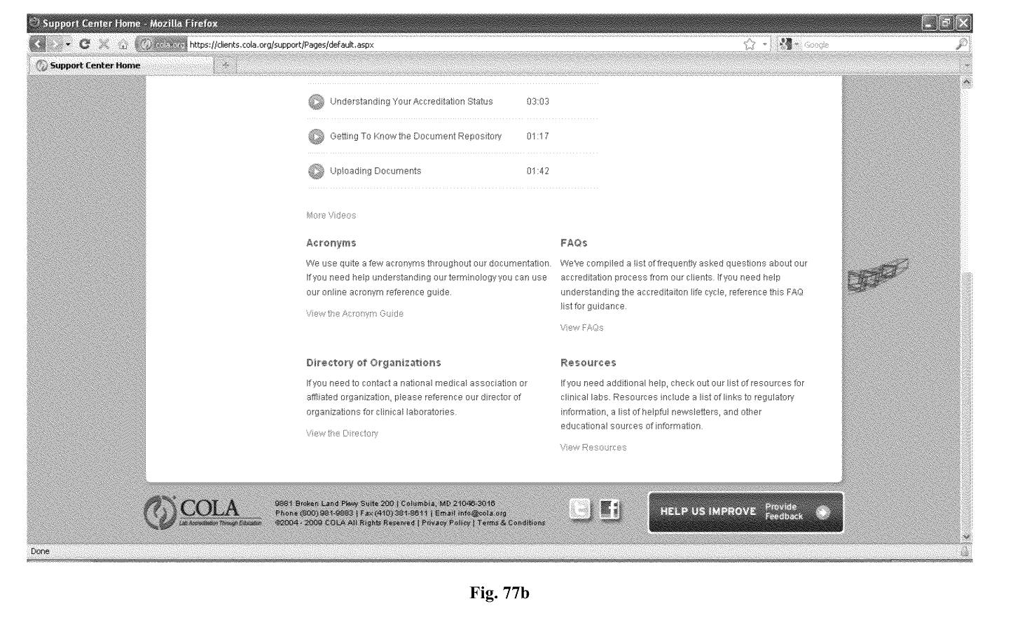

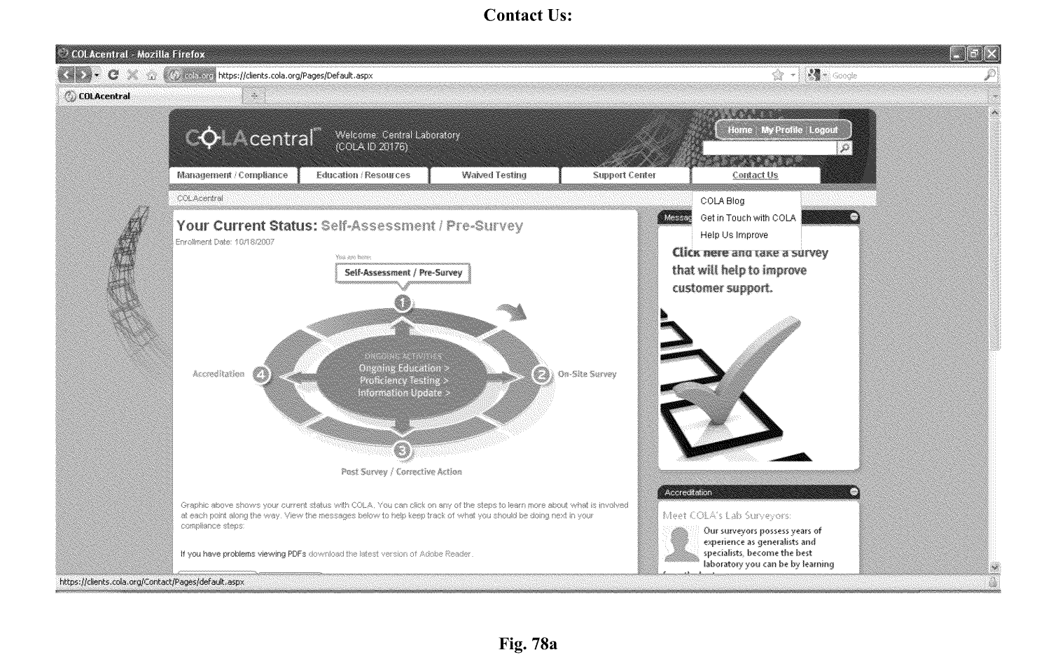

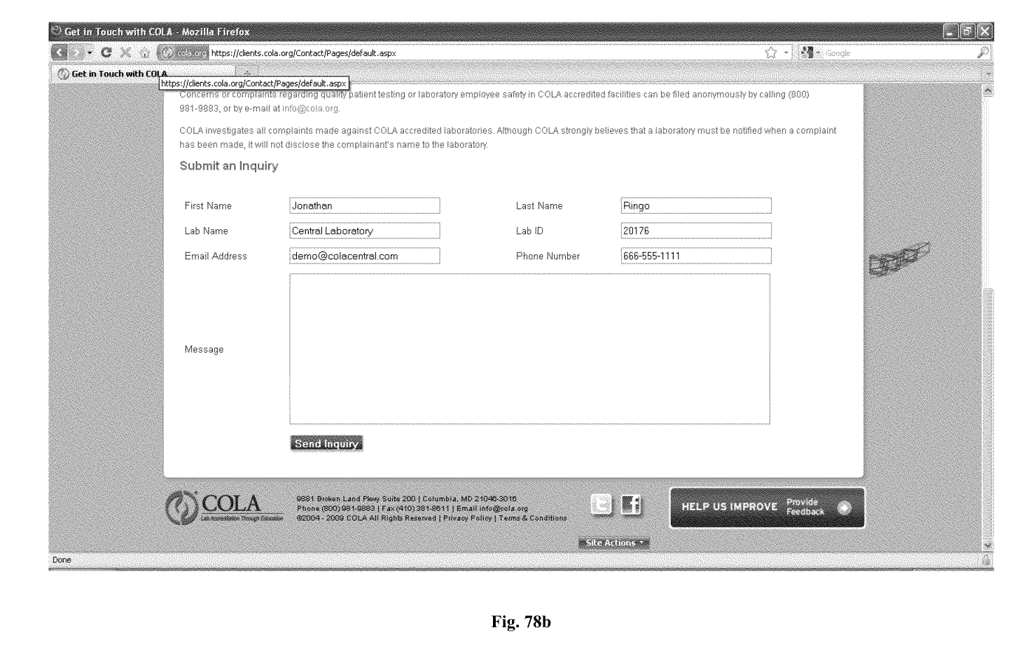

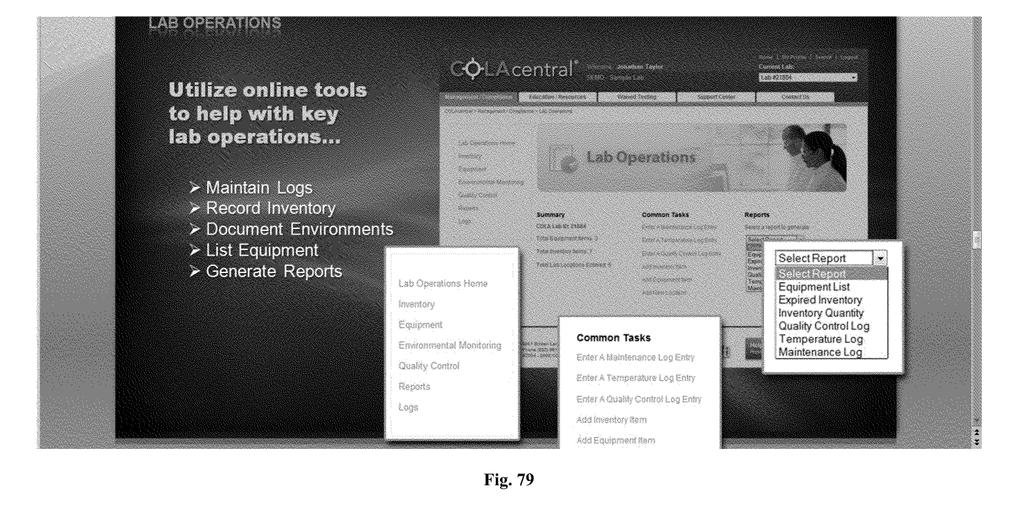

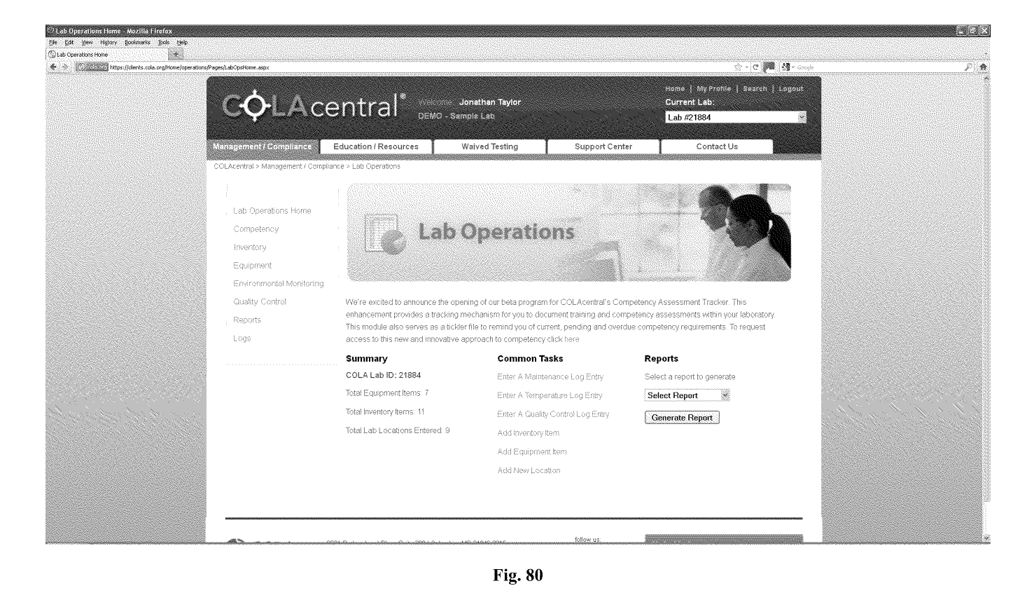

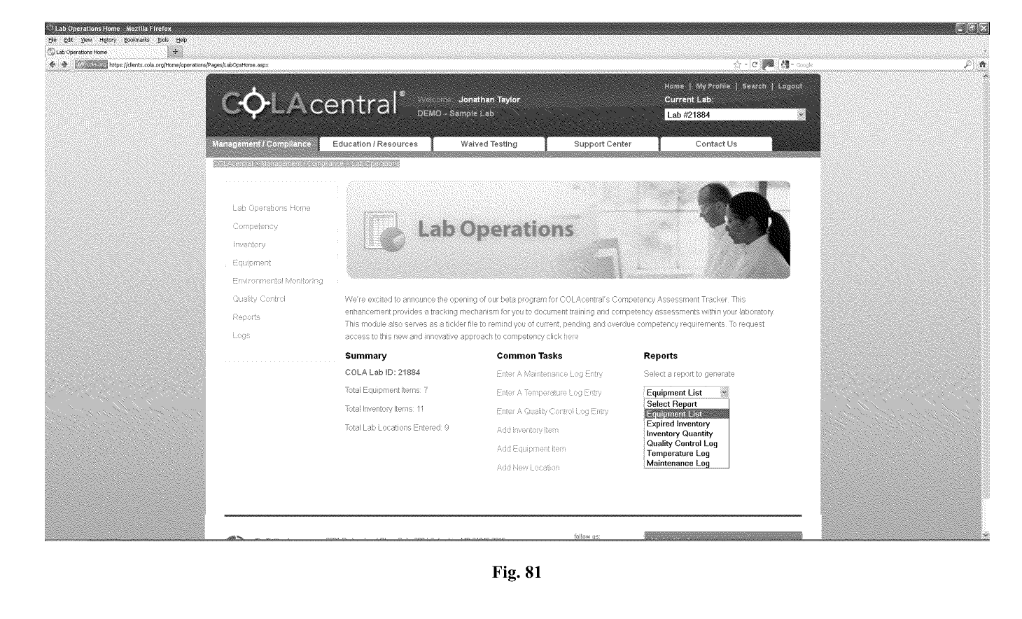

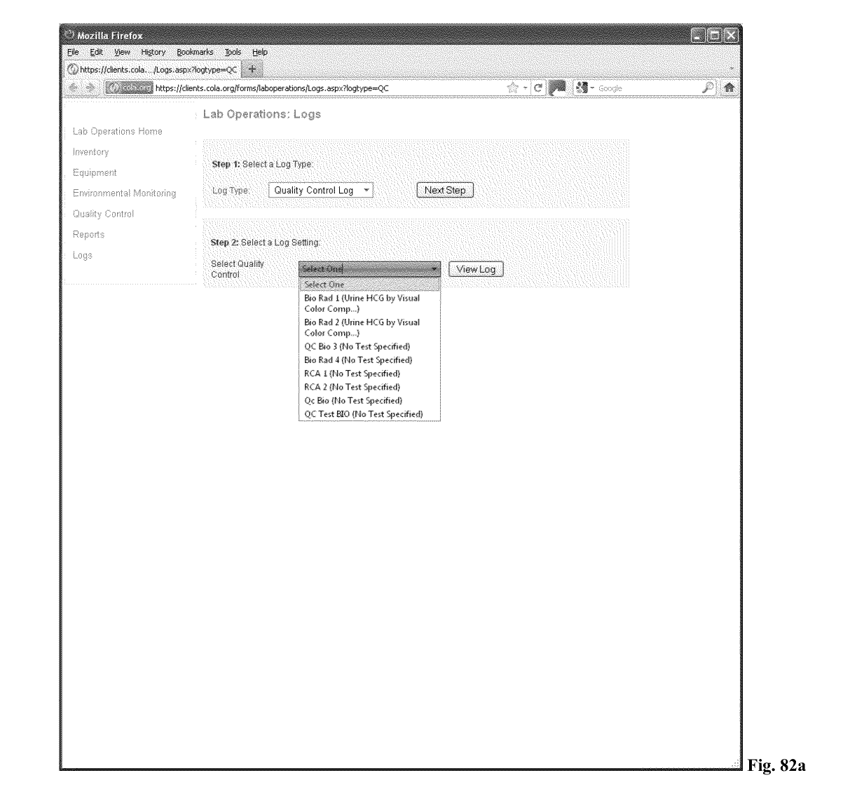

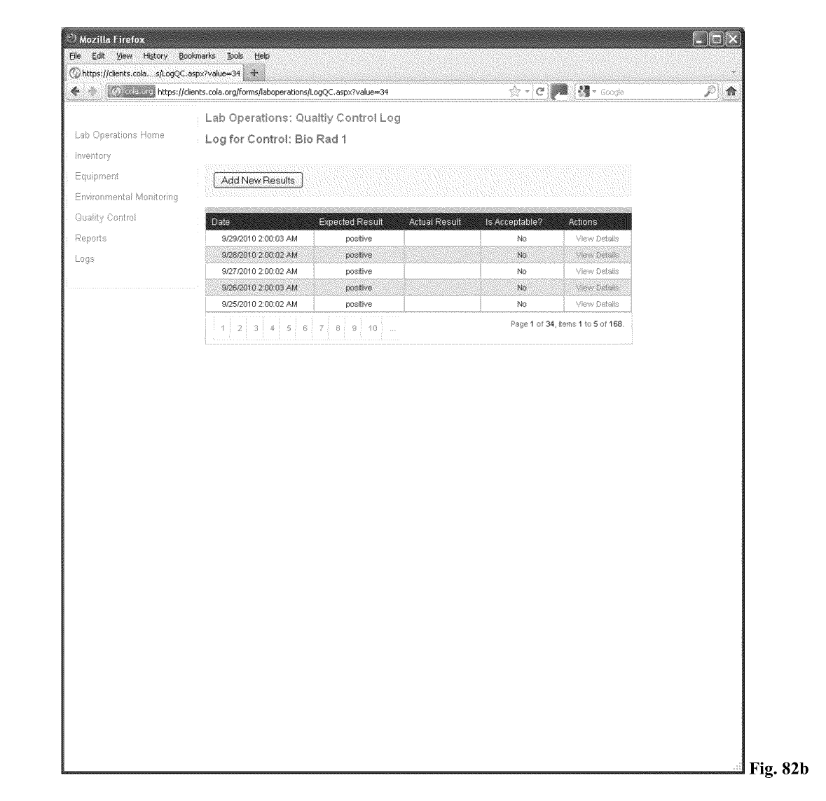

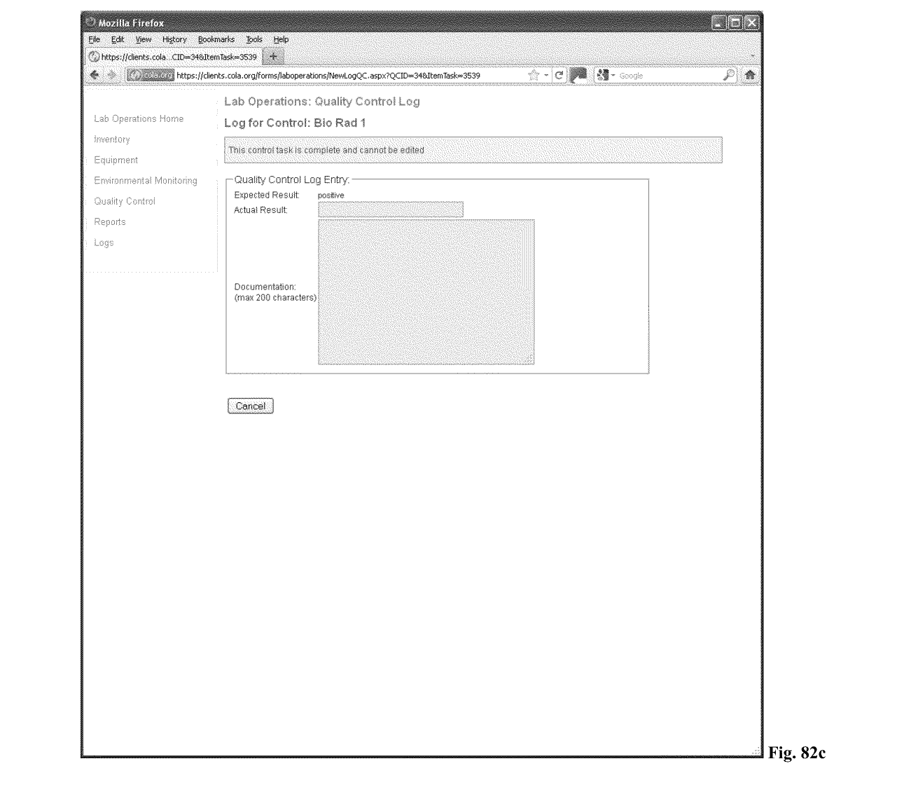

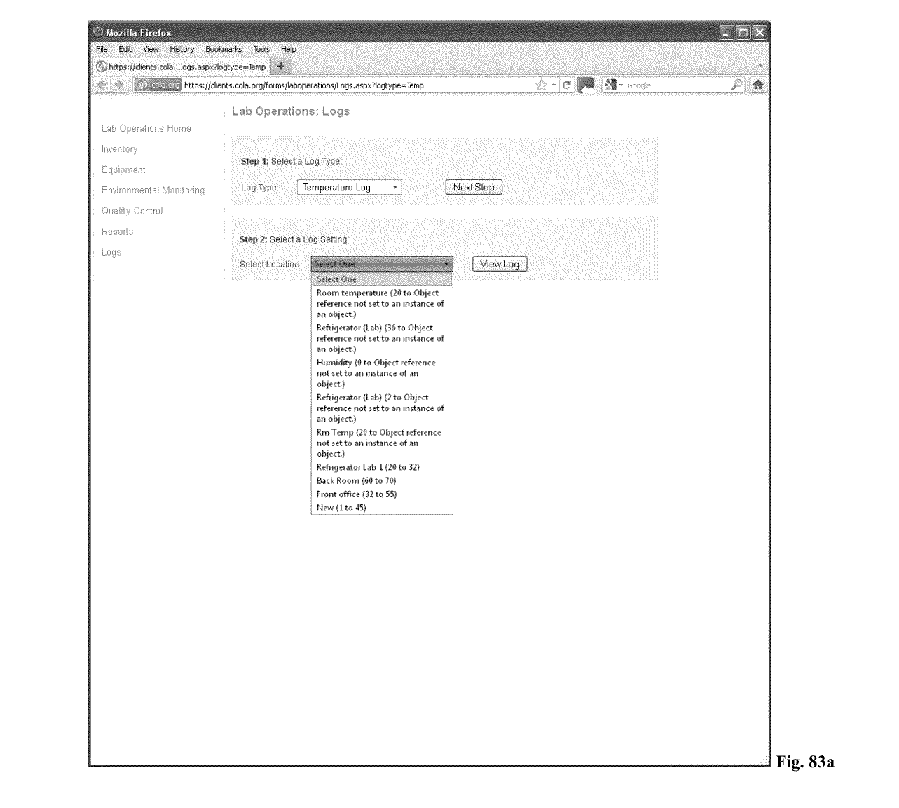

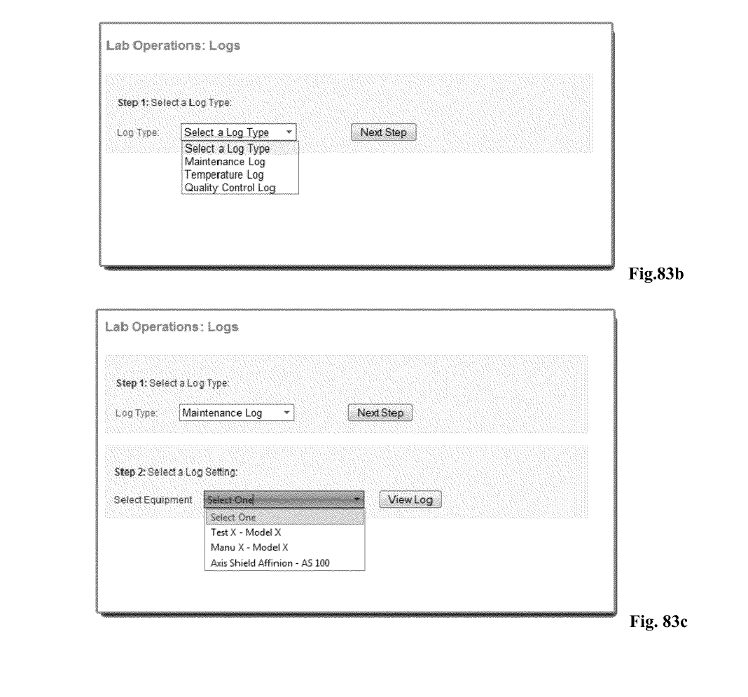

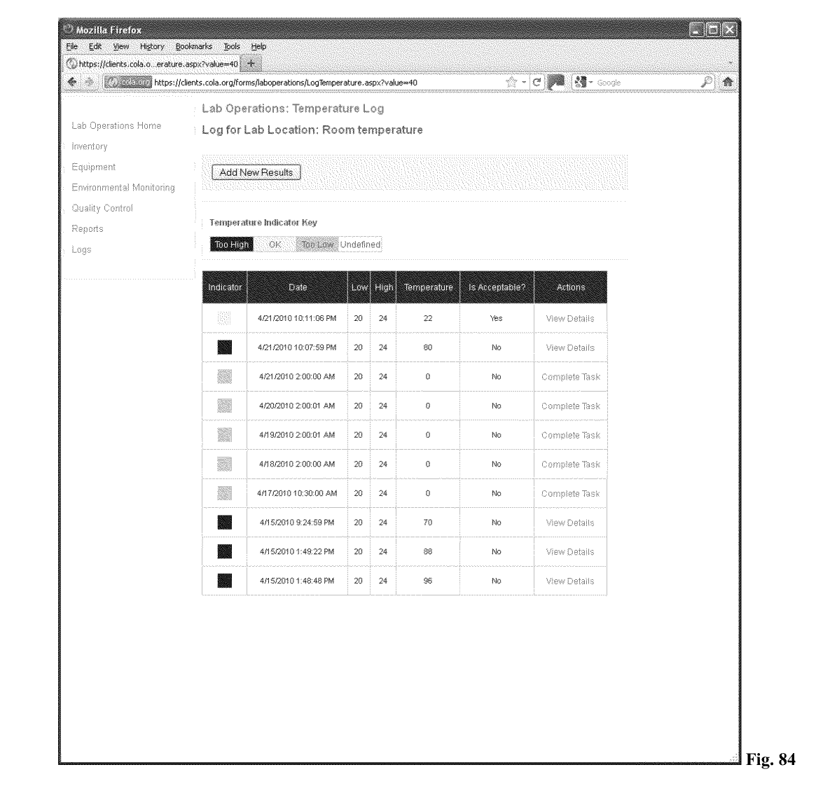

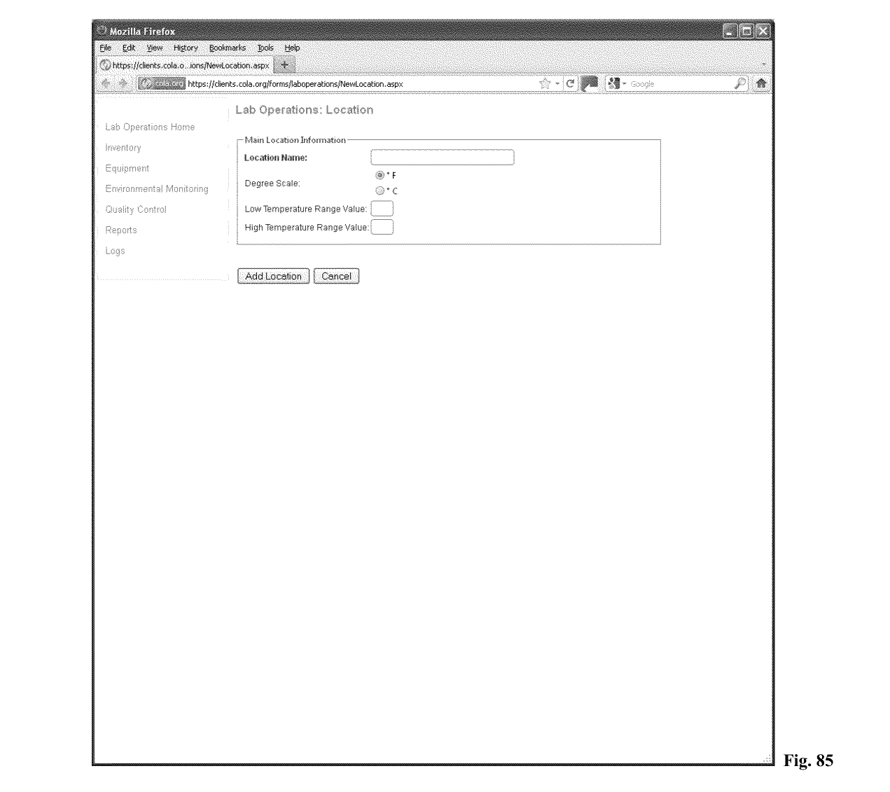

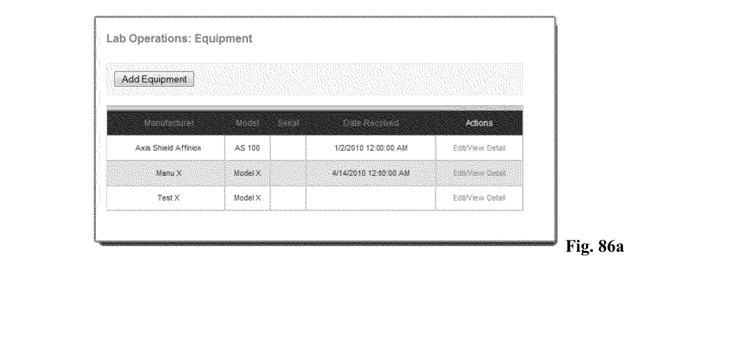

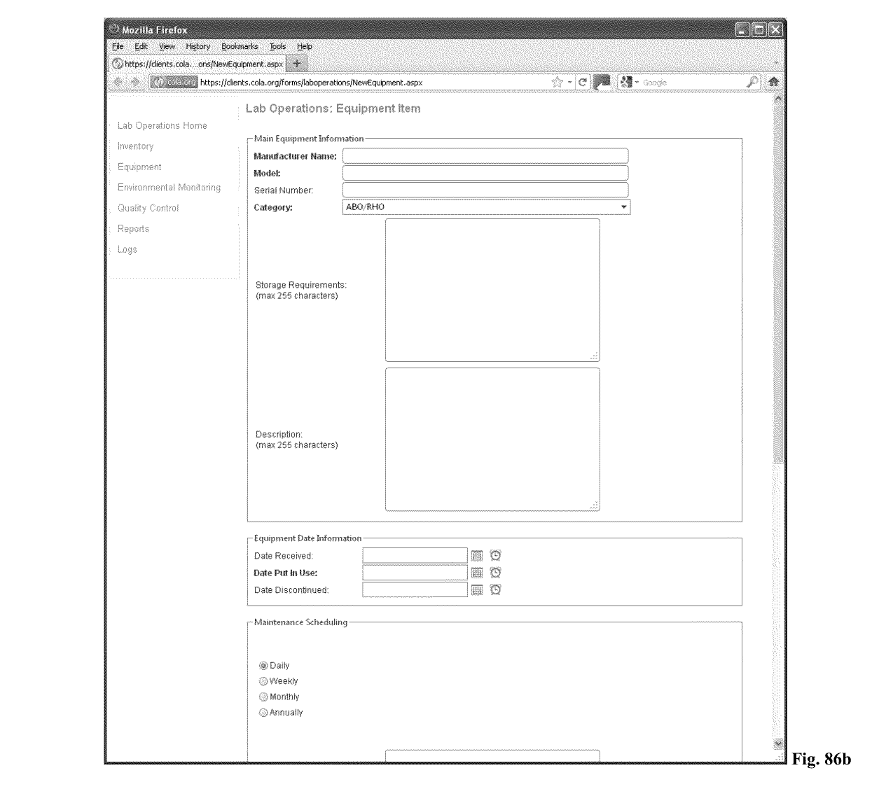

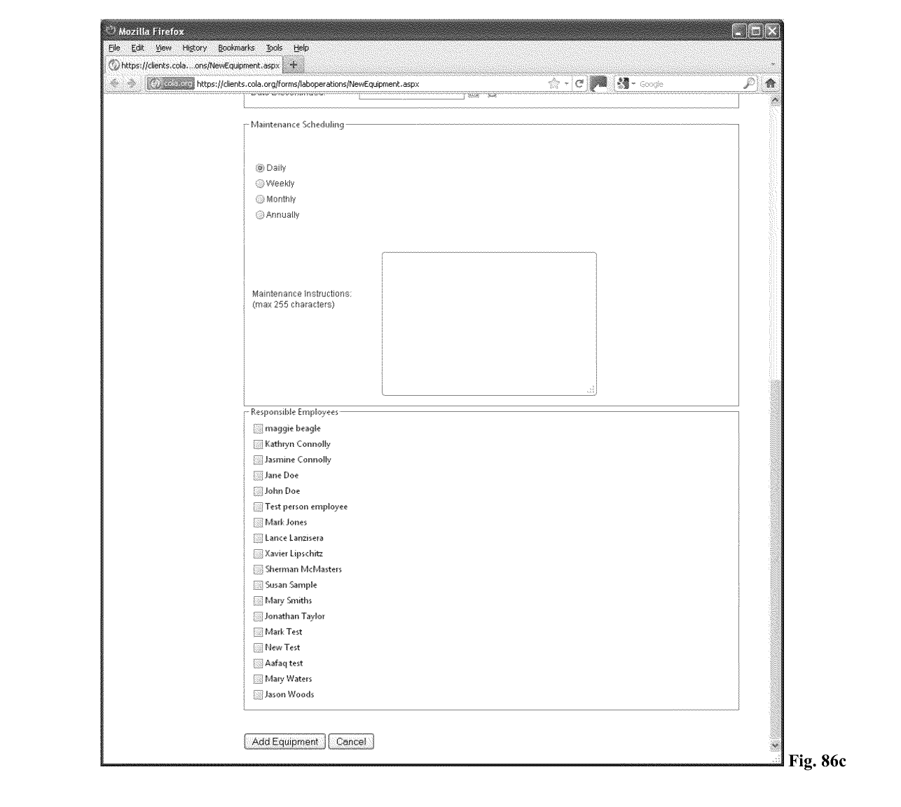

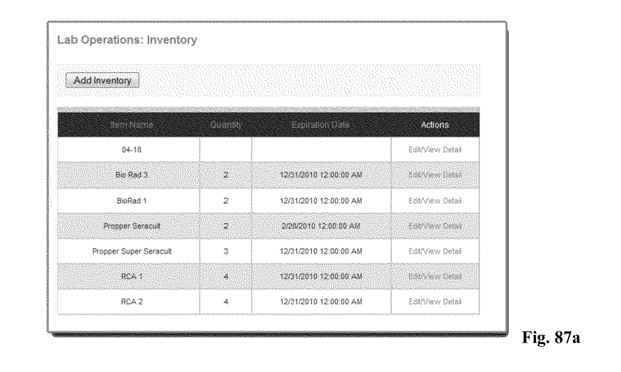

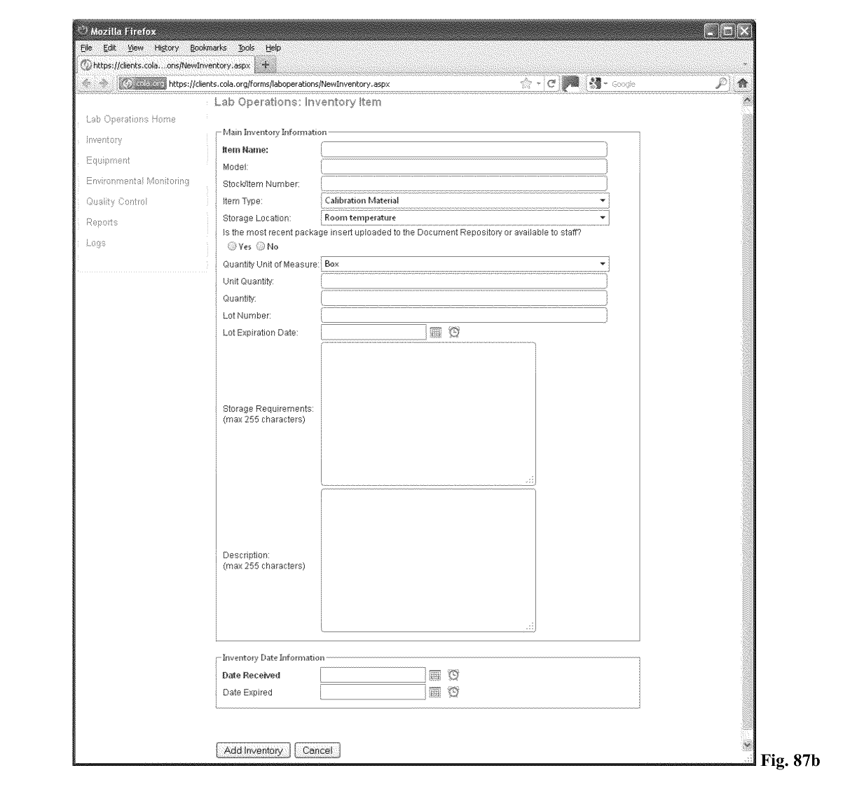

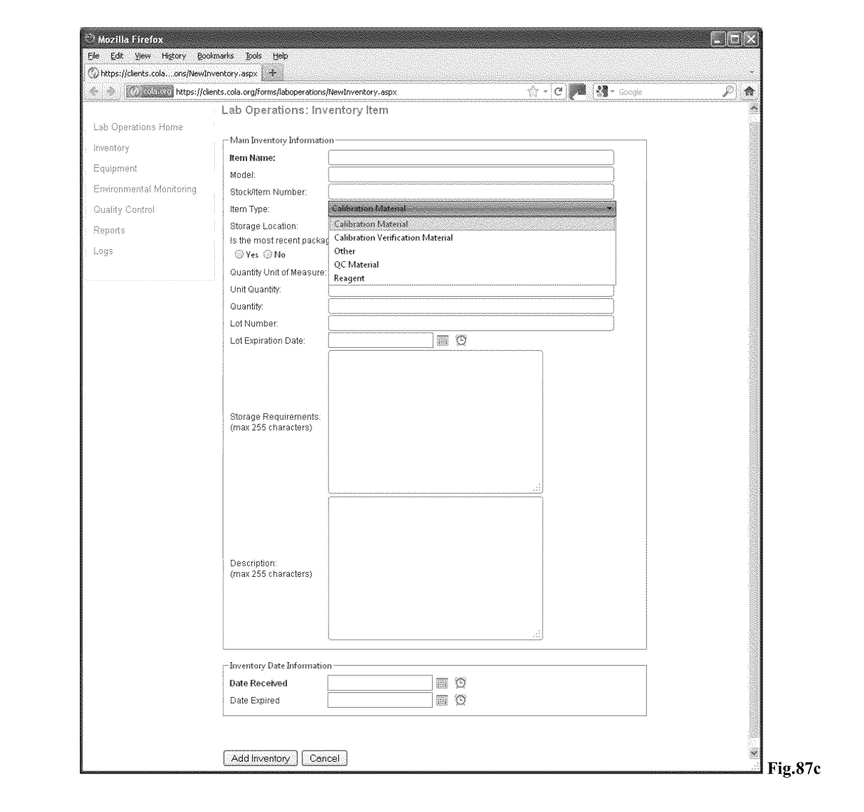

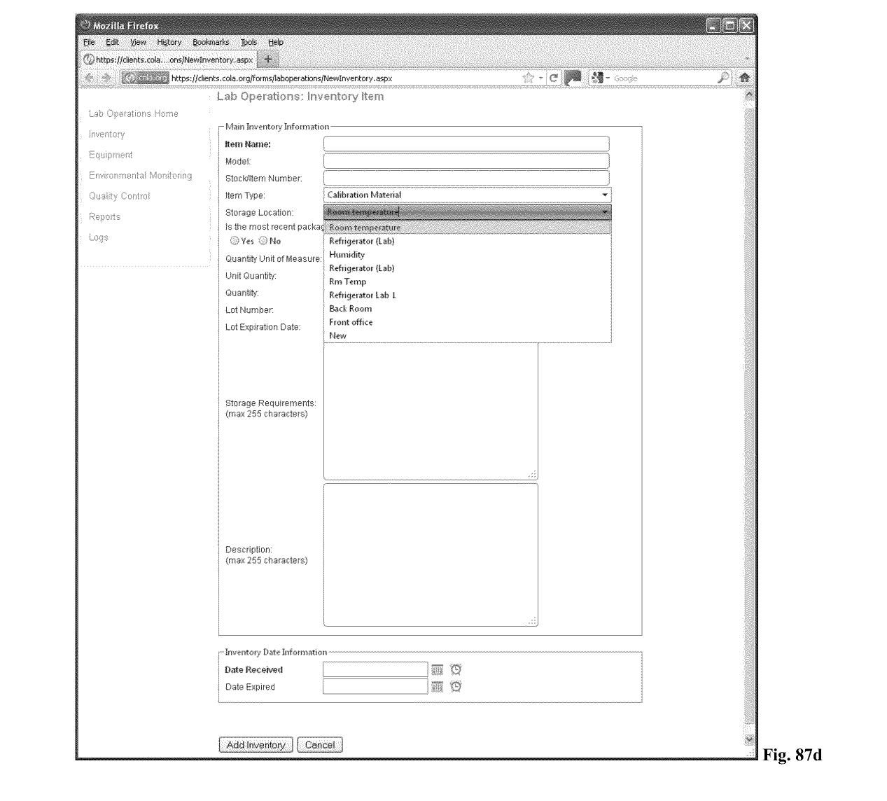

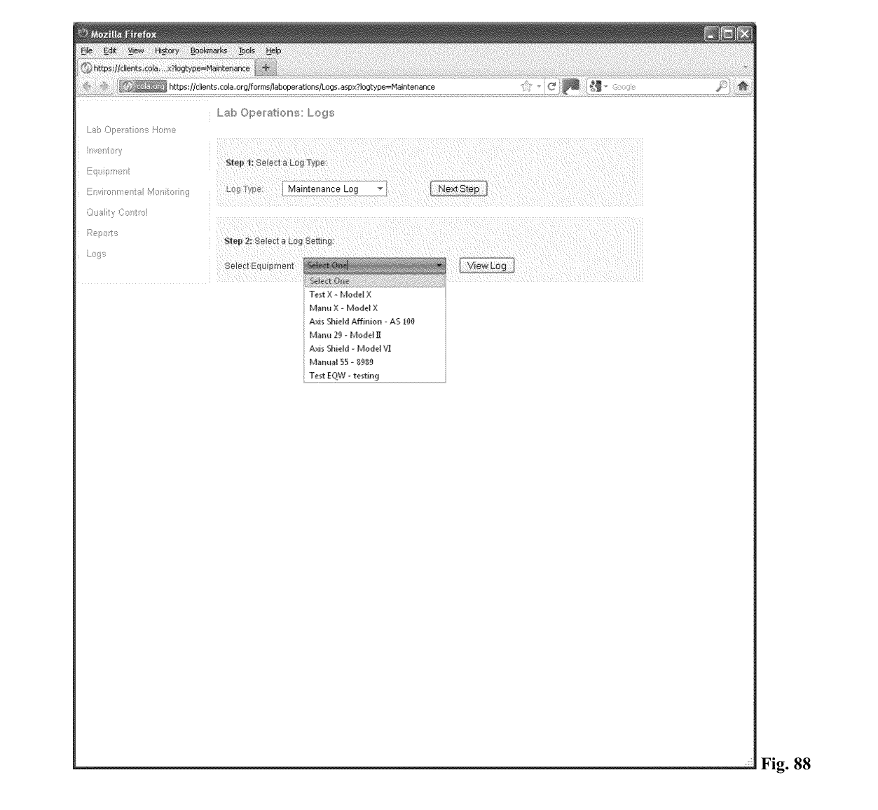

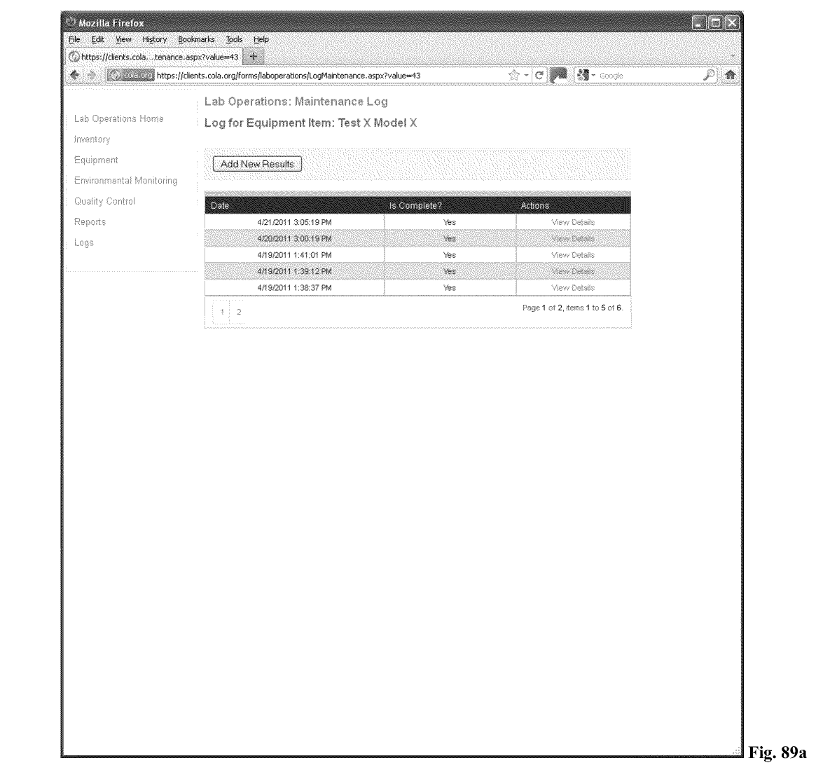

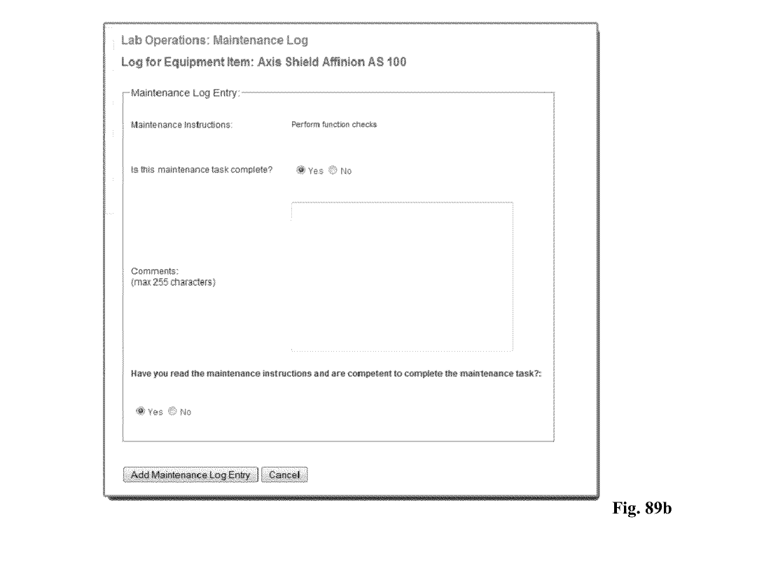

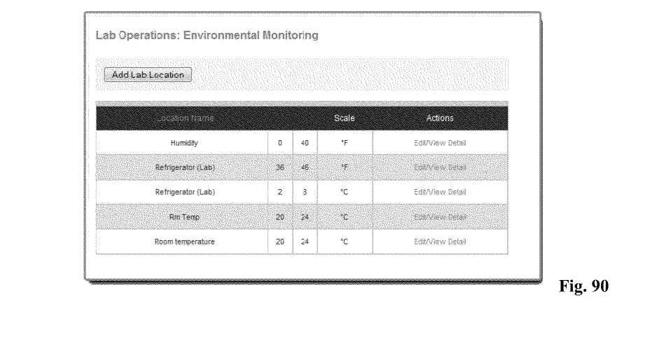

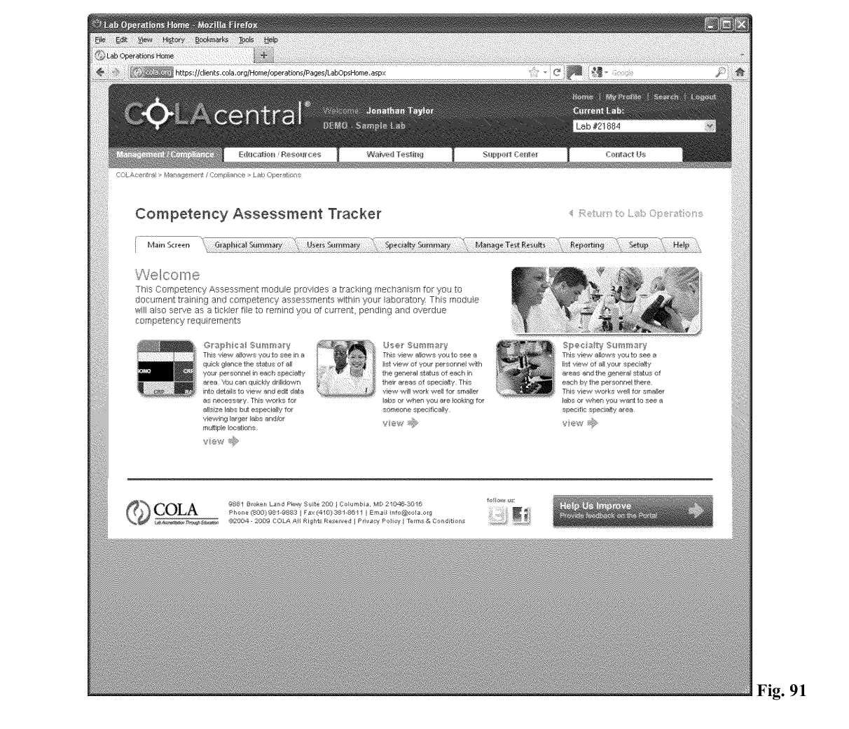

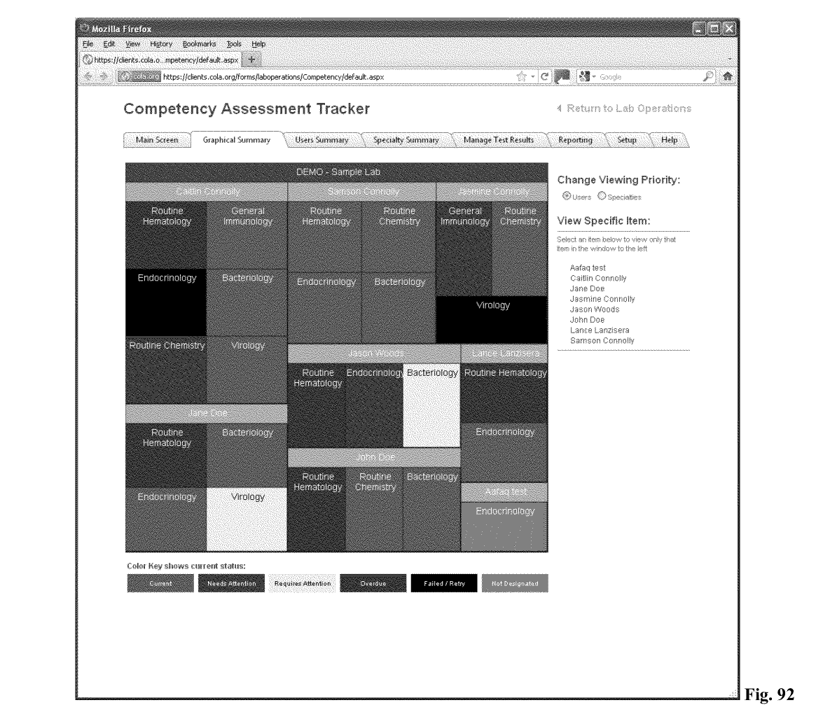

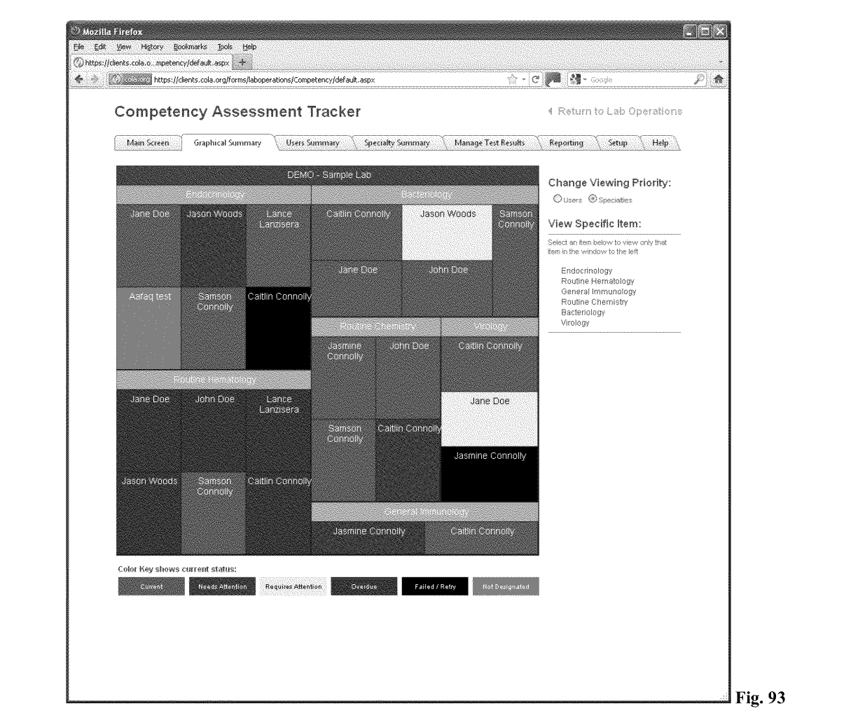

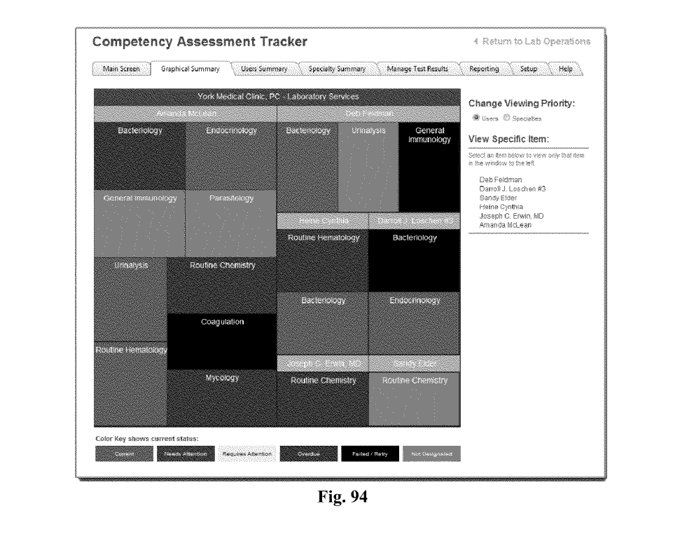

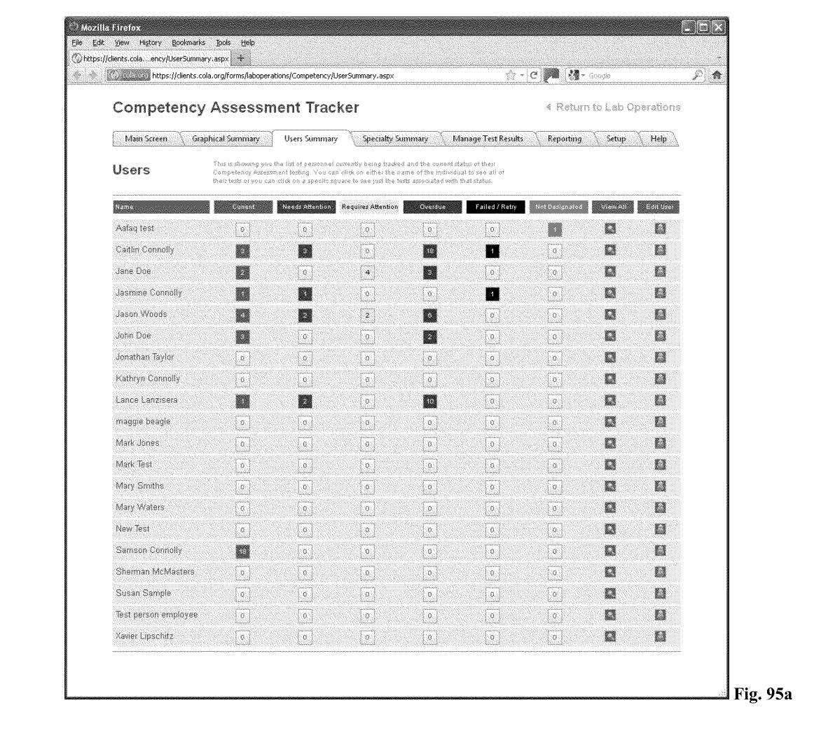

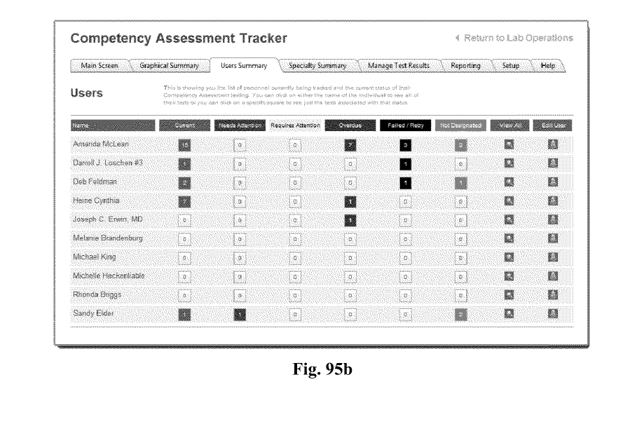

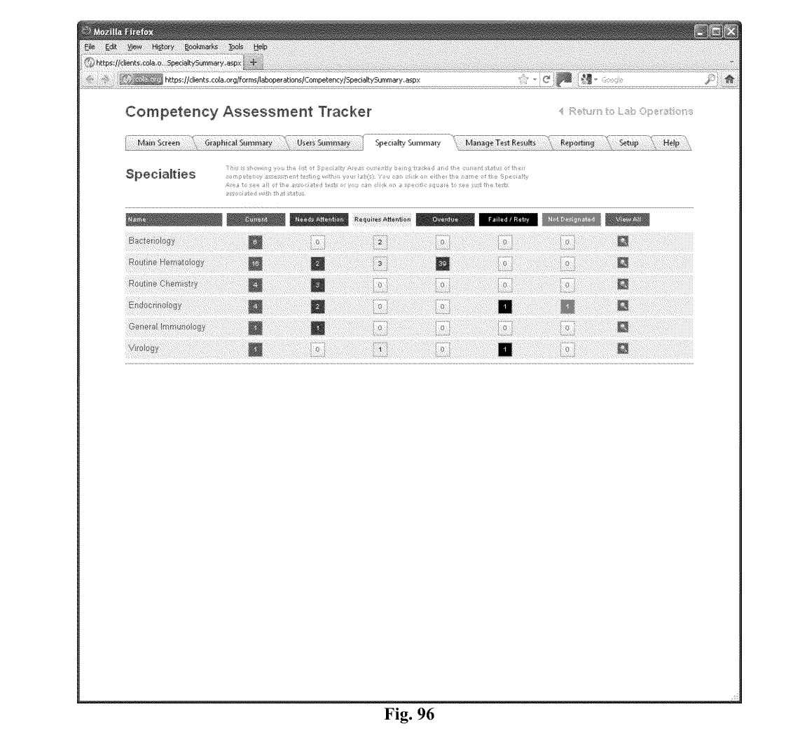

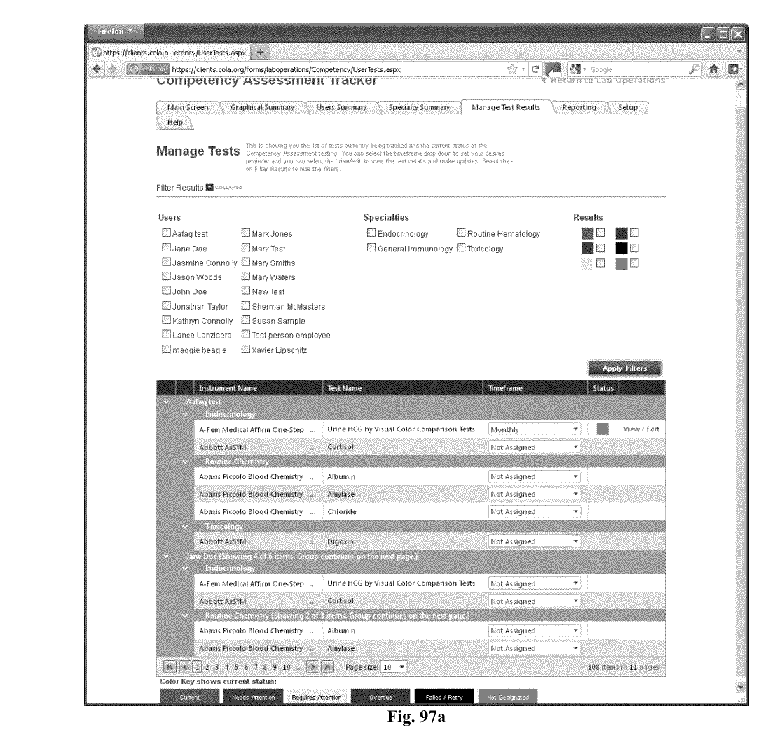

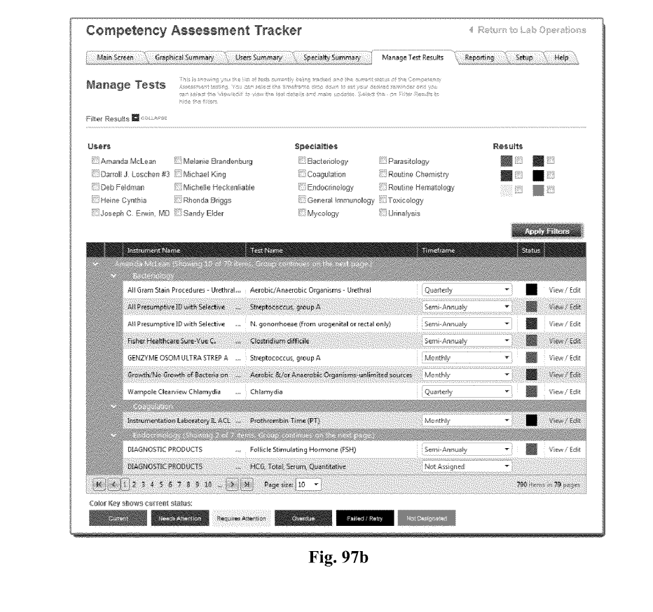

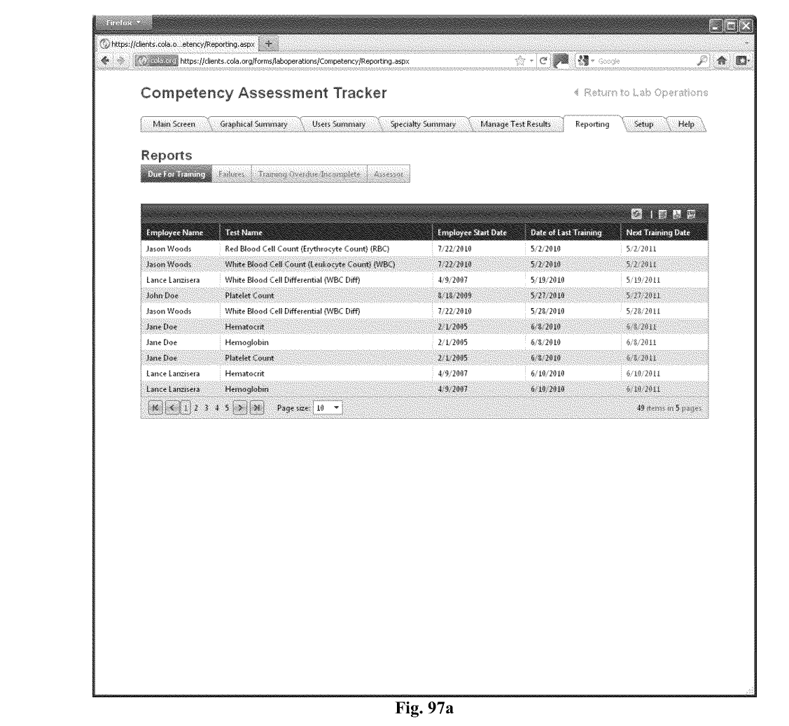

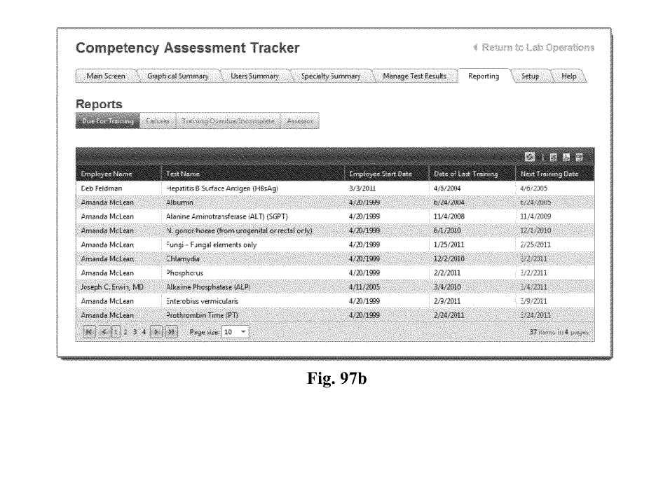

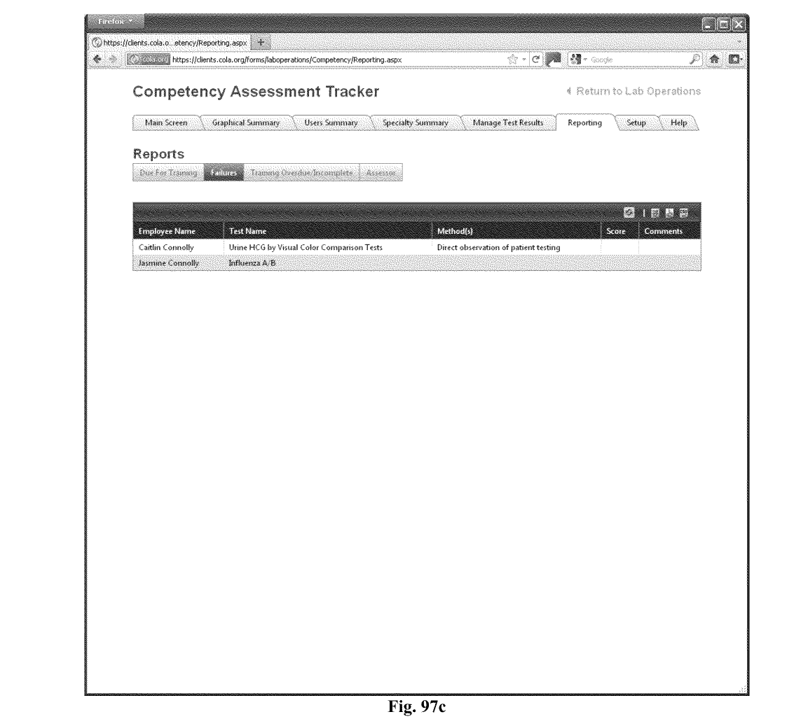

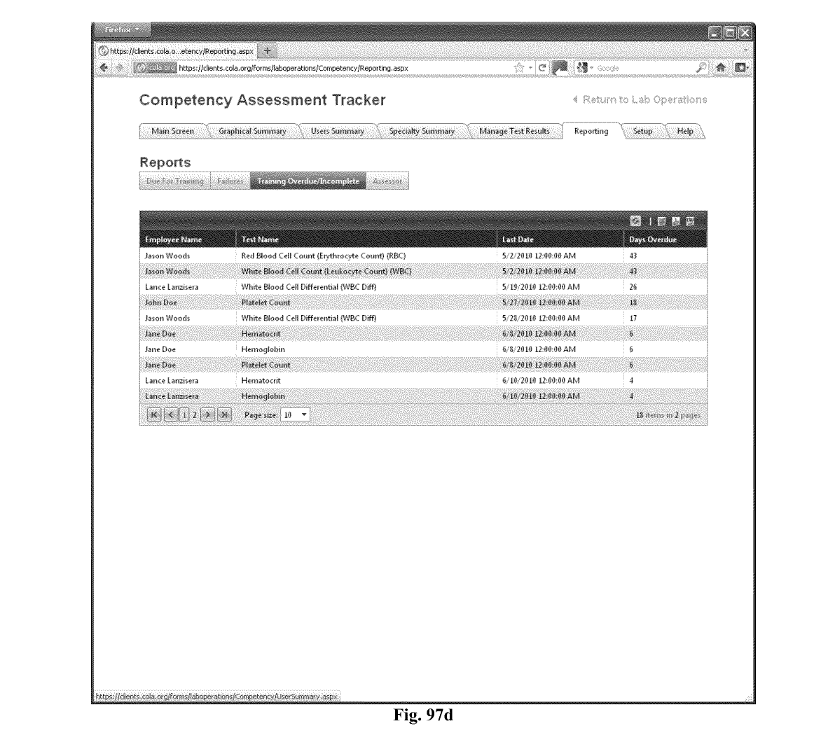

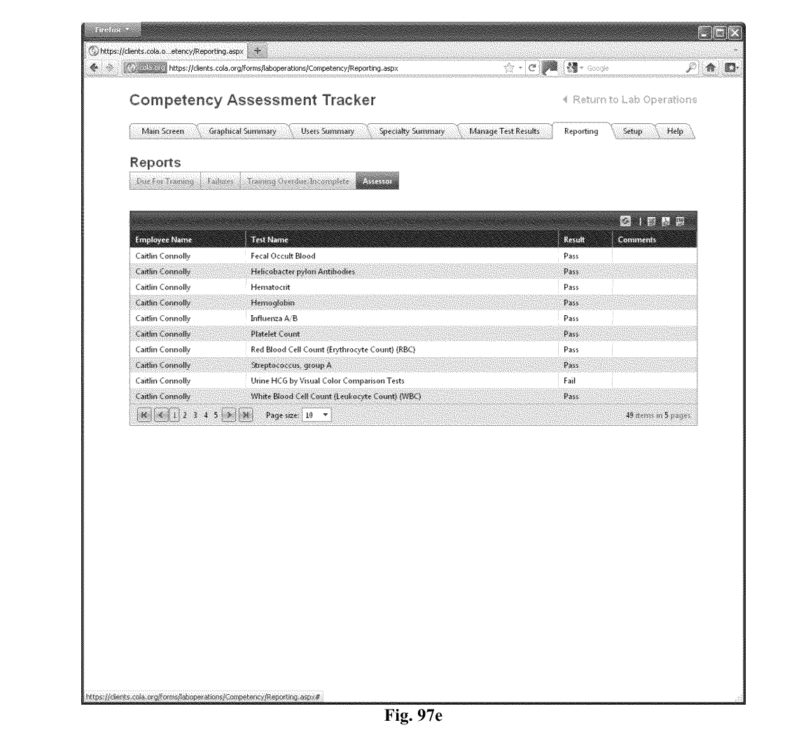

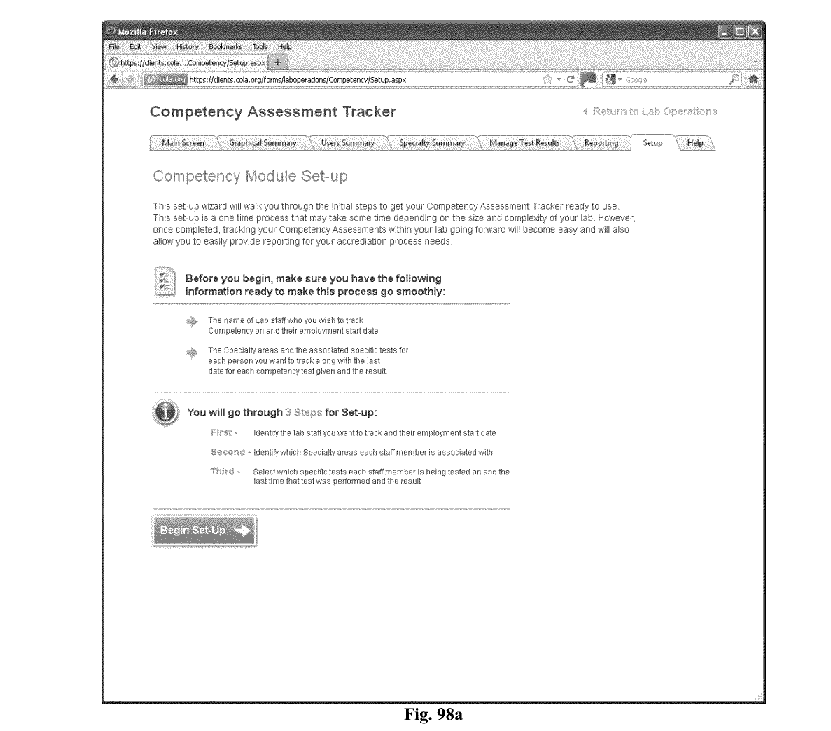

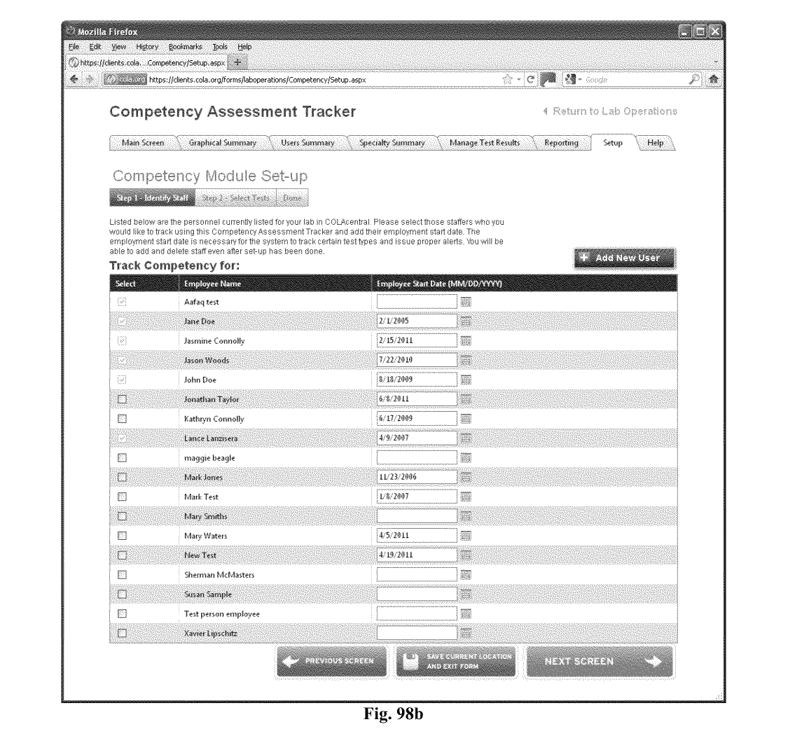

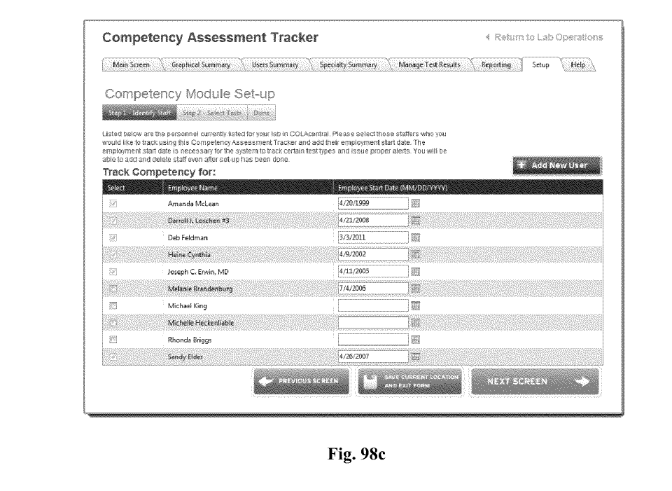

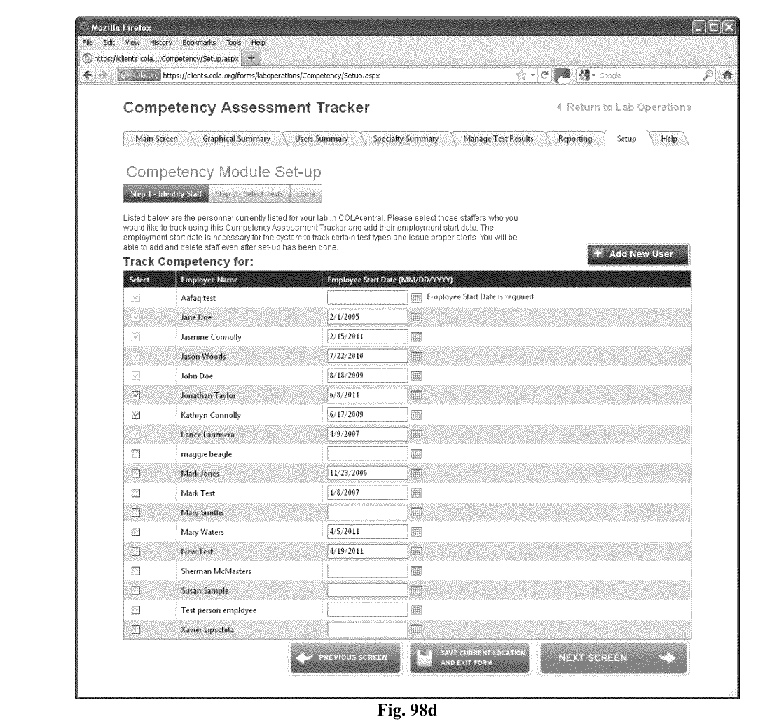

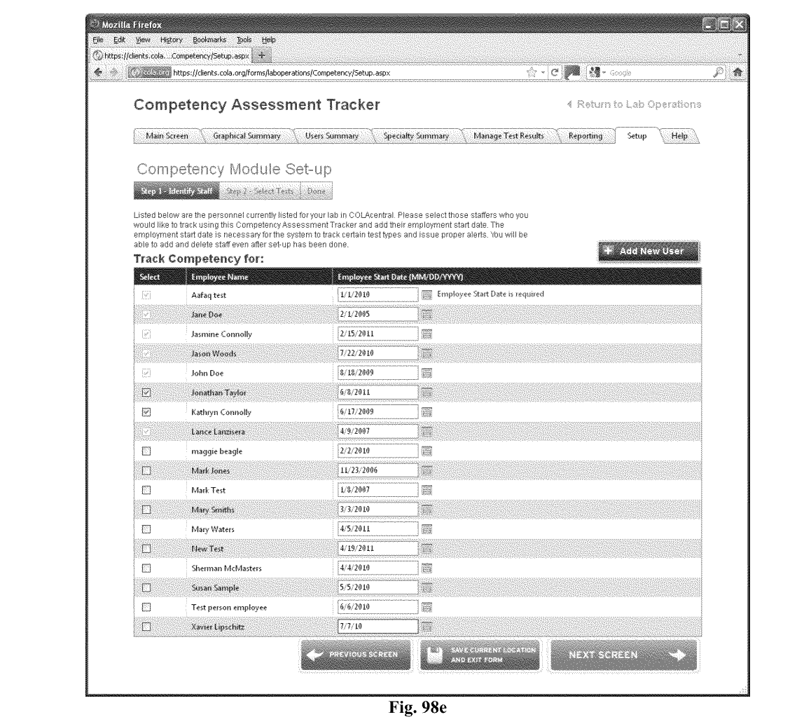

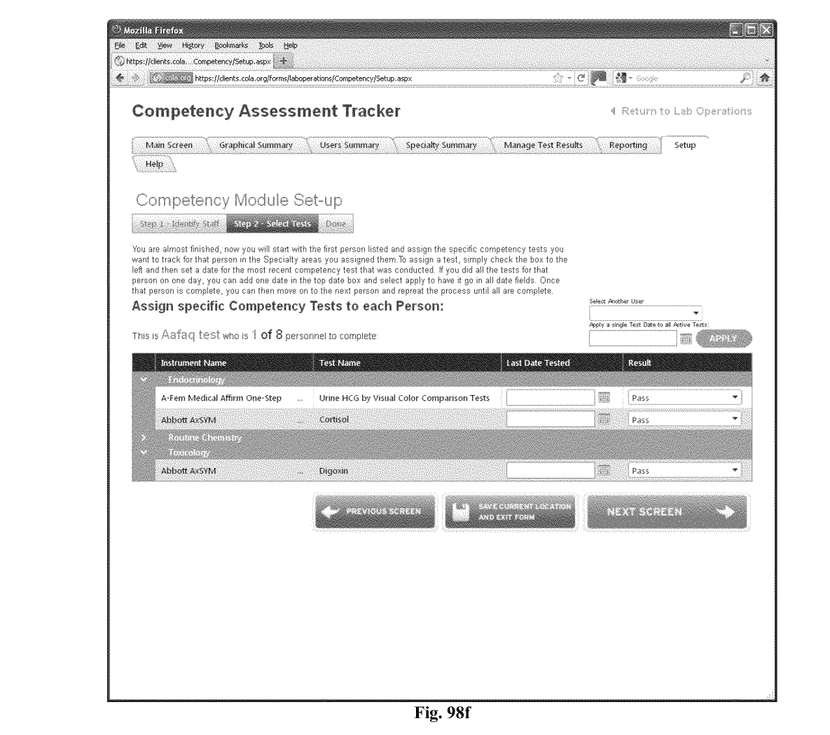

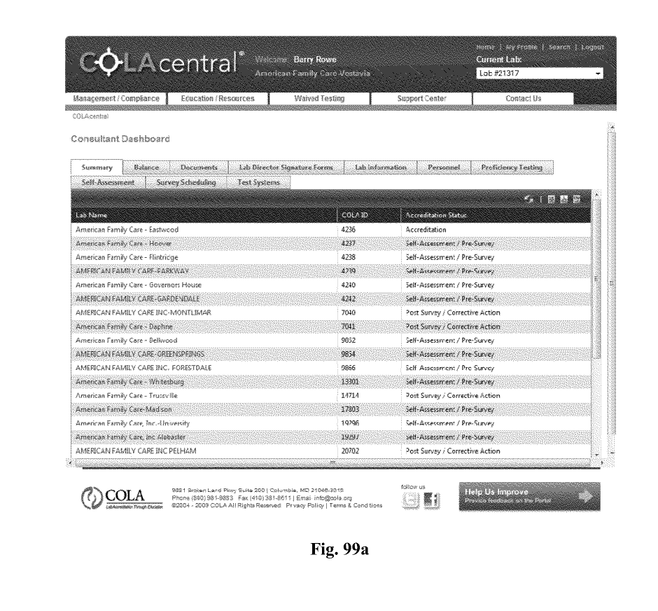

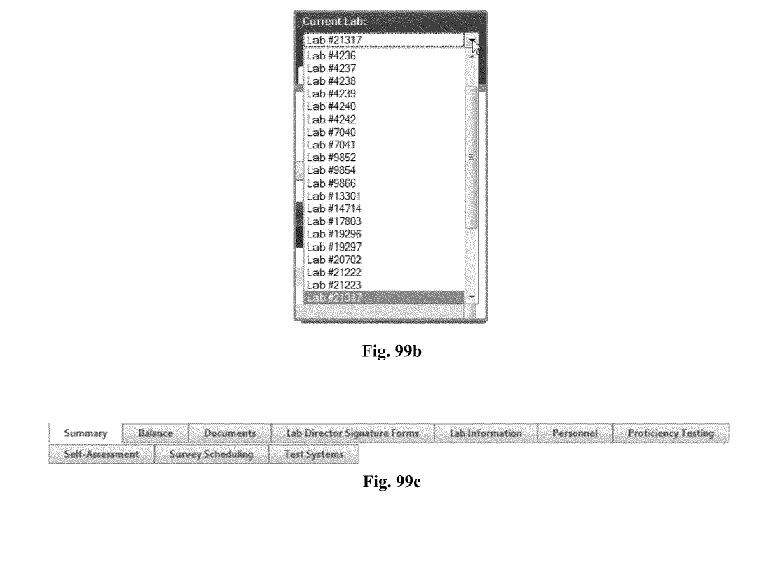

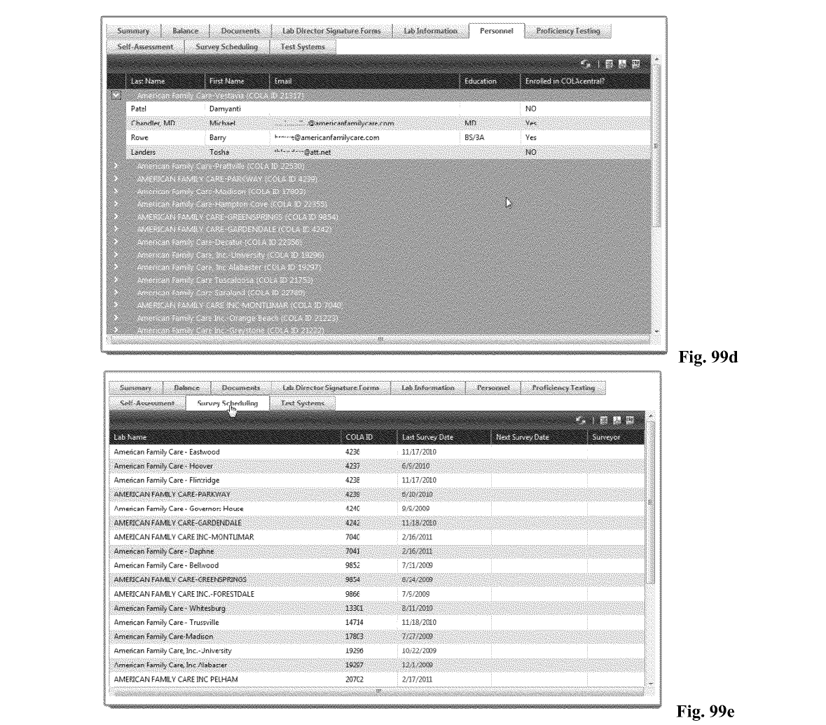

### DETAILED DESCRIPTION

COLA, an internationally respected clinical laboratory accreditation organization, launches a personalized desktop tool, designed to help laboratory personnel manage their laboratories and professional development more efficiently. COLA customers now have access to the tools needed to run a more efficient laboratory and improve patient care.

Called “COLAcentral,” the web portal provides a variety of helpful electronic tools, giving laboratory personnel the ability to update their laboratory profile, view news alerts and survey results, prepare for upcoming compliance surveys and receive support for a wide range of laboratory needs. Key features include an easy-to-follow dashboard wheel that displays compliance status information at a glance, a self-assessment wizard allowing managers to monitor their laboratory's quality and a dedicated section for waived laboratories. COLA's new client portal website is designed to provide a resource where laboratory professionals can update their lab profile, view communications, see survey results, prepare for upcoming surveys and receive support for a whole range of laboratory needs.

COLAcentral is a cutting-edge personal webportal for COLA accredited labs that gives users a 360-degree snapshot of their laboratory/organization, enabling and empowering them to take control of their laboratory/organization and focus on delivering high quality, consistent patient/end-user care. COLAcentral' provides a one-stop location for supporting laboratory and organizational compliance and support services.

COLAcentral is packed with tools to help users manage their labs more effectively, efficiently and profitably, keep up to date and be well prepared for their next accreditation. COLAcentral includes numerous features, “freeing” labs up from handling massive amounts of paperwork and alleviating worries about being compliant during upcoming inspections. Management Compliance tools include a document repository which holds all key correspondence as well as lab director forms, proficiency testing results, even a self assessment Wizard to check a lab's quality. High performing labs and those who want to prevent repeat citations are seeing measurable results by using COLAcentral every day.

COLAcentral helps them achieve these goals by providing a customizable desktop that lets them manage regulatory compliance, access educational resources, store and update records, receive industry alerts and talk online to their COLA surveyor from one convenient location.

This interactive new tool also permits laboratory managers to:
inform COLA of personnel updates, eliminating the need to fax this information,
store information such as laboratory director forms and proficiency testing results in an electronic filing cabinet,
view biographical information and photos of COLA laboratory surveyors,
view current COLA account balance and make payments,
register for COLA symposia and special programs and
schedule surveyor visits.

Prevention and compliance support does not end there. COLAcentral provides educational bundles to address top ten citations and the top ten repeat citations. To further support your laboratory operations a document repository that provides you with the ability to manage your compliance and practice documents in a safe, secure on-line environment is available.

COLAcentral is also useful for laboratories with Certificates of Waiver. Studies have shown that a noticeable percentage of waived sites are not meeting minimal requirements and are not aware of recommended practices to help ensure quality testing. COLAcentral provides an easy-to-use and affordable solution to this problem, by allowing waived laboratories to access COLA's growing library of more than of 60 online courses as well as a variety of other resources that help them improve performance.

Features

COLAcentral is packed with features that organizational and laboratory clients need to manage compliance activities throughout the Accreditation Life Cycle. From online document storage to real-time compliance survey results, COLAcentral stands out from the rest.

Some features include:

Compliance Record Management—Keeping track of all the required documentation for lab accreditation was once a difficult and taxing process. Now, COLA lab directors can view, upload, and track all COLA lab documents in once place.

Lab Inventory—Maintaining lab inventory and performing routine maintenance can be a challenge for lab directors to consistently monitor and control. With COLAcentral's new lab operation management services, inventory and lab asset management has been simplified.

Customer Service—Users will receive the industry's highest level of personalized service. The COLA brand of customer service is designed to empower you, as a valued customer and partner, with the ability to aid in COLA's continuous improvement efforts.

Education and Training—COLA has taken the lead in changing how education and training are provided to laboratorians. Through COLA's new plan, users/laboratories/organizations will benefit from tools designed with prevention and CLIA compliance at their core. Prevention tools include bundles of courses designed to prevent laboratories/organizations from receiving citations, including the “Top 10 Citations” and the “Top 10 Repeat Citations.”

Critical Alerts and Messages—COLAcentral has a unique alert system to notify laboratories/organizations of critical compliance and regulatory requirements.

Survey Results and Proficiency Testing Results—COLA is committed to a laboratory/organization's compliance goals, so after a COLA surveyor visits a laboratory/organization, users can login to COLAcentral to view a laboratory/organization's survey results. COLAcentral will even recommend training and educational materials to handle citations. Users will also have access to proficiency testing results and helpful links for more information about testing providers in a geographic area.

Personnel Management—Using COLAcentral gives users the control to manage lab/organizational employee data with ease.

Lab Information Management—COLAcentral enables laboratories/organizations to keep their lab/organization's information current. Users can edit their lab/organization's demographic data, hours of operation, CLIA information, director profiles, and more.

Utilize consultant tools to help with key lab operations... Manage Multiple Locations, Single Dashboard, See Scheduling, Review Balances

Multi-Site Access features include:

Consolidated Alerts—Users are notified when their labs have reached critical milestones in the accreditation process through COLAcentral's automated alert system. Users can view alerts for all of their labs/organizations in one place.

Aggregated Data with Single Sign-On—Single sign-on access is important to consultants with multiple labs in various locations. With a (new) consultant account, users can view compliance survey results for all of the labs/organizations they are associated with via the COLAcentral portal with one login. Consultants/Managers can view all of their labs under one COLAcentral user log in. This feature allows users to monitor one or thousands of labs from their computer.

Management Dashboards—Users can track the compliance activities of all their associated labs through COLAcentral's new management dashboard for consultants.

Documentation features include:

Record Management—Critical documents related to compliance were once a hassle to maintain and organize. Those days are over! With the new Document Repository in COLAcentral, users can view and download all COLA compliance documentation related to their lab. Users can also send documents to COLA for review.

More Space for Critical Documentation—Take control and always have access to necessary/critical documents. COLAcentral's new Laboratory plan includes an additional 2 GB of space to use as a safe place to store valuable documentation. Critical documents, like lab-specific guides and procedure manuals, can now reside in a secure online location. For users who are professional consultants or work in an integrated health system, each lab enrolled in a COLAcentral Laboratory plan will gain this additional document storage functionality

Organization—Managing files in a traditional file system can sometimes become cumbersome. COLAcentral's new tagging feature works like traditional folders with an extra bonus: users can associate multiple files with the same tags, filter by tag, and quickly add and remove tags. Color-coding further enables organization.

Document Delivery Minus the Extra Work—Sending documents to COLA has never been easier. Users simply locate and upload your compliance materials online in COLAcentral. COLA's experienced team of accreditation professionals will instantly receive them for review.

Lab Operations

Utilize online tools to help with key lab operations... Maintain Logs, Record Inventory, Document Environments, List Equipment, Generate Reports.

Asset tracking is key to laboratory success. Instead of investing in an alternate tracking system that would require additional employee training, COLAcentral provides laboratories/organizations with a secure online application to manage laboratory/organizational inventory.

By utilizing the Lab Operations feature of COLAcentral users can dramatically improve their lab's efficiency with immediate results. Lab Operations is a customized inventory control module created specifically for each lab to put users in control of maintenance, quality and profitability.

Equipment Tracking—COLA laboratorians and accreditation professionals have first-hand experience with the challenges of tracking and maintaining lab equipment. Whether users work in an independent lab, manage multiple labs as a professional consultant, or work in an integrated health system tracking lab equipment is now possible!

Asset Management—Using COLAcentral's new inventory module, users have the ability to track vital lab assets via a user-friendly online interface.

Maintenance Schedules—Each piece of equipment that is tracked with the COLAcentral inventory system can be associated with a maintenance schedule which users can tailor to meet your lab's needs. Users can assign maintenance tasks to one or several lab employees according to the laboratory/organization's custom schedule.

Environmental Monitoring—Optimal temperatures for equipment and lab assets need to be monitored on an on-going basis. With the COLAcentral inventory system, users now have the opportunity to identify optimal environmental settings for different areas in their laboratory/organization. Users can also assign tasks to lab technologists to record temperatures according to your schedule.

Quality Control—Based on years of laboratory experience, COLA has developed a quality control module to allow users to correlate quality requirements with their laboratory/organization's specific testing systems.

Reports—The reporting features of the COLAcentral new lab inventory module take the hassle out of asset management monitoring. COLAcentral provides users with the ability to view and export reports for equipment, expired inventory, environmental monitoring logs and quality control logs.

Premier Customer Service

Customers will receive the industry's highest level of personalized service. The COLA brand of customer service is designed to make you feel like a valued customer and partner.

Personal Consultations—COLA is there when customers need COLA the most. Lab surveys can often be challenging for COLA's clients, and having an accreditation professional there to help you with questions and concerns before the survey is essential to compliance success. After years of experience and thousands of successful surveys, COLA's pre-survey consultation will help your lab prepare for a stress-free survey process.

Citation Assistance—Compliance citations present unique challenges. COLA's goal is to turn those challenges into opportunities for success. Where other agencies often leave off, COLA picks up. COLA's service model is key to COLA's success, and we treat every customer as a partner. If you need help with understanding a citation, or need to know how to remediate an error, COLA's team of lab technologists are here to help.

Dedicated Support Teams—We know that even the best labs sometimes run into problems. So, we've created a trained team of accreditation professionals to meet the unique compliance needs of your lab. Whether you need help with a citation or have questions about COLA's STAT process, you'll have the confidence of knowing that a team of individuals that are familiar with your lab's compliance needs are only a phone call away.

On-Going Communication—COLA's goal is to keep you engaged in the accreditation process through on-going and consistent communication. As a COLA lab, you'll have access to COLA's highly successful Insights newsletter. COLA will keep you informed of what we're doing to improve COLA's accreditation services. Periodically, we'll just give you a call to determine if there is anything we can do to improve COLA's service. We understand that you're busy, so we've created customer service surveys that you can complete online at any time. We are constantly reviewing feedback and looking for ways to meet the challenges of today's laboratorians.

Education and Training—We provide you with the tools to succeed. As a member under one of COLA's new plans, you'll enjoy all COLA's membership benefits, including a new offering of educational products.

Top Ten Citations and Top Ten Repeat Citations Course Bundles—Even the best labs receive citations during lab surveys. After years of partnering with labs across the country, we've developed courseware to cover the most common citations. We've also generated an extensive course bundle to address the top ten repeat citations most labs experience. As a member under one of COLA's new plans, you'll enjoy the benefits of these valuable course bundles.

Lab Director Program Course Discounts—COLA is invested in your success, and when you enroll in one of COLA's new plans, you'll receive a 15% discount on COLA's popular Laboratory Director Program. With this program, qualified individuals can improve their skills and learn techniques required to become valued lab directors in today's industry. Physicians who complete COLA's program will earn at least 20 Continuing Medical Education (CME) credits that meet CLIA requirements and Quality Systems standards in the areas of laboratory practice and director responsibilities. Non-physicians can also benefit from this comprehensive program, and will earn P.A.C.E.® credit while learning about clinical laboratory operations and regulatory compliance.

Please note that anyone may participate in this program, but only licensed MDs, DOs, or DPMs may obtain CME credits and use them as a means to qualify as a laboratory director for a moderately complex laboratory.

The savings you will receive from one Lab Director Program purchase could cover the entire cost of new enrollment!

Symposium for Clinical Laboratories Discounts—Educating laboratorians is a key element in improving patient care. COLA partners with educational institutions to facilitate a series of Symposium events throughout the year. The Symposium for Clinical Laboratories was designed to help you meet CLIA & COLA requirements, improve operations, prevent errors and reduce cost. As a member of COLA under one of COLA's new plans, you and all of your staff will receive offers for discounted attendance.

Alerts and Messages—A custom alerting and messaging system to send notifications regarding critical steps in the accreditation life-cycle process. An important facet of the COLAcentral customer service model is to provide customers with on-going and purposeful communication regarding their compliance needs.

Accreditation Forms and Records—Instead of managing hard copies of compliance requirements, users can use the alert and messaging features of COLAcentral to view critical alerts online or via email.

Asset Management and Control—The COLAcentral inventory module was designed with the clinical laboratory in mind. COLAcentral will keep lab asset managers aware of equipment maintenance tasks, inventory expiration, and more.

Part 1: Understanding Your Accreditation Status

Determine your accreditation status with ease! Labs can use the accreditation life cycle graphic and helpful widgets to determine where they are in the 2-year accreditation process.

One of the most user-friendly features of COLAcentral is the accreditation life cycle graphic. The accreditation process is displayed and the lab's current status is highlighted. If you don't understand a portion of the accreditation process, you can click the life cycle segment on the graphic to review a detailed description of exactly what will occur during that segment of the process.

Another helpful tool that we've added to COLAcentral is the survey widget. When a lab approaches a survey date, so they will be able to see a picture of their surveyor, link to a brief description of the surveyor's background and review a list of other hiqhy-qualified and skilled COLA surveyors.

Finally, using COLA's alerting system, a lab can view a listing of critical outstanding compliance tasks that require their attention.

All of these aspects of COLAcentral empower COLA's labs to understand the accreditation process.

Part 2: Lab Survey Results

COLA's labs have access to view their last survey results within COLAcentral. COLA's mission is to enable labs to achieve compliance success through education and on-going regulatory improvement activities.

After a survey COLA's labs have access to view their performance metrics online If citations were given, they can view all their citations in one place.

COLA's mission is to provide clinical laboratory accreditation through education, so if a lab is challenged in an area, we'll recommend helpful tools, guides, documentation and courses to enable them to turn challenging citations into opportunities for compliance success.

Part 3: Proficiency Testing Results

Labs can use COLA's proficiency testing module to monitor their testing results over time and locate resources for COLA-approved testing providers.

Proficiency testing is an important tool to assess test accuracy and meet laboratory regulations. COLA monitors laboratory performance in proficiency testing and uses the same requirements and grading criteria as the federal government.

Within COLAcentral, we explain the proficiency testing requirements in detail and include a list of resources for providers.

Labs can quickly determine if they are deficient in any area by using COLA's color-coded performance indicators. We also provide a history of testing results so labs can track and monitor their compliance success over time.

As a COLA lab under COLA's new Laboratory plan, you'll have access to the proficiency testing module and all of COLA's other exciting premier services.

Part 4: Document Management

COLA takes the hassle out of compliance document organization. Using COLA's Document Repository module, labs can view and send documents within COLAcentral. This module also includes a color-coded tagging feature.

Not only is COLA's document repository a green alternative to printing large quantities of compliance data, it's also a user-friendly interface that allows COLA's labs to sort and organize compliance documents.

Labs can send documents to us for review, download documents that we've provided to them, and under COLA's new Laboratory plan, they can upload valuable documents that are specific to their labs.

Using COLA's color-coded tagging features, labs can keep all of their documents organized. They can even filter and search for documents by tag or keyword.

Dashboard

Easy access to helpful information & key features immediately upon login... Compliance Status, Alerts/Notifications, Documents, Personnel, Lab Information, Test Systems. The foundation of COLAcentral is the Accreditation Status “Pathway”—a graphic wheel which shows a user their laboratory/organization's current status with COLA and the steps ahead. The Dashboard quickly and visually shows the laboratory/organization's current (accreditation) status with COLA, on a graphic wheel. The Dashboard provides interactive features and resources for laboratories/organizations to learn most about accreditation steps and compliance related functions.

The alerts and messages can be sorted by priority, so that those items requiring immediate attention can be addressed first.

The dashboard shows your current status with COLA. You can click on any of the steps to learn more about what is involved at each point along the way. View the messages below to help keep track of what you should be doing next in your compliance steps:

Step 1: Self Assessment/Pre-Survey

Users may monitor their lab's quality and compliance with the Self Assessment Wizard.

Step 2: On-Site Survey

Step 3: Post Survey/Corrective Action

Step 4: Accreditation

Ongoing Activities: Ongoing Education—Ongoing Education includes post-Survey Support, a complete bundle of educational products personalized to help correct a laboratory/organization's deficiencies. Products are cross-walked with a laboratory/organization's specific citations and proven to help users/laboratories/organizations take control. Get access to great educational content & resource materials such as... Meet the Surveyors, Webinars, Manuals & Guides, Courseware, Regulatory Databases, Conference materials.

Ongoing Activities: Proficiency Testing—Proficiency testing includes a dedicated area for users to monitor a laboratory/organization's regulated analytes, which includes a color-coded dashboard displaying, for example, the last six events and notifications of adverse events.

Ongoing Activities: Information Update

Management/Compliance—The ability to manage laboratory information critical to your compliance. Access Schedule, Test Systems, CLIA Info, Personnel, Manage Forms, Conduct Self Assessment. Test Menu updates includes an online test and test systems page that provides laboratories with an easy to use, reliable interface for updating test and test systems. Under the “Management/Compliance” tab, users may:
Choose “Personnel/Security” to add or delete lab personnel (save changes);
Choose “Lab Information” to update demographics or hours of operation (save changes);
Choose “Test Systems” to update the test menu. (submit changes at the bottom of the screen and click “Send”).
Manage your personnel information in a number of key areas... See all your personnel, add new personnel, keep complexity information and control access through simple online forms.

Accounting Statement

Customize Widgets

Document Repository—The Document Repository is designed to eliminate the need for a cumbersome paper file system for a laboratory/organization's COLA and practice documents. This feature gives laboratories/organizations the flexibility of having a safe and secure online filing cabinet. Laboratories/organizations get 2 GB of space to upload and safely store compliance materials, CLIA certificates, personnel certifications and other important documents from all areas of their practice. Search documents by keyword...Upload documents and assign them for COLA use or for your own lab use...Create and apply your own set of tags to help easily find and identify the types of documents you are storing...

Lab Director Signature Forms

Lab Information Wizard—The Lab Information Wizard of COLAcentral presents an online version of what users typically see via mail from COLA. This new capability allows users to add or change information about their laboratory/organization online The information users provide in each section will be updated in the COLAcentral servers. Regardless whether users mail, fax or update online directly through the Lab Information Wizard, the Lab Information Wizard helps users manage their laboratory/organization.

The “Lab Information Wizard” of COLAcentral is where you can add to and change the information about your laboratory. The information you provide in each section to the left is automatically updated in the COLAcentral servers. Whether you mail, fax or update online directly through this wizard, this is your information to help you manage your lab. Users may update laboratory/organization personnel information with the click of a mouse. This replaces previous mechanisms including faxing of personnel information to accrediting bodies.

Users enter Hours of Operation, Blackout Dates, Demographics, Testing Overview, CLIA Information, PT Providers, Lab Director, Director (Moderate), Director (High), confirm and complete. For example, the Hours of Operation allows users

Users may update laboratory/organization personnel information with the click of a mouse. This replaces previous mechanisms including faxing of personnel information to accrediting bodies.

Personnel/Security—Users may view their laboratory/organization's proficiency testing scores for the last several events in this section, as well as view COLA-approved PT providers. Past PT scores show when regulated analytes are out of range and a color-coded dashboard with the last six events provide alerts about any adverse event.

Self Assessment Wizard

Test Systems

Lab Operations Home—COLAcentral's Competency Assessment Tracker is an enhancement that provides a tracking mechanism for you to document training and competency assessments within your laboratory. This module also serves as a tickler file to remind you of current, pending and overdue competency requirements.

A summary may be provided, for example:

COLA Lab ID: 0,

Total Equipment Items: 1,

Total Inventory Items: 1,

Total Lab Locations Entered: 6,

with Common Tasks:

Enter A Maintenance Log Entry,

Enter A Temperature Log Entry,

Enter A Quality Control Log Entry,

Add Inventory Item,

Add Equipment Item,

Add New Location and

Reports may be selected to be generated.

Competency—Track Competency Assessment within your laboratory . . . Set-up Wizard, Multiple ways to View Info, Receive Proactive Alerts, Generate Reports, Track Multiple Locations.

Inventory

Equipment

Environmental Monitoring

Quality Control

Reports

Logs

Competency Assessment Tracker—COLAcentral's Competency Assessment Tracker provides a tracking mechanism for you to document training and competency assessments within your laboratory. This module also serves as a tickler file to remind you of current, pending and overdue competency requirements.

A Summary may be provided. For example, a user may see the following information: “COLA Lab ID: 21884,” “Total Equipment Items: 7,” “Total Inventory Items: 11,” and “Total Lab Locations Entered: 9.” The user may then act on the “Common Tasks,” including: “Enter A Maintenance Log Entry,” “Enter A Temperature Log Entry, ” “Enter A Quality Control Log Entry,” “Add Inventory Item,” “Add Equipment Item,” and “Add New Location”

Education/Resources:

You will also have a vast array of educational resources at your fingertips from articles to manuals to on-line courses and state regulatory databases. There is even a private area focused on providing important information and tools for waived laboratories.

Waived Testing:

Access information & resources for Waived testing . . . Testing Manual, Proficiency Testing, Self-Assessments, Surveys.

Support Center:

The Support Center provides a “Getting Started” video series for new users, other videos to aid in using COLAcentral, an Acronym Guide, FAQ section, Directory of Organizations and many more Resources. Users can send online email correspondence to COLA surveyors for key insights to help their accreditation run smoothly.

COLA also provides Dedicated Team Support, to help remedy problems by providing consultation and educational products tailored for your individual laboratory. Other support features include “Citation Management,” Customer service technologists/Technical Advisors available to assist laboratories/organizations with understanding citations and using the products (i.e. educational, etc.) included in COLAcentral to remediate errors. A team of personal Technical Advisors are available through a customer support line (1-800-981-9883) to answer any questions a laboratory may have.

PRI Support Plan includes a complete bundle of educational products personalized to help laboratories correct deficiencies. Products are cross-walked with your specific citations and proven to help labs take control.

With regard to STAT/PRI, the STAT team helps remedy problems by providing consultation and education products tailored for individual laboratories.

Welcome to Waived Testing—This private area, focused on providing important information and tools for waived laboratories, is a special resource for subscribers and participating COLA laboratories.

COLA provides its participants with the resources they need to deliver quality healthcare. By joining COLA's Waived Program, you've become privy to a wealth of COLA information—accessible at your convenience and at the click of a button!

What are Waived Tests? Waived tests are laboratory tests that:
Are simple to use
Have easy to follow procedures
Provide accurate results

The Food and Drug Administration (FDA) determines which tests are approved as waived. The list of waived tests continues to grow as new tests are developed and approved.

Can Anyone Perform Waived Tests? There are no personnel requirements to perform waived tests, but your facility must obtain a CLIA certificate before performing any testing. If you plan to perform only waived tests, then get a CLIA Certificate of Waiver. Laboratories with a Certificate of Waiver are not required to participate in proficiency testing and are not routinely inspected. However, the CLIA regulations do allow inspections of waived laboratories under certain circumstances. If you already have a CLIA Certificate of Compliance, Certificate of Accreditation, or Certificate of Provider Performed Micrsocopy Procedures (PPMP), then waived testing is included.

What are the Requirements for Waived Testing? The most important requirement that applies to waived testing is: YOU MUST FOLLOW THE MANUFACTURER'S INSTRUCTIONS.It is extremely important that you follow the test kit or instrument manufacturer's instructions for performing any test. If you do not follow the instructions exactly, then you may not get an accurate result. Also, the test may no longer be considered waived if the procedure is changed in any way.

What are Good Laboratory Practices? Any test worth doing deserves your best effort. The results of the test may be used to make decisions about treatment for the patient. We already mentioned the importance of following all manufacturer's instructions exactly. The good laboratory practices below are additional steps you can take to make sure the tests performed in your office are accurate and reliable:
Ensure employees have proper training
Perform quality control (also following the manufacturer's instructions).
Focus on quality assessment (quality assurance) by monitoring laboratory activities, evaluating how things are done, and making improvements whenever needed.
Consider enrolling in proficiency testing (PT) as an extra check for test accuracy. It is not required, but economical PT modules are available for waived tests.
Keep organized records of training, test results, and quality control results.
Report any problems with the test to the manufacturer

Waived Survey—COLA has provided the waived survey to enable your Certificate of Waiver (COW) laboratory to review operations and align them to the expectations of the CMS validation survey.

This survey tool will help you to prepare for a CMS on-site visit to your COW laboratory under the Clinical Laboratory Improvement Amendment (CLIA).

The State agency surveyors will be visiting laboratories to ensure that personnel conduct quality testing in a manner which protects patient safety, determines each laboratory's regulatory compliance, and makes certain that each laboratory is only conducting the simpler tests that are appropriate for a certificate of waiver facility.

Requirements for Waived Tests—To receive a certificate of waiver under CLIA, a lab must only perform tests in which the Food and Drug Administration (FDA) and the Centers for Disease Control and Prevention (CDC) have determined to be so simple that there is little risk of error. Waived laboratories must meet only the following requirements under CLIA:

Enroll in the CM program

Pay applicable certificate fees biennially

Follow manufacturers' test instructions

The waived survey may be accessed through COLAcentral, and may include questions such as:
i. Are all tests performed classified as waived? §§493.15(c), and 493.1775(b)(3)
ii. If the answer to #1 is NO, list the non-waived tests. §493.1775(b)(3)
iii. Does the laboratory operate in and perform testing in a manner that constitutes an imminent and serious risk to public health? If the answer is YES, contact the RO for further instructions (ASAP). §493.1775(b)(1)

Waived Criteria and Self-Assessment Follow the Path of Workflow

The Waived Criteria are an educational tool that evaluates your laboratory processes through the path of workflow. In the medical laboratory, “path of workflow” is defined as the sequence of activities beginning with the initiation of a request for healthcare services, all the way through the delivery of those services. Simply stated, it represents the path a patient specimen follows as it moves through the laboratory; i.e., test orders and specimen collection and receiving (pre-analytic phase), testing (analytic phase), and result reporting (post-analytic phase).

Do not be surprised if some phases of your laboratory operation do not initially meet the COLA waived requirements. Take enough time while completing the questions to understand the requirements and make plans to correct noncompliant criteria you identify.

Be sure to consider each test system and every test, and each and every person filling designated positions in the laboratory as you answer the questions. Any partial noncompliance should be answered as a “no.” Only 100 percent compliance in every instance qualifies for a “yes” answer.

It is to your laboratory's advantage to answer “no” to questions for which your laboratory is only in partial compliance, because helpful educational feedback will be returned to your lab if the Waived Self-Assessment is submitted to COLA for review.

When you return your completed Self-Assessment to COLA, your responses will be reviewed for noncompliant criteria. If noncompliant criteria are found, COLA will send helpful information back to you to address these problems, so improvements can be made. COLA suggests you make appropriate changes in laboratory operations, processes, and procedures to comply with COLA's waived criteria.

We recommend that the laboratory repeat the Waived Self-Assessment (including sending the laboratory's responses to COLA for feedback) twice a year to assure continual compliance, quality performance, and readiness. The Waived Self-Assessment maybe downloaded via COLA central and transmitted to COLA for processing.

Waived Proficiency Testing General Information—PT is not required for any test that is waived. (Check the FDA website http://www.fda.gov/cdrh/CLIA to determine whether your test(s) are waived.) However, enrolling in a PT program and performing PT on your waived test(s) will provide you with an excellent indication of the accuracy of the waived test(s) and thus improve the quality of testing you provide to your patients. It also serves to demonstrate the accuracy of your testing if it is ever questioned. Please see the waived PT provider section to find resources on how to get started selecting a PT organization for your laboratory.

What is Proficiency Testing? Proficiency testing, or PT, is the testing of unknown samples sent to a laboratory by a COLA approved PT program. Most PT samples are sent to participating laboratories three times per year. After testing the PT samples in the same manner as its patient specimens, the laboratory reports its sample results back to their PT program. The program grades the results and sends the laboratory and COLA scores reflecting how accurately it performed the testing.

Why is Proficiency Testing Important? PT is important because it is a tool the laboratory can use to verify the accuracy and reliability of its testing. Routine reviews of PT reports by the laboratory staff and director will alert them to areas of testing that are not performing as expected and also indicate subtle shifts and trends that, over time, would affect their patient results.

Review proficiency testing results and keep track historically. Using drag-n-drop you can sort and organize PT results the way you want. Also, export in a variety of formats.

### CONCLUSION

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Of course, those skilled in the art will recognize many modifications may be made to this configuration without departing from the scope or spirit of what is described herein. It will be understood that many additional changes in the details, materials, steps and arrangement of parts, which have been herein described and illustrated to explain the nature of the subject matter, may be made by those skilled in the art within the principle and scope of the disclosure as expressed in the appended claims. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A system for organizational management of certifiable laboratories, self-assessment, accreditation, education, professional development, maintenance and resolution comprising:
a server host module capable of communicating with a plurality of laboratory client modules, and providing the client modules with a customizable desktop interface;
a compliance record management module capable of tracking documentation of lab accreditation, compliance and quality control data;
a hosted data storage function capable of storing laboratory data for the certifiable laboratories;
a laboratory inventory module capable of storing inventory data for laboratory asset management;
a calendar alerting function capable of providing personnel at the certifiable laboratories time sensitive compliance data;
a module capable of providing survey and compliance results through the laboratory client modules;
a module capable of maintaining data regarding business operations of the certifiable laboratories, including demographic data, hours of operation and laboratory functions subject to certification; and
a consolidation function permitting commonly managed or commonly owned laboratories with consolidated data for the commonly managed or commonly owned laboratories,
wherein the customizable desktop interface provides communication access to the server host module to:
update personnel information,
store form data in at least one of the client module or the server host module,
provide scheduling information to the host, and
receive scheduling information from the host.

2. The system of claim 1, further comprising;
a waived testing module, permitting personnel at the certifiable laboratory to track procedures related to waived testing to provide self-assessment.

3. The system of claim 1, further comprising a competency tracking function, the competency tracking function comprising documentation of training and competency assessments of personnel associated with the certifiable laboratories, and further including a calendar function for reminding the personnel of current, pending and overdue competency requirements.

4. The system of claim 1, further comprising a module providing automated alerts, triggered by an action or inaction related to any of complete information, incomplete information, content, calendar, alarm, requirements, personnel, data, fields and category or categories.

5. The system of claim 1, wherein the server host module communicates with the plurality of laboratory client modules by providing a client portal website, and provides the client modules with a customizable desktop interface provided as a web interface.

6. The system of claim 1, further comprising:
the host having a capability of:
communicating with an accreditation source,
informing an accreditation source of personnel updates,
storing documents and/or information such as laboratory director forms and proficiency testing results in an electronic filing cabinet,
conducting one or more self-assessments, reviewing self-assessment and/or accreditation outcomes and/or corrective actions,
reviewing biographical information and photos of accreditation surveyors,
viewing one or more accreditation-related account balances,
making accreditation-related payments,
registering for accreditation symposia and special programs, and
scheduling surveyor visits.

7. A method for providing organizational management of certifiable laboratories, self-assessment, accreditation, education, professional development, maintenance and resolution, the method comprising:
providing a server host module and using the server host module to communicate with a plurality of laboratory client modules through a customizable desktop interface;
providing tracking documentation of lab accreditation, compliance and quality control data;
storing laboratory data for the certifiable laboratories;
storing inventory data for laboratory asset management;
using calendar alerting to provide personnel at the certifiable laboratories with notifications of time sensitive compliance data;
providing survey and compliance results through the desktop interface;
maintaining updatable data regarding business operations of the certifiable laboratories, including demographic data, hours of operation and laboratory functions subject to certification;
for commonly managed or commonly owned laboratories, providing consolidated data for the commonly managed or commonly owned laboratories; and
providing communication access to the server host module to:
update personnel information,
store form data in at least one of the client module or the server host module,
provide scheduling information to the host, and
receive scheduling information from the host.

8. The method of claim 7, further comprising providing automated alerts, triggered by an action or inaction related to any of complete information, incomplete information, content, calendar, alarm, requirements, personnel, data, fields and category or categories.

9. The method of claim 7, wherein the server host module communicates with the plurality of laboratory client modules by providing a client portal website, and provides the client modules with a customizable desktop interface provided as a web interface.

10. The method of claim 7, further comprising:
communicating with an accreditation source,
informing an accreditation source of personnel updates,
storing documents and/or information such as laboratory director forms and proficiency testing results in an electronic filing cabinet,
conducting one or more self-assessments,
reviewing self-assessment and/or accreditation outcomes and/or corrective actions,
reviewing biographical information and photos of accreditation surveyors, viewing one or more accreditation-related account balances,
making accreditation-related payments,
registering for accreditation symposia and special programs, and
scheduling surveyor visits.

11. The method of claim 7, further comprising enabling extension of turnaround time for users, without dependence on other checker or communication method delay.
